(19) United States
(12) Patent Application Publication
(10) Pub. No.: US 2008/0046720 A1
(43) Pub. Date: Feb. 21, 2008

(54) Image processing system, image processing apparatus, and program management method

(76) Inventors: Satoru Sugishita, Tokyo (JP); Yoshimine Horiuchi, Kanagawa (JP)

Correspondence Address: DICKSTEIN SHAPIRO LLP, 1825 EYE STREET NW, Washington, DC, 20006-5403, US

(21) Appl. No.: 11/889,555

(22) Filed: Aug. 14, 2007

(30) Foreign Application Priority Data
Aug. 21, 2006 (JP) 2006-224520
Jun. 28, 2007 (JP) 2007-170863

(51) Int. Cl. H04L 9/00

(52) U.S. Cl. 713/156

(57) ABSTRACT

A management server is disclosed that is connected to an image processing apparatus. The management server includes an authentication unit that performs authentication of authentication information sent from the image processing apparatus, a certificate issuing unit that issues a certificate containing program identification information for identifying a program and expiration date information indicating an expiration date of the program in an encrypted manner, and a program provision unit that provides the image processing apparatus with the program to be installed and the certificate.

### BACKGROUND OF THE INVENTION

1. Field of the Invention

The present invention generally relates to an image processing system, and particularly relates to an image processing system that authenticates a program in an image processing apparatus on a per function basis based on authentication information containing encrypted information and thus efficiently manages appropriate programs, an image processing apparatus used therein, and a program management method.

2. Description of the Related Art

Due to advancement of technologies related to digital multi-function printers (MFPs) (hereinafter referred to as “image processing apparatuses”) such as improvement of CPU (Central Processing unit) performance, increase of memory capacity, increase of communication speed, and advancement of digital imaging technology, current digital MFPs are equipped with not only a copier function but also other functions such as facsimile, printer, and scanner functions, and are therefore used in various situations under users' environments.

Users often request extended functions according to their intended use, and hence manufacturers (makers) need to design image processing apparatuses capable of having quickly installed appropriate function extension software and thus realizing function extension.

In view of the foregoing, Patent Document 1 (Japanese Patent Laid-Open Publication No. 2002-152458) discloses a method wherein a software component of a desired extended function and authentication information are downloaded (transferred to an image processing apparatus) from a download server storing function extension software so that the software component is executed based on the downloaded authentication information.

However, according to the method disclosed in Patent Document 1, if the function extension software is not appropriate for the image processing apparatus, only the use of hardware resources of the image processing apparatus is restricted based on the authentication information, but the use of the function extension software is not restricted.

That is, appropriateness of the function extension software to be executed is not efficiently determined in appropriate units (in units of functions).

Further, as one method for determining appropriateness of function extension software, authentication information for determining appropriateness of the function extension software is embedded in the software itself such that the determination is made based on the authentication information.

However, because different software operating systems using different authentication systems need authentication information items in different authentication data formats, it is cumbersome for developers of function extension software to embed authentication information into the function extension software.

### SUMMARY OF THE INVENTION

In view of the foregoing, the present invention is directed to provide an image processing system that authenticates a program in an image processing apparatus in units of functions based on authentication information containing encrypted information and thus efficiently manages appropriate programs; an image processing apparatus used therein; and a program management method.

According to one aspect of the present invention, there is provided an information processing system wherein a management server that manages a program to be installed into an image processing apparatus is connected to the image processing apparatus into which the program downloaded from the management server is to have installed. The information processing system includes an authentication request unit that sends authentication information from the image processing apparatus to the management server at a predetermined timing so as to request the management server including an authentication unit to perform authentication of the authentication information using the authentication unit; and a behavior control unit that, if the authentication information sent by the authentication request unit is authenticated by the authentication unit of the management server, controls behavior of the program downloaded from the management server based on an expiration date of the program indicated in the authentication information.

According to this aspect of the present invention, in the image processing system, the image processing apparatus sends the authentication information containing the encrypted information to the management server. The management server determines whether the sent authentication information is valid and sends the authentication result to the image processing apparatus. Thus, the image processing apparatus can control the behavior of the program based on the authentication result.

Further, the above image processing system does not use an authentication system that determines program appropriateness based on authentication information embedded in a program, and therefore can reduce workload on program developers.

It is therefore possible to realize an image processing system that authenticates a program in an image processing apparatus in units of functions based on the authentication information containing the encrypted information and thus efficiently manages appropriate programs.

According to another aspect of the present invention, there is provided a management server of an image processing system that is connected to an image processing apparatus. The management server comprises an authentication unit that performs authentication of authentication information sent from the image processing apparatus; a certificate issuing unit that issues a certificate containing program identification information for identifying a program and expiration date information indicating an expiration date of the program in an encrypted manner; and a program provision unit that provides the image processing apparatus with the program to be installed and the certificate.

According to this aspect of the invention, the management server of the image processing system encrypts the expiration date information and the program identification information used for controlling the program behavior in the image processing apparatus, and thus can issue a certificate with a high security level as authentication information. Further, the management server performs authentication based on the issued certificate, and thus can determine whether the image processing uses an appropriate program according to the expiration date. The management server can also provide an appropriate program to the image processing apparatus based on the authentication result.

Further, because the authentication information exchanged between the image processing apparatus and the management server is encrypted, it is possible to prevent the authentication information from being maliciously tampered with and thus prevent unauthorized use of functions of the image processing apparatus.

According to still another aspect of the present invention, there is provided an image processing apparatus of an image processing system that is connected to a management server. The image processing apparatus comprises an authentication request unit that sends authentication information to the management server at a predetermined timing so as to request the management server including an authentication unit to perform authentication of the authentication information, the authentication information including program identification information for identifying a program downloaded from the management server, expiration date information indicating an expiration date and time of the program, and a certificate containing the program identification information and the expiration date information in an encrypted manner; and a behavior control unit that, if the authentication information sent by the authentication request unit is authenticated by the authentication unit of the management server, controls behavior of the program downloaded from the management server based on the expiration date of the program indicated in the authentication information.

According to this aspect of the present invention, the image processing apparatus of the image processing system requests the management server to perform authentication, and controls the behavior of the program downloaded from the management server based on the authentication result by the management server. It is therefore possible to prevent unauthorized use of the program.

According to a further aspect of the present invention, there is provided a program management method for use in an image processing system in which a management server that manages a program to be installed into an image processing apparatus is connected to the image processing apparatus into which the program downloaded from the management server is to have installed. The program management method comprises an authentication requesting step of sending authentication information from the image processing apparatus to the management server at a predetermined timing so as to request the management server to perform authentication of the authentication information using the authentication unit; and a behavior controlling step of controlling, if the authentication information sent in the authentication requesting step is authenticated by the management server, behavior of the program downloaded from the management server based on an expiration date of the program indicated in the authentication information.

According to the above described program management method, the image processing apparatus sends the authentication information containing the encrypted information to the management server. The management server determines whether the sent authentication information is valid and sends the authentication result to the image processing apparatus. Thus, the image processing apparatus can control the behavior of the program based on the authentication result.

Further, this method does not use an authentication system that determines program appropriateness based on authentication information embedded in a program, and therefore can reduce workload on program developers.

It is therefore possible to authenticate a program in an image processing apparatus in units of functions based on the authentication information containing the encrypted information and thus efficiently manage appropriate programs.

According to another further aspect of the present invention, there is provided a program management method for use in a management server of an information processing system that is connected to an image processing apparatus. The program management method comprises an authenticating step of performing authentication of authentication information sent from the image processing apparatus; a certificate issuing step of issuing a certificate containing program identification information for identifying a program and expiration date information indicating an expiration date of the program in an encrypted manner; and a program providing step of providing the image processing apparatus with the program to be installed and the certificate.

According to this aspect of the invention, the program management method for use in the management server of the image processing system encrypts the expiration date information and the program identification information used for controlling the program behavior in the image processing apparatus, and thus can issue a certificate with a high security level as authentication information. Further, this method makes it possible to performed authentication based on the issued certificate, and thus determines whether the image processing uses an appropriate program according to the expiration date. This method makes it possible to provide an appropriate program to the image processing apparatus based on the authentication result.

Further, because the authentication information exchanged between the image processing apparatus and the management server is encrypted, it is possible to prevent the authentication information from being maliciously tampered and thus prevent unauthorized use of functions of the image processing apparatus.

According to still another aspect of the present invention, there is provided a program management method for use in an image processing apparatus of an image processing system that is connected to a management server. The program management method comprises an authentication requesting step of sending authentication information to the management server at a predetermined timing so as to request the management server to perform authentication of the authentication information, the authentication information including program identification information for identifying a program downloaded from the management server, expiration date information indicating an expiration date of the program, and a certificate containing the program identification information and the expiration date information in an encrypted manner; and a behavior controlling step of controlling, if the authentication information sent in the authentication requesting step is authenticated by the management server, behavior of the program downloaded from the management server based on the expiration date of the program indicated in the authentication information.

According to this aspect of the present invention, the image processing apparatus of the image processing system requests the management server to perform authentication, and controls the behavior of the program downloaded from the management server based on the authentication result by the management server. It is therefore possible to prevent unauthorized use of the program.

Embodiments of the present invention provided an image processing system that authenticates a program in an image processing apparatus in units of functions based on authentication information containing encrypted information and thus efficiently manages appropriate programs; an image processing apparatus used therein; and a program management method.

### BRIEF DESCRIPTION OF THE DRAWINGS

FIG. 1 is a diagram showing an example of a configuration of an image processing system according to a first embodiment of the present invention;

FIG. 2A is a diagram showing an example of a hardware configuration of an image processing apparatus according to the first embodiment of the present invention;

FIG. 2B is a diagram showing an example of a hardware configuration of a management server according to the first embodiment of the present invention;

FIG. 3A is a diagram used to explain installation of a program in units of functions from the management server to the image processing apparatus according to the first embodiment of the present invention;

FIG. 3B is a diagram used to explain activation of a program according to the first embodiment of the present invention;

FIG. 4 is a diagram showing a data structure of authentication information according to the first embodiment of the present invention;

FIG. 5 is a diagram used to explain sending and receiving authentication information in the image processing system according to the first embodiment of the present invention;

FIG. 6A is a block diagram showing a configuration example of main function units of the image processing apparatus according to the first embodiment of the present invention;

FIG. 6B is a block diagram showing a configuration example of main function units of the management server according to the first embodiment of the present invention;

FIG. 7A is a block diagram showing a configuration example of component parts of the main function units of the image processing apparatus according to the first embodiment of the present invention;

FIG. 7B is a block diagram showing a configuration example of component parts of the main function units of the management server according to the first embodiment of the present invention;

FIG. 8 is a flowchart illustrating processing performed by a program storage unit in the image processing apparatus according to the first embodiment of the present invention;

FIG. 9A is a flowchart illustrating processing performed by a program behavior control unit in the image processing apparatus at the time of power-on according to the first embodiment of the present invention;

FIG. 9B is a flowchart illustrating processing performed by the program behavior control unit in the image processing apparatus when the date is changed according to the first embodiment of the present invention;

FIG. 10 is a flowchart illustrating processing performed by an authentication request unit in the image processing apparatus according to the first embodiment of the present invention;

FIG. 11 is a flowchart illustrating processing performed by an authentication request reception unit in the management server according to the first embodiment of the present invention;

FIG. 12 is a flowchart illustrating processing performed by an authentication unit in the management server according to the first embodiment of the present invention;

FIG. 13 is a flowchart illustrating processing performed by a certificate issuing unit in the management server according to the first embodiment of the present invention;

FIG. 14 is a flowchart illustrating processing performed by a program providing unit in the management server according to the first embodiment of the present invention;

FIG. 15 is a flowchart illustrating processing performed by an expiration date information management unit in the management server according to the first embodiment of the present invention;

FIG. 16 is a sequence diagram showing a process of installing a program according to the first embodiment of the present invention;

FIG. 17A is a sequence diagram showing a processing flow in the case where the result of authentication performed when activating a program at the time of power-on is OK according to the first embodiment of the present invention;

FIG. 17B is a sequence diagram showing a processing flow in the case where the result of authentication performed when activating a program at the time of power-on is NG according to the first embodiment of the present invention;

FIG. 18A is a sequence diagram showing a processing flow in the case where the result of expiration date determination performed when the date is changed is “the expiration date has not passed” according to the first embodiment of the present invention;

FIG. 18B is a sequence diagram showing a processing flow in the case where the result of expiration date determination performed when the date is changed is “the expiration date has passed” according to the first embodiment of the present invention;

FIG. 18C is a sequence diagram showing a processing flow in the case where the result of an expiration date determination performed when the date is changed is “the expiration date is close” according to the first embodiment of the present invention;

FIG. 19 is a sequence diagram showing a process of updating authentication information according to the first embodiment of the present invention;

FIG. 20 is a diagram showing an example of a configuration of an image processing system (wherein a distributed management server is used) according to a modified embodiment of the first embodiment of the present invention;

FIG. 21 is a diagram showing an example of a configuration of an image processing system (wherein an extended image processing apparatus is used) according to a modified embodiment of the first embodiment of the present invention;

FIG. 22 is a sequence diagram showing a processing flow performed when activating a program in the extended image processing apparatus according to a modified embodiment of the first embodiment of the present invention;

FIG. 23 is a block diagram showing an example of a hardware configuration of an image processing apparatus according to a modified embodiment of the present invention;

FIG. 24 is a diagram showing an example of a configuration of an image processing system (wherein an activation server is used) according to a second embodiment of the present invention;

FIG. 25A is a block diagram showing a configuration example of main function units of a program management server according to the second embodiment of the present invention;

FIG. 25B is a block diagram showing a configuration example of main function units of the activation server according to the second embodiment of the present invention;

FIG. 26 is a sequence diagram showing a process of installing a program according to the second embodiment of the present invention;

FIG. 27 is a diagram showing an example of a configuration of an image processing system (wherein a to-be-installed-program creating PC is used) according to a third embodiment of the present invention;

FIG. 28A is a block diagram showing a configuration of main function units of an image processing apparatus according to the third embodiment of the present invention;

FIG. 28B is a block diagram showing a configuration example of main function units of the to-be-installed-program creating PC according to the third embodiment of the present invention; and

FIG. 29 is a sequence diagram showing a process of installing a program according to the third embodiment of the present invention.

### DETAILED DESCRIPTION OF THE PREFERRED EMBODIMENT

Preferred embodiments of the present invention are described below with reference to the accompanying drawings.

### First Embodiment

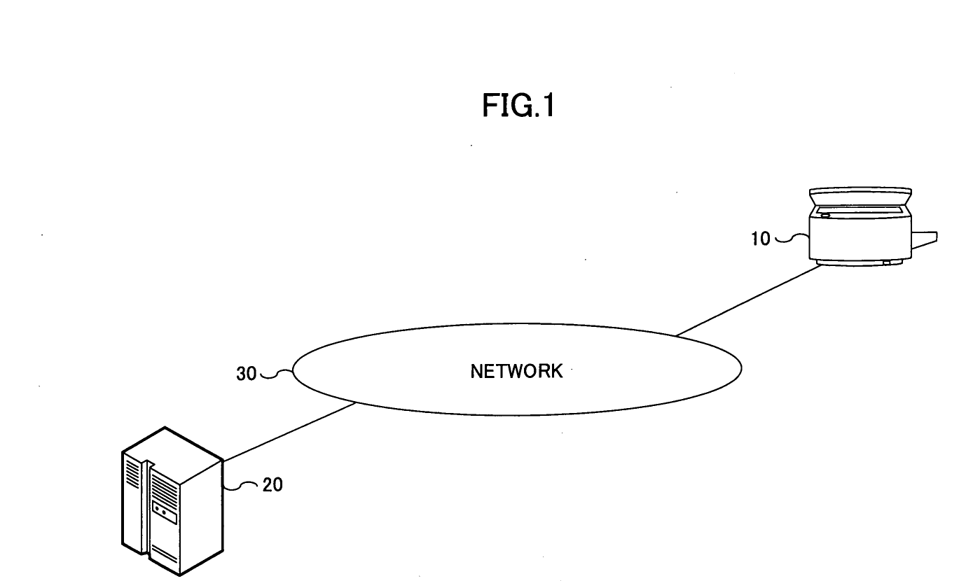

FIG. 1 is a diagram showing an example of a configuration of an image processing system according to a first embodiment of the present invention.

Referring to FIG. 1, the image processing system includes an image processing apparatus 10, into which a function extension program is installed, and a management server 20 that manages the function extension program to be installed into the image processing apparatus 10. The image processing apparatus 10 and the management server 20 are connected via a network 30 such as a LAN (Local Area Network) or WAN (Wide Area Network). The image processing apparatus 10 can download the function extension program managed by the management server 20 via the network 30 and install the downloaded function extension program therein, thereby extending its function.

The image processing system thus can quickly extend the function of the image processing apparatus 10 and thus achieve high extensibility.

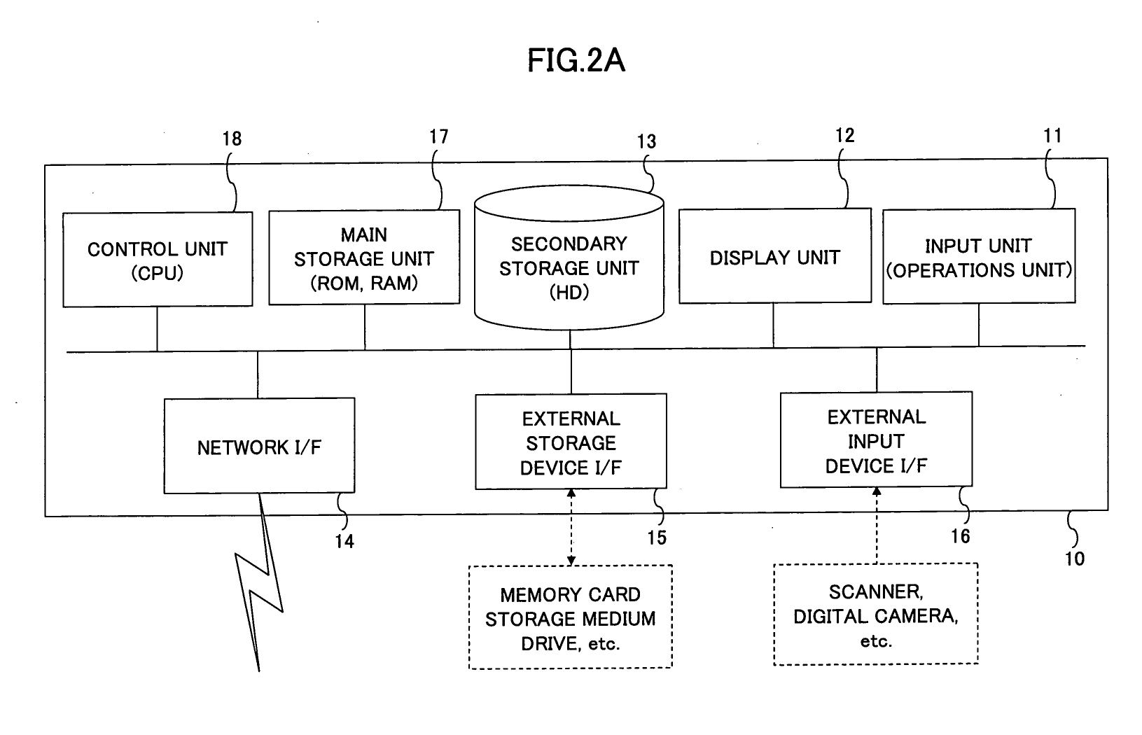

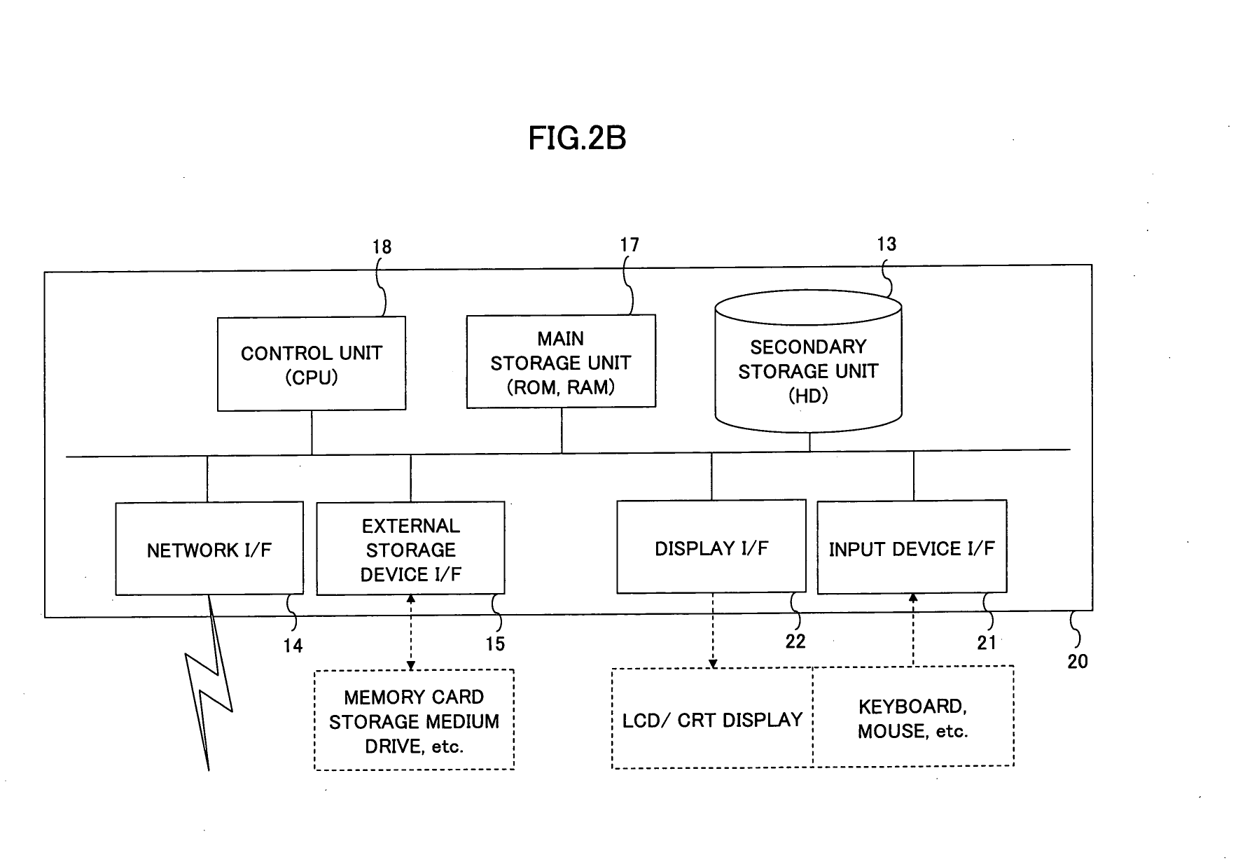

The hardware configurations of the image processing apparatus 10 and the management server 20 are described with reference to FIGS. 2A and 2B.

FIG. 2A is a diagram showing an example of a hardware configuration of the image processing apparatus 10 according to the first embodiment of the present invention.

Referring to FIG. 2A, the image processing apparatus 10 includes an input unit 11, a display unit 12, a secondary storage unit 13, a network I/F 14, an external storage device I/F 15, an external input device I/F 16, a main storage unit 17, and a control unit 18.

The input unit 11 is called an operations unit. The input unit 11 includes a numeric keypad, various function keys, a start/stop key, and is configured to receive various settings and instructions entered using these keys, such as configuration settings for image processing functions (e.g. resolution setting and zoom setting) and instructions for executing operations (e.g. instruction for starting a copy operation entered using the start key). For example, the input unit 11 of this, embodiment receives an identification code, a password or the like of a contractor entered using the numeric keypad when performing service contractor authentication (described below).

The display unit 12 includes a liquid crystal display unit, and is configured to display various types of information such as job-related information (e.g. the name of a job being processed), operational configurations of the image processing apparatus 10 (e.g. a selected resolution and a selected zoom rate), and the apparatus status (e.g. “ready” and “processing job”). The display unit 12 may optionally have a touch panel function. If the display unit 12 has a touch panel function, the display unit 12 can receive settings and instructions entered by touching buttons displayed on the touch panel with use of a touch pen or the like, thereby offering the same function as the input unit 11. For example, the display unit 12 of this embodiment displays information about a function extension program downloaded from the below-described management server 20 (e.g. the name of a function corresponding to an activated program). In the case where the display unit 12 has a touch panel function, similar to the input unit 11, the display unit 12 receives an identification code, a password or the like of a contractor entered using a numeric keypad displayed on the touch panel.

The secondary storage unit 13 is a non-volatile storage unit, such as a hard disk (HD), that hold data (e.g. image data) handled by the image processing apparatus 10. For instance, the secondary storage unit 13 of this embodiment holds the function extension program and data related to the program.

The network I/F 14 is used for two-way data communication between the image processing apparatus 10 and a communication device (e.g. a network I/F of the management server 20) via the network 30 such as a LAN or a WAN. For example, the network I/F 14 of this embodiment is used when downloading the function extension program to be installed, its related data, and the like from the management server 20 or when sending and receiving authentication information for determining program appropriateness.

The external storage device I/F 15 is used for exchanging data between the image processing apparatus 10 and an external storage medium such as a memory card. Examples of external storage medium include not only a memory card but also an FD (Floppy Disk), an MO (Magneto-Optical disk), a CD (Compact Disc), and a DVD (Digital Versatile Disk). For instance, the external storage device I/F 15 of this embodiment is used when reading image data from and writing image data into a memory card or other storage media.

The external input device I/F 16 is used for exchanging data between the image processing apparatus 10 and an image reader such as a scanner and a digital camera. For instance, the external input device I/F 16 of this embodiment inputs image data (reads images) to be processed.

The main storage unit 17 includes a ROM (Read Only Memory) and a RAM (Random Access Memory), and is configured to store or temporarily store programs and related data for realizing the functions of the image processing apparatus 10. For example, the main storage unit 17 of this embodiment stores, in a ROM, basic software (hereinafter referred to as an “OS (Operating System)”) for controlling the image processing apparatus 10, programs and related data of basic functions (e.g. an image input function, an image processing function, and an image output function) that are enabled when starting the image processing apparatus 10. The programs and the related data in the ROM are expanded (loaded) into the RAM by the below-described control unit 18.

The control unit 18 is called a controller unit that executes a program in the CPU and controls the image processing apparatus 10 according to control command signals. For example, when the image processing apparatus 10 is powered on, the control unit 18 of this embodiment expands (loads) the programs and data from the ROM into the RAM and executes the expanded (loaded) programs according to need. The control unit 18 thus activates the OS at the time of power-on of the image processing apparatus 10, and activates the basic functions on the activated OS. In the case where an extended function is installed, the control unit 18 runs the corresponding function extension program and related data in the secondary storage unit 13 as plug-in software to the basic functions.

The above-described hardware components are connected to each other through a bus and a connection cable as transmission channels for data and control signals. With this configuration, the control unit 18 sends control signals to the input unit 11, the display unit 12, the secondary storage unit 13, the network I/F 14, the external storage device I/F 15, the external input device I/F 16, and the main storage unit 17. In response, the input unit 11, the display unit 12, the secondary storage unit 13, the network I/F 14, the external storage device I/F 15, the external input device I/F 16, and the main storage unit 17 can send data signals processed by them according to the control signals to the control unit 18. Thus, the control unit 18 can control the entire operation of the image processing apparatus 10.

For instance, in the case of installing the function extension program and the related data from the management server 20 to the image processing apparatus 10, the control unit 18 first executes a control program for executing installation. The control unit 18 then sends a control signal to the network I/F 14 so that the network I/F 14 sends, to the management server 20, a data request signal for requesting the program and related data.

Then, the control unit 18 receives from the network I/F 14 a signal indicating that a transmission of data (the program and the related data) from the management server 20 has started. After that, the control unit 18 outputs a data signal so as to transfer the received data to the secondary storage unit 13, and sends a control signal to the secondary storage unit 13 so that the secondary storage unit 13 holds the transferred data.

As described above, the image processing apparatus 10 acquires the function extension program and its related data from the management server 20 via the network I/F 14, and installs the acquired program and the related data (i.e., loads the acquired program and the related data into the secondary storage unit 13) expands (loads) the installed function extension program and the related data from the secondary storage unit 13 into the RAM of the main storage unit 17, and executes the expanded program, thereby realizing an extended function.

FIG. 2B is a diagram showing an example of a hardware configuration of the management server 20 according to the first embodiment of the present invention.

Referring to FIG. 2B, the management server 20 includes an input device I/F 21, a display I/F 22, a secondary storage unit 13, a network I/F 14, an external storage device I/F 15, a main storage unit 17, and a control unit 18.

The input device I/F 21 is used for exchanging data between the management server 20 and input devices such as a keyboard and a mouse.

The display I/F 22 is used for exchanging RGB signals between the management server 20 and display units such as a CRT (Cathode Ray Tube) display unit and a liquid crystal display unit.

The secondary storage unit 13, the network I/F 14, the external storage device I/F 15, the main storage unit 17, and the control unit 18 of the management server 20 are the same as those of the image processing apparatus 10. Therefore, the following does not describe basic operations of these hardware components of the management server 20 but describes the differences from those of the image processing apparatus 10.

The secondary storage unit 13 of the management server 20 holds the function extension program and the related data managed by the management server 20 and authentication information.

The external storage device I/F 15 of the management server 20 is used when reading the function extension program and the related data from and writing the function extension program and the related data into a memory card and other storage media.

The main storage unit 17 of the management server 20 stores an OS program for controlling the management server 20 and its related data in a ROM. The program and the related data in the ROM are expanded (loaded) into a RAM by the control unit 18.

When the management server 20 is powered on, the control unit 18 of the management server 20 expands (loads) the program and data from the ROM into the RAM and executes the expanded (loaded) program according to need. The control unit 18 thus activates the OS at the time of power-on, and activates the basic functions (e.g. a management function for the function extension program and the related data, and an authentication function) on the activated OS. Thus, the control unit 18 of the management server 20 can control the entire operation of the management server 20.

As described above, the management server 20 receives a request for the function extension program and the related data, and sends the function extension program and the related data in response to the request, thereby providing the function extension program and the related data to the image processing apparatus 10.

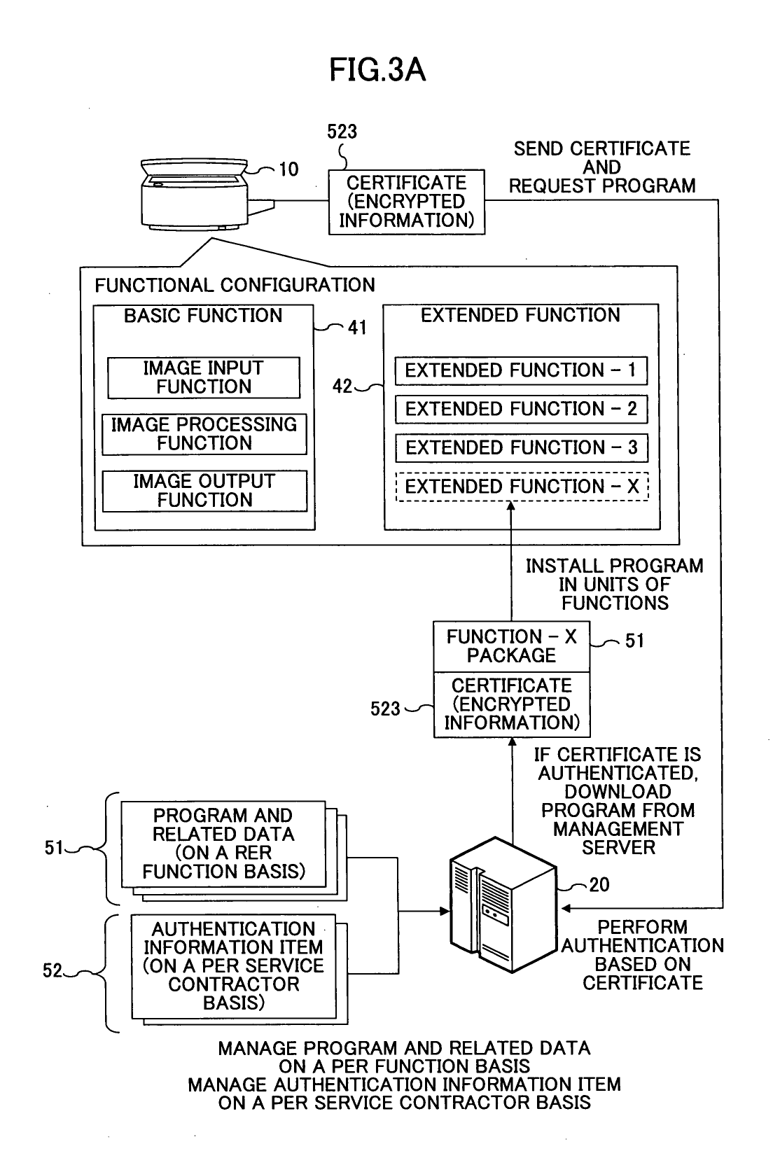

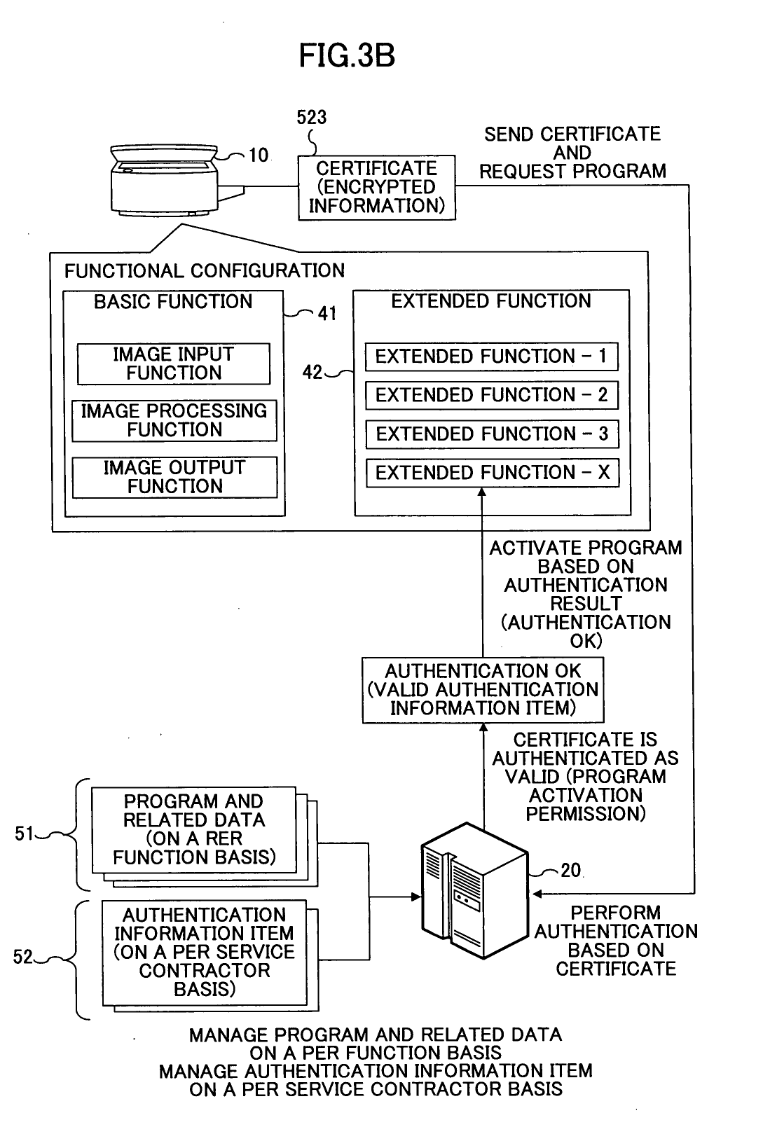

The following describes how the management server 20 provides an extended function to the image processing apparatus 10 with reference to FIGS. 3A and 3B.

FIG. 3A is a diagram used to explain installation of a program in units of functions from the management server 20 to the image processing apparatus 10 according to the first embodiment of the present invention.

Functions of the image processing apparatus 10 are generally divided into basic functions 41 and extended functions 42.

As shown in FIG. 3A, the basic functions 41 are used for processing image data and outputting the processed image data, and include an image input function for inputting image data, an image processing function for processing the input image data, and an image output function for outputting the processed data. The extended functions 42 extend the basic functions 41.

The basic functions 41 are functional software of the image processing apparatus 10, while the extended functions 42 are plug-in software to the functional software.

The management server 20 manages programs and related data of the functional software and the function extension plug-in software on a per function basis.

When installing an extended function into the image processing apparatus 10, the image processing apparatus 10 acquires by downloading an installation package 51 (a function X package in FIG. 3A) containing a program of the extended function and its related data from the management server 20.

The management server 20 manages the authentication information item 52, which is used for authentication for determining whether a program to be installed into the image processing apparatus 10 is appropriate, on a per service contractor basis.

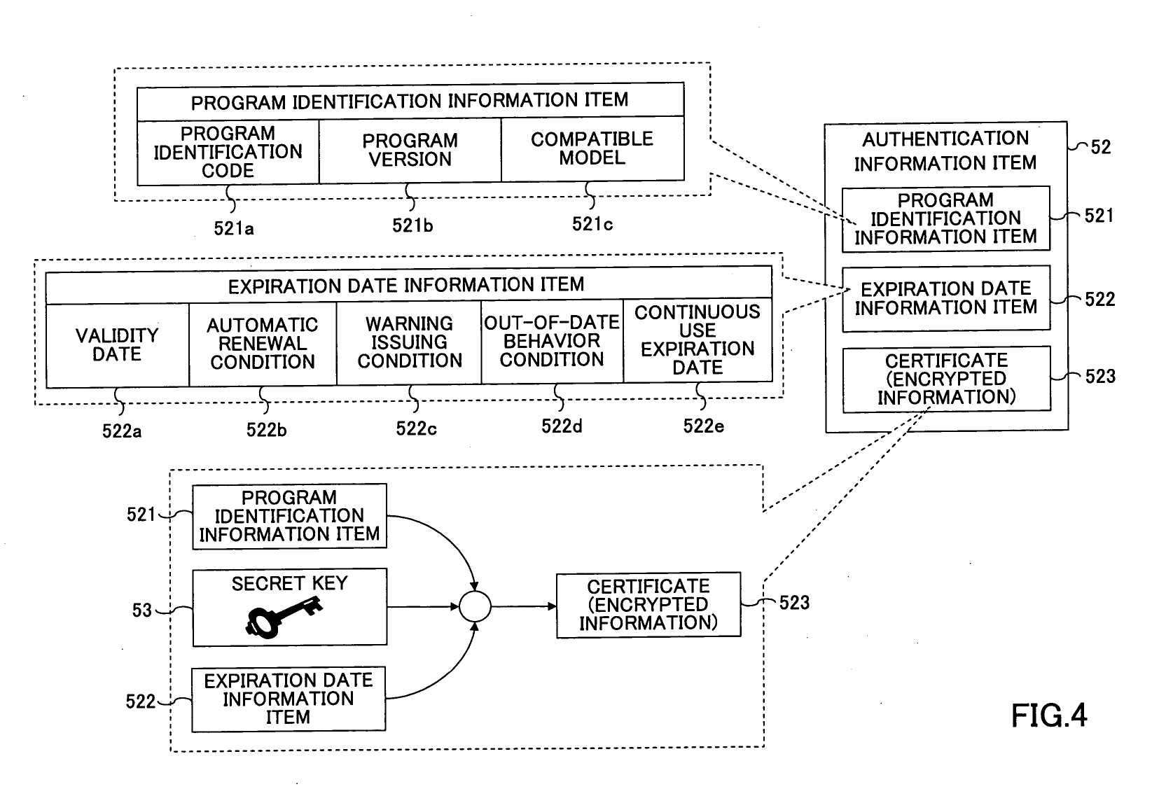

The authentication information item 52 is described below in greater detail with reference to FIG. 4. The authentication information item 52 includes a program identification information item 521, an expiration date information item 522, and a certificate 523 (encrypted information).

The program identification information item 521 includes a program identification code 521a, a program version 521b, and a compatible model 521c, and is used for identifying a program.

The program identification code 521a includes string (text) data of alphanumeric characters for identifying the program. The program version 521b includes string (text) data of alphanumeric characters indicating the version of the program. The compatible model 521c includes string (text) data of alphanumeric characters indicating a model by which the program is executable.

The expiration date information item 522 is about the date until when the program can be used, and includes a validity date 522a, automatic renewal condition 522b, a warning issuing condition 522c, out-of-date behavior condition 522d, and a continuous use expiration date 522e.

The validity date 522a includes string (text) data indicating the date until when the program can be used, and this date is determined based on the contract signed by the service contractor. The validity date 522a includes date and time information such as “2006.06.15 (22 h. 11 m. 07 s)”, for example, and indicates the date until when the program can be used. This date is determined based on the date and time of the installation of the program.

The automatic renewal condition 522b includes bit data indicating whether to automatically renew the service contract and the expiration date of the program the service contract when the validity date 522a has passed. For example, data such as “0” indicating “do not automatically renew” and “1” indicating “update automatically” may be used. If “1” is selected as the automatic renewal condition 522b, the expiration date is automatically renewed when the validity date 522a has passed.

The warning issuing condition 522c includes string (text) data of numeric characters indicating when to display a message indicating that the expiration date is close on the screen of the display unit. For example, data such as “5” indicating “display the message when the remaining period is 5 days or less” and “10” indicating “display the message when the remaining period is 10 days or less” may be used. If “10” is selected as the warning issuing condition 522c, the message indicating that the expiration date is coming put is displayed on the screen of the display unit 12.

The out-of-date behavior condition 522d includes bit data indicating a condition for controlling the behavior of the corresponding program in the case where the validity date 522a has passed. For example, data such as “0x01” indicating “display a warning on the screen; permit use of the program for a predetermined additional period” and “0x10” indicating “display a warning on the screen; prohibit use of the program” may be used. If “0x10” is selected as the out-of-date behavior condition 522d, when the expiration date has passed, a message indicating that the expiration date has passed is displayed on the screen, so that the program is terminated or is not activated.

The continuous use expiration date 522e includes string (text) data indicating the additional period during when the corresponding program can be used after the expiration date. For example, data such as “5” indicating five days and “10” indicating ten days may be used. If “10” is selected, the corresponding program can be used for an additional ten days.

The certificate 523 includes the program identification information item 521 and the expiration date information item 522 in an encrypted manner.

The certificate 523 is encrypted using a public-key cryptosystem such as a RSA (Rivest Shamir Adleman) cryptosystem. The public-key cryptosystem encrypts and decrypts data using a pair of keys, a public key 54 that is publicly made available and a secret key 53 that is kept secret.

The above-described authentication information item 52 is managed on a per service contractor basis. In the case where a service contractor has a right to use plural functions, the authentication information item 52 includes plural program identification information items 521 and expiration date information items 522 for the respective corresponding programs.

Further, in the case where a service contractor has a right to use plural functions, the certificate 523 of the authentication information item 52 includes integrally encrypted plural program identification information items 521 and expiration date information items 522.

The certificate 523 of the authentication information item 52 is exchanged between the image processing apparatus 10 and the management server 20.

Referring back to FIG. 3A, described below is the flow of installing a program from the management server 20 into the image processing apparatus 10 in units of functions based on the certificate 523.

First, the image processing apparatus 10 specifies a program corresponding to a function to be added, sends the certificate 523 of the authentication information item 52, thereby requesting the management server 20 to perform authentication of permission to install (acquire) the specified program.

The management server 20 determines whether the certificate 523 received from the image processing apparatus 10 is valid (not tampered with).

If the management server 20 determines that the certificate 523 is valid as a result of the authentication (i.e. if the authentication result is OK), the management server 20 sends an installation package 51 including the specified program to the image processing apparatus 10. At this time, the program identification information item 521 and the expiration date information item 522 corresponding to the program are updated, and a certificate 523 containing the updated information items 521 and 522 in an encrypted manner is issued and sent to the image processing apparatus 10.

The image processing apparatus 10 receives the installation package 51 including the program and the certificate 523 sent from the management server 20.

Then the image processing apparatus 10 installs the received program. Further, the image processing apparatus 10 decrypts the certificate 523 to update the authentication information item 52 held at the time of requesting the installation to the authentication information item 52 containing the program identification information item 521 and the expiration date information item 522 corresponding to the installed program.

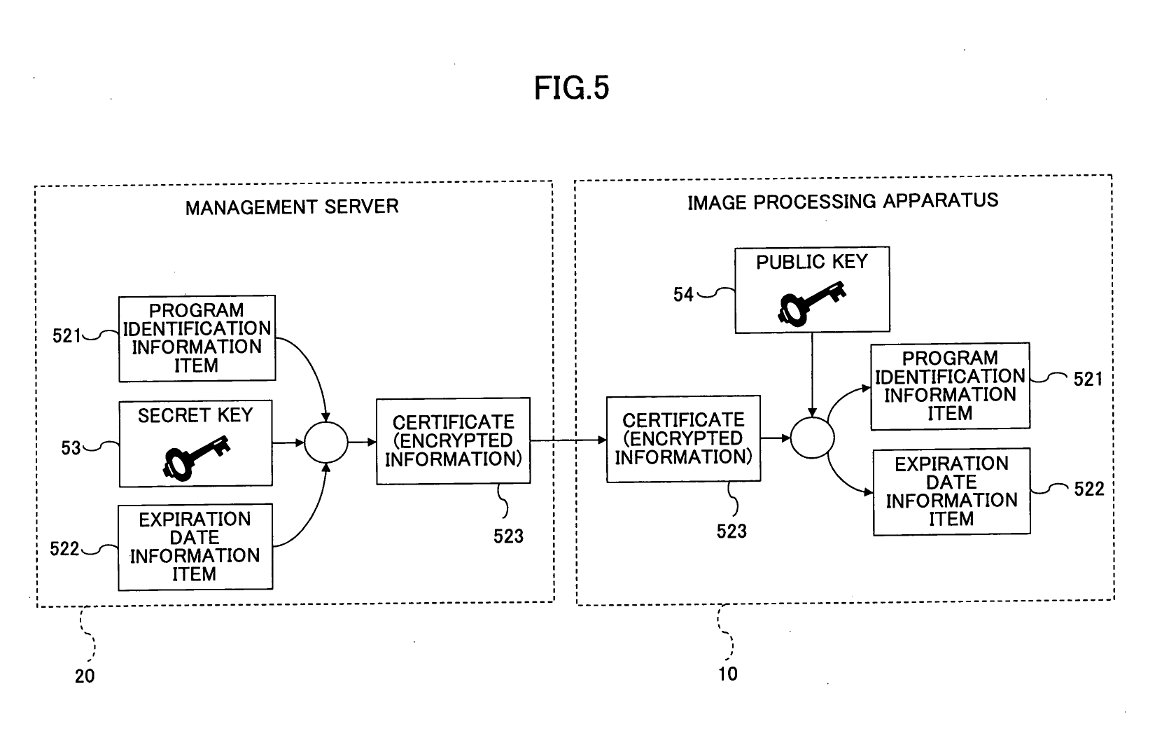

The processing flow performed by the image processing apparatus 10 for decrypting the certificate 523 and updating the authentication information item 52 is described below with reference to FIG. 5.

FIG. 5 is a diagram used to explain sending and receiving the authentication information item 52 in the image processing system according to the first embodiment of the present invention.

The management server 20 encrypts the program identification information item 521 and the expiration date information item 522 using the secret key 53 to issue a certificate 523. Then the management server 20 sends the issued certificate 523 as the authentication information item 52 to the image processing apparatus 10.

The image processing apparatus 10 receives the certificate 523 sent from the management server 20, decrypts the certificate 523 using the public key 54 to obtain the program identification information item 521 and the expiration date information item 522, and updates the authentication information item 52 that has been held in the image processing apparatus 10.

In this way, in the image processing system of the first embodiment using the public-key cryptosystem, the management server 20 with a high security level holds the secret key 53 and encrypts the authentication information item 52 using the secret key 53, while the image processing apparatus 10 with a lower security level than the management server 20 holds the public key 54 and decrypts the encrypted information (certificate 523) sent from the management server 20 using the public key 54. This system thus ensures security of the authentication information item 52 during transmission between the management server 20 and the image processing apparatus 10.

The process of activating the program installed in the image processing apparatus 10 based on the certificate 523 is described below with reference to FIG. 3B.

First, the image processing apparatus 10 specifies a program to be activated, sends the certificate 523 of the authentication information item 52, thereby requesting the management server 20 to perform authentication of permission to activate the specified program.

The management server 20 determines whether the certificate 523 received from the image processing apparatus 10 is valid (not tampered with).

If the management server 20 determines that the certificate 523 is valid based as a result of the authentication (i.e. if the authentication result is OK), the management server 20 sends the authentication result (authentication determination OK: program activation permission) to the image processing apparatus 10.

The image processing apparatus 10 receives the authentication result (authentication determination OK: valid authentication information item 52) sent from the management server 20, and activates the program based on the received authentication result (authentication determination OK: valid authentication information item 52).

In this way, the image processing system of the first embodiment can control installation of a program and control behavior of the installed program on a per function basis (i.e. manage programs on a per function basis) based on the authentication result of the management server 20.

The image processing system of the first embodiment does not use an authentication system that determines program appropriateness based on authentication information embedded in a program, and therefore can reduce workload on program developers.

Further, because the authentication information item 52 exchanged between the image processing apparatus 10 and the management server 20 is encrypted, it is possible to prevent the authentication information item 52 from being maliciously tampered with and thus prevent unauthorized use of the functions of the image processing apparatus 10.

It is therefore possible to realize an image processing system that authenticates a program in an image processing apparatus in units of functions based on the authentication information item 52 containing encrypted information and thus efficiently manages appropriate programs.

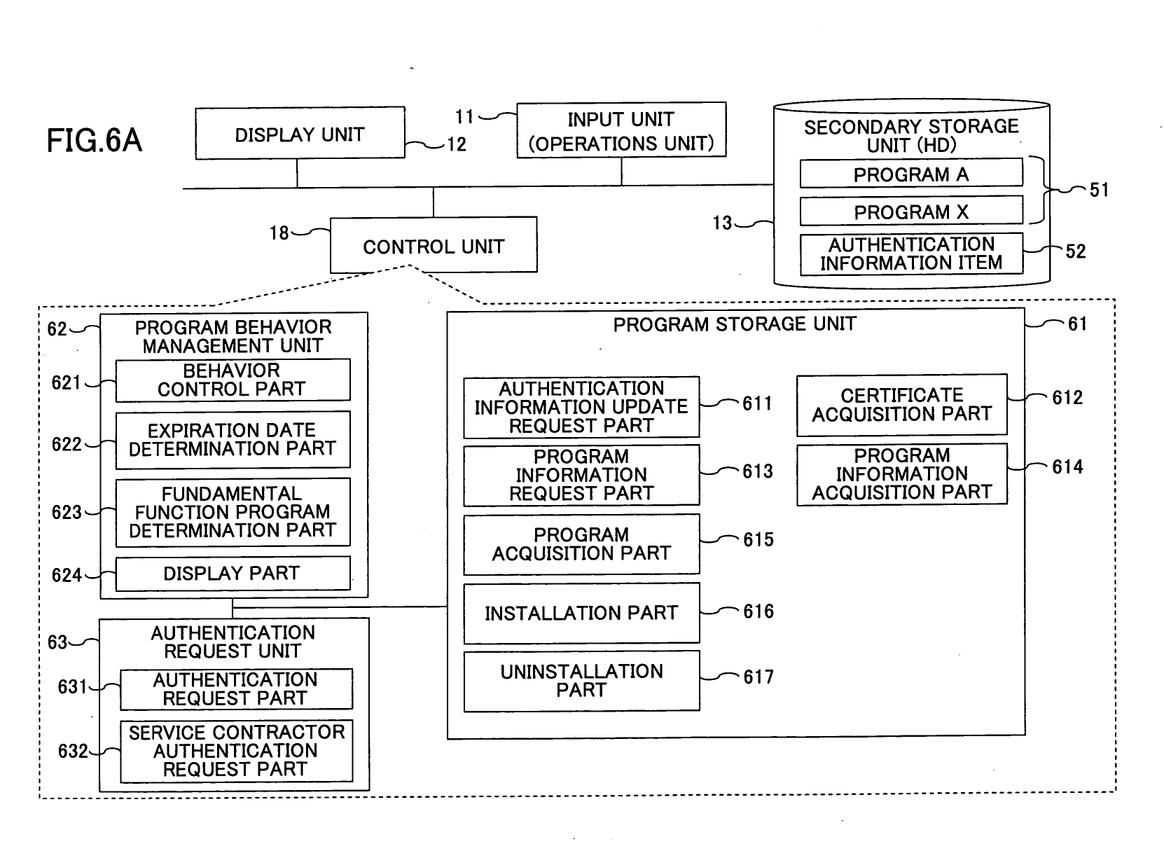

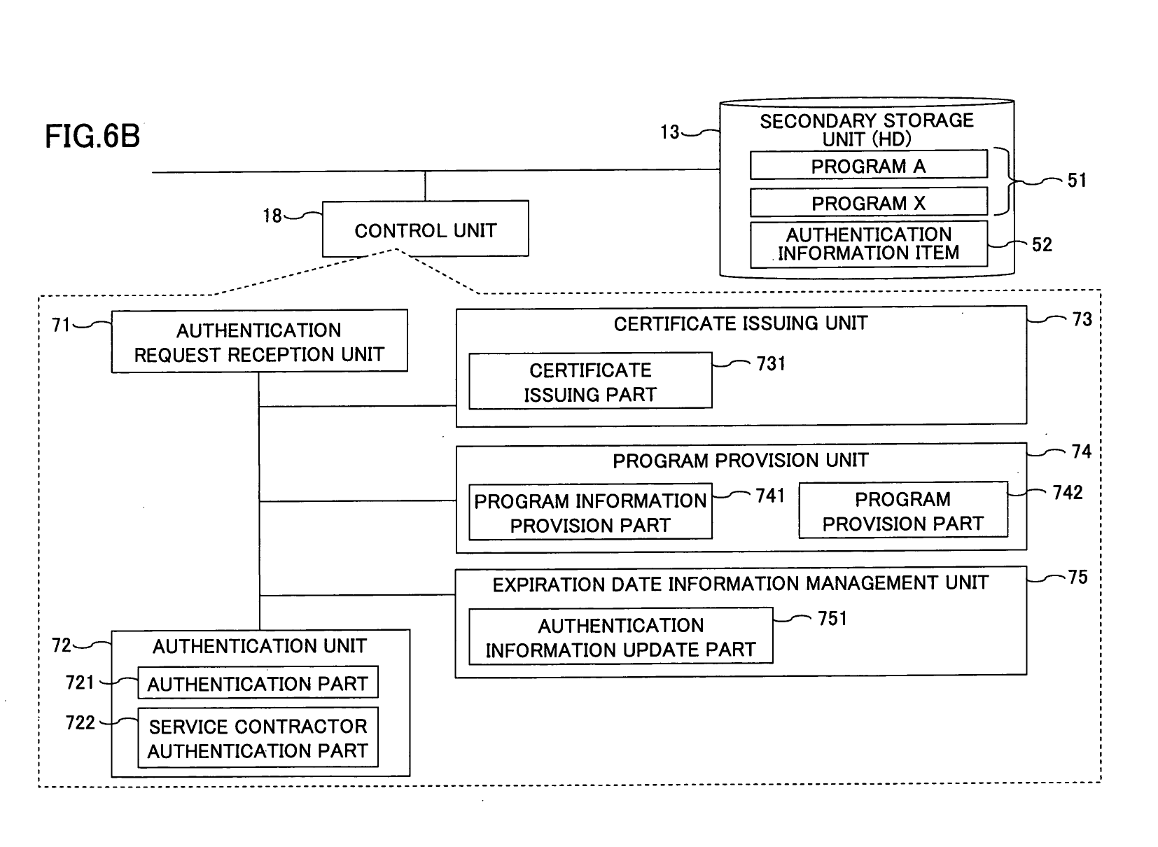

The following describes components of the image processing system illustrated in FIGS. 3, 4, and 5 for realizing installation of a program and controlling the behavior of the installed program with reference to FIGS. 6A and 6B.

FIG. 6A is a block diagram showing a configuration example of main function units of the image processing apparatus 10 according to the first embodiment of the present invention. FIG. 6B is a block diagram showing a configuration example of main function units of the management server 20 according to the first embodiment of the present invention.

First, the main function units of the image processing apparatus 10 are described with reference to FIG. 6A.

In FIG. 6A, the main function units include a program storage unit 61, a program behavior management unit 62, and an authentication request unit 63.

The program storage unit 61 includes an authentication information update request part 611, a certificate acquisition part 612, a program information request part 613, a program information acquisition part 614, a program acquisition part 615, an installation part 616, and an uninstallation part 617. The program storage unit 61 is configured to install a program acquired from the management server 20 and manages the installed program and the authentication information item 52. For example, the program storage unit 61 loads/deletes a program, and updates the authentication information item 52.

The program behavior management unit 62 includes a behavior control part 621, an expiration date determination part 622, and a fundamental function program determination part 623. The program behavior management unit 62 is configured to activate or terminate the program based on the authentication result and the authentication information item 52 sent from the management server 20, and thus control the behavior of the installed program.

The program behavior management unit 62 further includes a display part 624, and is configured to display information about the installed program (e.g. the expiration date information item 522 of the program) acquired from the management server 20 on the screen of the display unit 12.

The authentication request unit 63 includes an authentication request part 631 and a service contractor authentication request part 632, and is configured to request the management server 20 to determine whether a service contractor and the certificate 523 issued to the service contractor are valid.

With use of these main function units, the image processing apparatus 10 controls installation and uninstallation of the program and the behavior of the installed program.

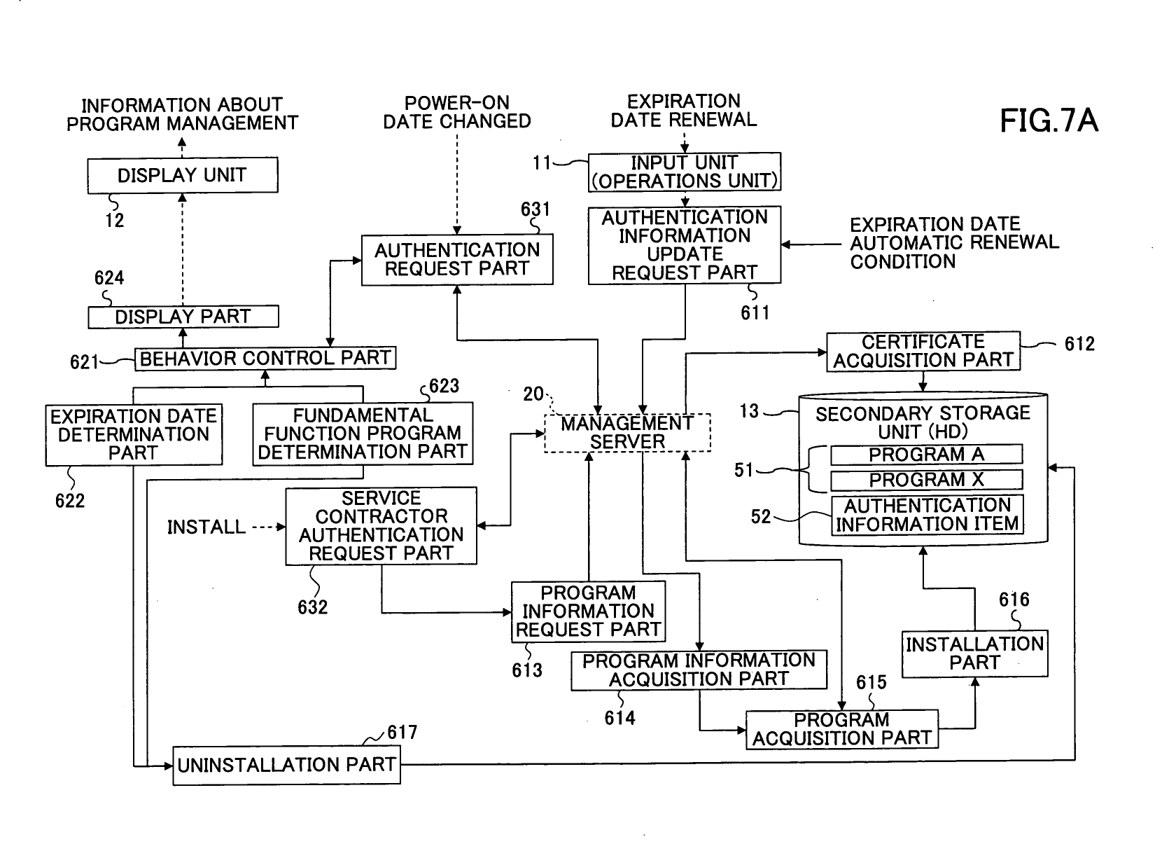

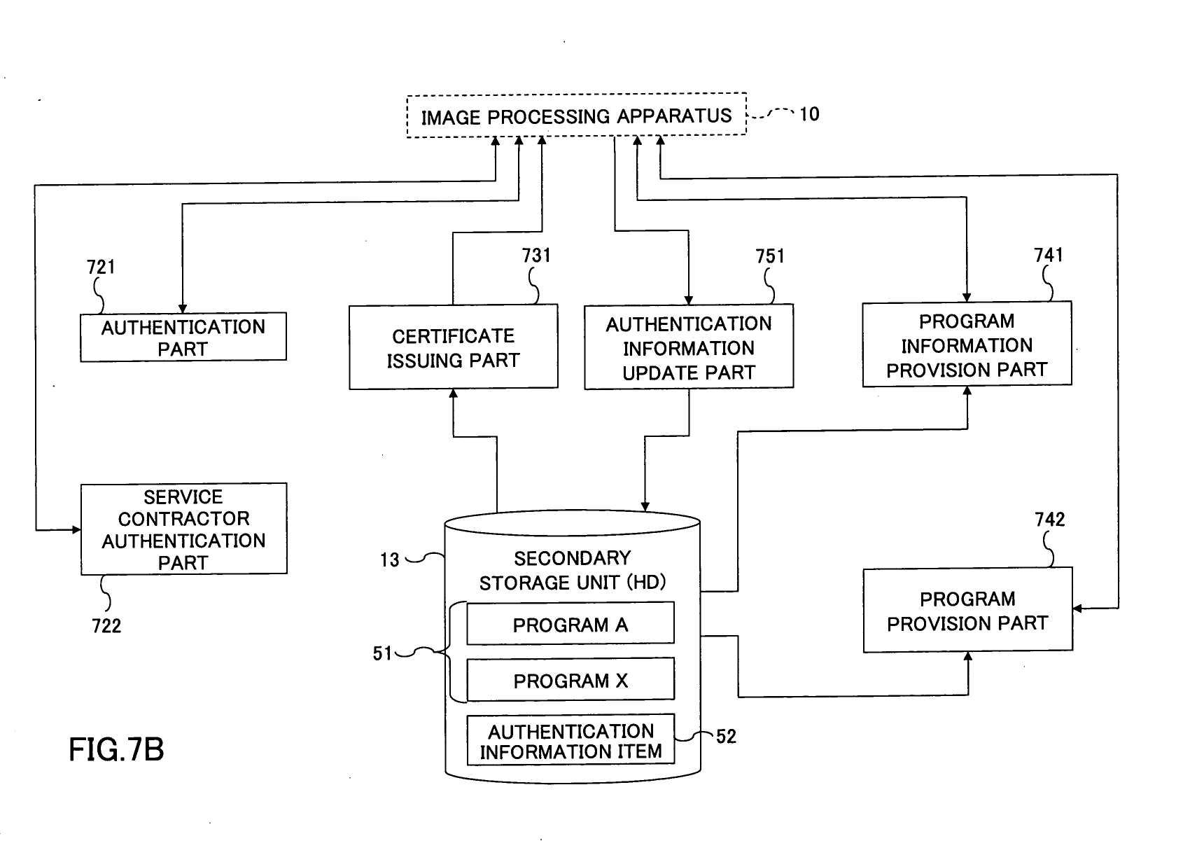

Next, component parts of the main function units of FIG. 6A are described with reference to FIG. 7A.

FIG. 7A is a block diagram showing a configuration example of component parts of the main function units of the image processing apparatus 10 according to the first embodiment of the present invention.

The authentication information update request part 611 of the program storage unit 61 is configured to request the management server 20 to update the authentication information item 52.

If the installed program has expired or expires soon, the expiration date information item 522 needs to be updated in order to continue to use the program.

Therefore, based on an update instruction from a service contractor (which may be entered by using the hard keys of the input unit 11 or the touch panel of the display unit 12) or based on the automatic renewal condition 522b of the expiration date information item 522, the authentication information update request part 611 requests the management server 20 to update the expiration date information item 522 of the authentication information item 52 according to a service contract.

The certificate acquisition part 612 of the program storage unit 61 is configured to receive the certificate 523 from the management server 20.

More specifically, the certificate acquisition part 612 receives the certificate 523 sent from the management server 20 when the image processing apparatus 10 needs a new authentication information item 52, such as when the authentication information item 52 is updated or when installing a new program.

The certificate acquisition part 612 renews the older certificate 523 (i.e. the certificate 523 that has been held by the image processing apparatus). Then, certificate acquisition part 612 decrypts the renewed certificate 523 using the public key 54 so as to obtain the expiration date information item 522 of the authentication information item 52. Based on the obtained expiration date information item 522, the certificate acquisition part 612 updates the older expiration date information item 522.

With this configuration, when renewing the contract or installing a new program, the program storage unit 61 causes the authentication information update request part 611 to request the management server to update the authentication information item 52, causes the certificate acquisition part 612 to receive the renewed certificate 523 of the authentication information item 52 sent from the management server 20 in response to the request, and thus updates the expiration date information item 522 of the authentication information item 52 held by the image processing apparatus 10.

The program information request part 613 of the program storage unit 61 is configured to, when installing a new program, request the management server 20 for a program list containing information about programs that can be installed in the image processing apparatus 10.

More specifically, the program information request part 613 sends the certificate 523 of the authentication information item 52 acquired by the certificate acquisition part 612 to the management server 20, thereby requesting the program list.

The program information acquisition part 614 of the program storage unit 61 is configured to receive the program list sent from the management server 20 when installing a new program.

More specifically, the program information acquisition part 614 receives the program list sent from the management server 20 based on an authentication result in response to the request of the program information request part 613.

The program acquisition part 615 of the program storage unit 61 is configured to, when installing a new program, acquire the program from the management server 20 based on the program list.

More specifically, the program acquisition part 615 selects the program to be installed from the program list acquired by the program information acquisition part 614, and requests the management server 20 for the selected program.

Then, the program acquisition part 615 receives the program sent from the management server 20 in response to the request.

The installation part 616 of the program storage unit 61 is configured to install the program acquired by the program acquisition unit 615.

The installation unit 616 loads the acquired program into a predetermined storage area of the secondary storage unit 13.

The uninstallation part 617 of the program storage unit 61 is configured to uninstall the program installed by the installation unit 616.

The uninstallation part 617 deletes the program from the secondary storage unit 13 in units of function, which may be one that has expired without renewing its contract, according to an instruction from the program behavior management unit 62

With this configuration, the program storage unit 61 can acquire a program in units of functions from the management server 20 using the program information request part 613, the program information acquisition part 614, the program acquisition part 615, and the installation part 616, and can uninstall the installed program in units of functions using the uninstallation part 617, thereby managing programs on a per-function basis.

The behavior control part 621 of the program behavior management unit 62 is configured to control program behavior based on the authentication result sent from the management server 20.

More specifically, when it is required to determine whether the certificate 523 of the authentication information item 52 issued to the service contractor is valid, such as when the image processing apparatus 10 is powered on or when the date is changed while the image processing apparatus 10 is being operated, the behavior control part 621 controls program behavior based on the authentication result sent from the management server 20.

For example, when the image processing apparatus 10 is turned on (i.e. when activating the program), if the authentication result of the management server 20 is “authentication determination: OK”, the program is activated. If the authentication result is “authentication determination: NG” (i.e. inappropriate program), the program is not activated.

When the date is changed while the image processing apparatus 10 is being operated, if the authentication result of the management server 20 is “authentication determination: NG” (inappropriate program), the running program is terminated.

The behavior control part 621 also controls the program behavior based on the expiration date information item 522.

The program behavior management unit 62 determines the program behavior as follows.

The expiration date determination part 622 of the program behavior management unit 62 determines whether the program controlled by the behavior control part 621 has expired based on the valid date 522a of the expiration date information item 522.

The expiration date determination part 622 compares the validity date 522a and the current date, and determines whether the expiration date of the program has passed.

When the image processing apparatus 10 is powered on (i.e. when activating the program) if the authentication result is “authentication determination: OK (appropriate program)” and also if the expiration date determination part 622 determines that the expiration date of the program has passed, the behavior control part 621 does not activate the program.

When the date is changed while the image processing apparatus 10 is being operated, if the authentication result is “authentication determination: OK (appropriate program)” and also if the expiration date determination part 622 determines that the expiration date of the program has passed, the behavior control part 621 terminates the running program.

If the authentication result is “authentication determination: OK (appropriate program)” and also if the expiration date determination part 622 determines that the expiration date of the program has passed as described above, the program behavior is controlled based on the out-of-date behavior condition 522d of the expiration date information item 522.

For example, if the out-of-date behavior condition 522d is “display a warning on the screen; permit use of the program for a predetermined additional period”, the behavior control part 621 displays a message indicating that the expiration date has passed on the screen of the display unit 12 and terminates the running program or does not activate the program.

The behavior control part 621 also instructs the program storage unit 61 to uninstall the installed program based on the program identification information item 521 of the authentication information item 52.

The behavior control part 621 determines whether to instruct the program storage unit 61 to uninstall the installed program as follows.

Before instructing the program storage unit 61 to uninstall a program, it is determined whether the image processing apparatus 10 will be disabled due to uninstallation of the program.

Therefore, the program behavior management unit 62 includes the fundamental function program determination part 623 that instructs the program storage unit 61 to uninstall the program based on the program identification code 521a of the program identification information item 521. Thus, based on the determination result of the fundamental function program determination part 623, the program behavior management unit 62 causes the behavior control unit 621 to instruct the program storage unit 61 to uninstall the program.

If the fundamental function program determination part 623 determines that the image processing apparatus 10 will be disabled due to termination of the expired program, the behavior control part 621 allows the program to be operated or activated (i.e. the behavior control part 621 does not terminate the operation of the program although the expiration date has passed) for a predetermined period after the expiration date based on the continuous use expiration date 522e of the expiration date information item 522.

Thus, the program behavior management unit 62 causes the behavior control part 621 to activate or terminate the program based on the authentication result and the determination result of the expiration date determination part 622.

Also, the program behavior management unit 62 causes the behavior control part 621 to uninstall the program based on the determination result of the fundamental function program determination part 623.

With this configuration, the program behavior management unit 62 can activate/terminate the program based on the authentication result, the expiration date, the behavior condition, and the continuous use expiration date, and thus can control the program behavior.

Also, the program behavior management unit 62 can uninstall the program that does not need to be stored in the image processing apparatus 10 according to the service contract, such as a program that has expired without renewing its contract, and thus can maintain the total volume of the programs installed in the image processing apparatus 10 at the optimum level (i.e. minimize the total volume of the installed programs).

The display part 624 of the program behavior management unit 62 is configured to display the information about the installed program (e.g. the expiration date information item 522 of the program) acquired from the management server 20 on the display screen on the display unit 12.

The display part 624 displays the information in response to an instruction from the behavior control unit 621.

The information to be displayed is related to the operational status of the program, the current expiration date information item 522, and contract renewal, and may include messages such as “The function XX has expired and cannot be activated. Please renew the contract.” and “The function XX is about to expire. Please renew the contract before the expiration of the contract”.

Thus, with use of the display part 624, the program behavior management unit 62 can provide the service contractor with the information about the operational status of the program, the current expiration date information item 522, and contract renewal, and thus can prompt the user to properly manage the contract.

The authentication request part 631 of the authentication request unit 63 is configured to, when it is required to determine whether the certificate 523 of the authentication information item 52 issued to the service contractor is valid, such as when the image processing apparatus 10 is powered on or when the date is changed while the image processing apparatus 10 is being operated, send the certificate 523 to the management server 20 and requests authentication of the authentication information item 52.

Further, the authentication request part 631 receives an authentication result (authentication determination OK: valid authentication information item 52/NG: tampered with authentication information item 52) sent from the management server 20 in response to the authentication request.

Thus, with use of the authentication request part 631, the authentication request unit 63 can request the management server 20 to determine whether the certificate 523 issued to the service contractor is valid, confirm that the certificate 523 is not maliciously tampered with, and determine the appropriateness of the program based on the valid certificate 523 according to the service contract.

The service contractor authentication request part 632 of the authentication request unit 63 is configured to, in order to install an appropriate program (extension function) from the management server 20 into the image processing apparatus 10, send to the management server 20 information (e.g. the public key 54) for identifying a service contractor who requested the installation. The service contractor authentication request part 632 thus requests the management server 20 to perform authentication of the service contractor so as to determine whether the service contractor is valid before installation of the program.

Further, the service contractor authentication request part 632 receives the authentication result (authentication determination OK: authenticated service contractor/NG: unauthorized use) sent from the management server 20 in response to the authentication request.

Thus, with use of the service contractor authentication request part 632, the authentication request unit 63 can request the management server 20 to perform the authentication of the service contractor, and detect unauthorized use by a person pretending to be a service contractor based on the authentication result of the management server 20.

Accordingly, it is possible to prevent unauthorized use of the image processing apparatus 10 by a third party who is not a service contractor.

Thus, with use of the component parts of the main function units, the image processing apparatus 10 can control and manage installation of a program based on an authentication result and can control and manage behavior of the installed program based on the authentication result, the expiration date, and the out-of-date behavior condition.

Next, the main function units of the management server 20 are described with reference to FIG. 6B.

In FIG. 6B, the main function units include an authentication request reception unit 71, an authentication unit 72, a certificate issuing unit 73, a program provision unit 74, and an expiration date information management unit 75.

The authentication request reception unit 71 receives information for identifying a service contractor and the certificate 523 from the image processing apparatus 10 when the authentication is requested, transfers the received information to the authentication unit 72, and returns the authentication result of the authentication unit 72 to the image processing apparatus 10.

The authentication unit 72 includes an authentication part 721 and a service contractor authentication part 722, and is configured to perform authentication of the service contractor and the certificate 523 in response to authentication requests from the image processing apparatus 10.

The certificate issuing unit 73 includes a certificate issuing part 731, and is configured to issue the certificate 523 containing the program identification information item 521 and the expiration date information item 522 of the authentication information item 52 in an encrypted manner.

The program provision unit 74 includes a program information provision part 741 and a program provision part 742, and is configured to provide the image processing apparatus 10 with the information about the program that can be installed in the image processing apparatus 10. The program provision unit 74 also provides the image processing apparatus 10 with the program requested by the image processing apparatus 10 based on the provided information.

The expiration date information management unit 75 includes an authentication information update part 751, and is configured to update the authentication information item 52 held by the management server 20 in response to a request for updating the authentication information item 52 from the image processing apparatus 10.

With use of these main function units, the management server 20 performs authentication and data management necessary for controlling installation of a program and behavior of the installed program in the image processing apparatus 10.

Next, component parts of the main function units of FIG. 6B are described with reference to FIG. 7B.

FIG. 7B is a block diagram showing a configuration example of the component parts of the main function units of the management server 20 according to the first embodiment of the present invention.

The authentication part 721 of the authentication unit 72 is configured to determine whether the certificate 523 of the authentication information item sent from the image processing apparatus 10 is valid.

More specifically, the authentication part 721 is configured to, when it is required to determine whether the certificate 523 of the authentication information item 52 issued to the service contractor is valid, such as when the image processing apparatus 10 is powered on or when the date is changed while the image processing apparatus 10 is being operated, receive the certificate 523 from the image processing apparatus 10 and performs authentication of the certificate 523 in response to a certificate authentication request.

Further, the authentication part 721 sends the authentication result (authentication determination OK: valid authentication information item 52/NG: tampered with authentication information item 52) to the image processing apparatus 10 in response to the authentication request.

Thus, with use of the authentication part 721, the authentication unit 72 can determine whether the certificate 523 held by the image processing apparatus 10 is valid, and send the authentication result to the image processing apparatus 10. That is, the authentication part 721 can confirm that the certificate 523 is not maliciously tampered with and report the appropriateness of the program based on the valid certificate 523 according to the service contract.

The service contractor authentication part 722 is configured to, in order to install an appropriate program into the image processing apparatus 10, receive from the image processing apparatus 10 information (e.g. the public key 54) for identifying a service contractor who requested the installation. The service contractor authentication part 722 thus performs authentication of the service contractor identification information item so as to determine whether the service contractor is valid before installation of the program.

Further, the service contractor authentication part 722 sends the authentication result (authentication determination OK: authenticated service contractor/NG: unauthorized use) to the image processing apparatus 10 in response to the authentication request.

Thus, with use of the service contractor authentication part 722, the authentication unit 72 can determine whether the service contractor is valid based on the service contractor identification information sent from the image processing apparatus 10, and sends the determination result to the image processing apparatus 10. That is, the authentication unit 72 can report whether the function of the image processing apparatus 10 is used maliciously by a person pretending to be a service contractor.

The certificate issuing part 731 of the certificate issuing unit 73 is configured to encrypt the program identification information item 521 and the expiration date information item 522 using the secret key 53 to issue a certificate 523.

The certificate issuing part 731 receives a request for the certificate 523 from the image processing apparatus 10 when the image processing apparatus 10 needs a new authentication information item 52, such as when the authentication information item 52 is updated or when installing a new program into the image processing apparatus 10. The certificate issuing part 731 sends the latest certificate 523 to the image processing apparatus 10 in response to the request.

Thus, with use of the certificate issuing part 731, the certificate issuing unit 73 can issue the certificate 523 containing the program identification information item 521 and the expiration date information item 522 in an encrypted manner, and thus can send the latest certificate 523 managed according to the service contract to the image processing apparatus 10 when the image processing apparatus 10 needs the latest certificate 523.

The program information provision part 741 of the program provision unit 74 is configured to, when installing a new program into the image processing apparatus 10, send to the image processing apparatus 10 a program list containing information about programs that can be installed in the image processing apparatus 10.

The program list sent by the program information provision part 741 to the image processing apparatus 10 is based on the authentication information item 52.

The program provision part 742 of the program provision unit 74 is configured to, when installing a new program into the image processing apparatus 10, send the program the image processing apparatus 10 in response to a request from the image processing apparatus 10.

Thus, with the program information provision part 741 and the program provision part 742, the program provision unit 74 can provide the image processing apparatus 10 with the list of the programs that can be installed in the image processing apparatus 10, and provide the image processing apparatus 10 with the program requested by the image processing apparatus 10 based on the provided program list based on the authentication result. Thus, the program provision unit 74 can provide the image processing apparatus 10 with an appropriate program according to the service contract.

The authentication information update part 751 of the expiration date information management unit 75 is configured to receive a request for updating the expiration date information item 522 according to the service contract when the corresponding program installed in the image processing apparatus 10 has expired or expires soon and therefore the expiration date information item 522 needs to be updated for further use of the program. The authentication information update part 751 updates the expiration date information item 522 in response to the request.

More specifically, the authentication information update part 751 changes the validity date 522a of the expiration date information item 522 based on the renewal term (e.g., one-year contract term) of the expiration date predetermined for each program according to the service contract.

With the authentication information update part 751, the expiration date information management unit 75 can renew the expiration date based on the renewal term predetermined on a per-program basis and thus update the authentication information item 52 held by the management server 20 at the time of renewal of the service contract in response to the request for updating the authentication information item 52 from the image processing apparatus 10.

With use of these component parts of the main function units, the management server 20 can perform authentication and data management necessary for controlling installation of a program and behavior of the installed program in the image processing apparatus 10, and can provide information required by the image processing apparatus 10 in response to a request therefrom.

As described above, in the image processing system of the first embodiment, the image processing apparatus 10 sends the authentication information item 52 containing encrypted information to the management server 20. The management server 20 determines whether the sent authentication information item 52 is valid and sends the authentication result to the image processing apparatus 10. Thus, the image processing apparatus 10 can control the behavior of the corresponding program based on the authentication result.

With this configuration, the image processing system can authenticate the program in the image processing apparatus 10 in units of functions based on the authentication information item 52 containing encrypted information and thus efficiently manage appropriate programs.

The image processing system encrypts the expiration date information item 522 and the program identification information item 521 used for controlling the program behavior in the image processing apparatus 10, and thus can ensure the security of the authentication information item 52.

That is, because the authentication information item 52 exchanged between the image processing apparatus 10 and the management server 20 is encrypted, it is possible to prevent the authentication information item 52 from being maliciously tampered with and thus prevent unauthorized use of the functions of the image processing apparatus 10.

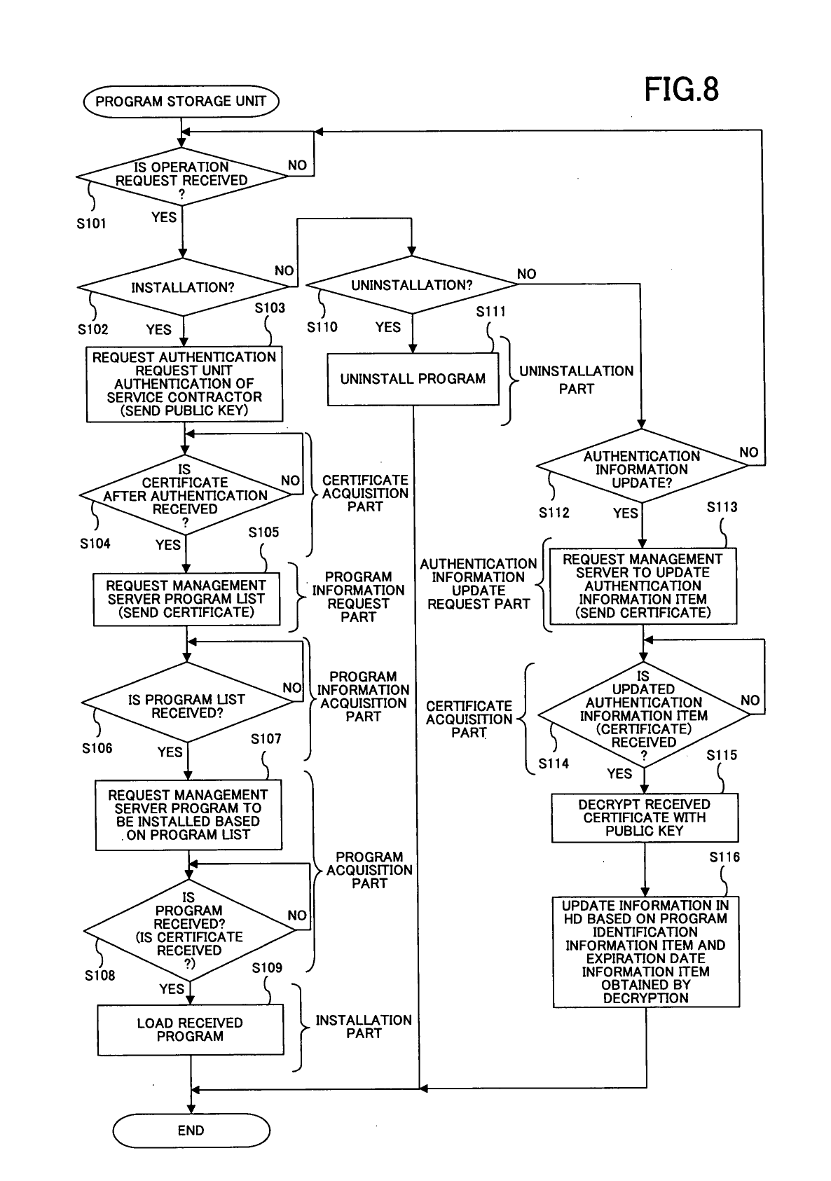

The following describes methods performed by the image processing apparatus 10 and the management server 20 for realizing the installation of a program and the behavior control of the installed program in the image processing system illustrated in FIGS. 6A through 7B with reference to FIGS. 8 through 15.

First, processing performed by the main function units of the image processing apparatus 10 is described in detail with reference to FIGS. 8 through 10.

FIG. 8 is a flowchart illustrating processing performed by the program storage unit 61 in the image processing apparatus 10 according to the first embodiment of the present invention.

The program storage unit 61 waits for an operations request for installation, uninstallation, or update of the authentication information item 52 (S101).

If the program storage unit 61 receives an operations request (YES in S101), the program storage unit 61 determines to which operation (installation, uninstallation, or authentication information update) the operations request is related (S102, S110, and S112).

If the operations request is related to installation (YES in S102), the program storage unit 61 requests the management server 20 to perform authentication of the service contractor. In this step, the program storage unit 61 sends the public key 54 as information for identifying the service contractor to the management server 20 (S103).

If the service contractor is authenticated by the management server 20, the certificate 523 issued after the authentication according to the service contract of the service contractor is sent to the image processing apparatus 10. The program storage unit 61 waits for the certificate acquisition part 612 to receive the certificate sent from the management server 20 after the authentication (S104).

If the certificate 523 for the service contractor is received from the management server 20 (YES in S104), the program storage unit 61 causes the program information request part 613 to request the management server 20 for the program list indicating the installable programs. In this step, the program storage unit 61 sends the received certificate 523 to the management server 20, thereby requesting authentication of the certificate 523 (S105).

If the certificate 523 is authenticated by the management server 20, the program storage unit 61 waits for the program information acquisition part 614 to receive the program list from the management server 20 (S106).

If the program list is received from the management server 20 (YES in S106), the program storage unit 61 causes the program acquisition part 615 to request the management server 20 for a program corresponding to a desired function to be installed based on the program list (S107), and waits for the program sent from the management server 20 (S108).

If the program is received from the management server 20 (YES in S108), the program storage unit 61 causes the installation part 616 to load the received program into the secondary storage unit 13 (S109).

If the operations request is related to uninstallation (NO in S102 and YES in S110), the program storage unit 61 causes the uninstallation part 617 to delete the specified program from the secondary storage unit 13 in units of functions (S111).

If the operations request is related to update of the authentication information item 52 (NO in S102, NO in S110. and YES in S112), the program storage part 61 causes the authentication information update request part 611 to request the management server to update the authentication information item 52. In this step, the program storage unit 61 sends the received certificate 523 to the management server 20, thereby requesting authentication of the certificate 523 (S113).

If the certificate 523 is authenticated by the management server 20, the program storage unit 61 waits for the certificate acquisition part 612 to receive a renewed certificate 523 from the management server 20 (S114).

If the renewed certificate 523 is received from the management server 20 (YES in S114), the program storage unit 61 decrypts the certificate 523 using the public key 54 (S115) and updates the authentication information item 52 that has been held based on the program identification information item 521 and the expiration date information item 522 obtained by the decryption (S116).

If the operations request is not related to installation, uninstallation, or authentication information update (NO in S101, S110, and S112), the process returns to Step S101 in which the program storage unit 61 waits for an operations request for installation, uninstallation, or authentication information update.

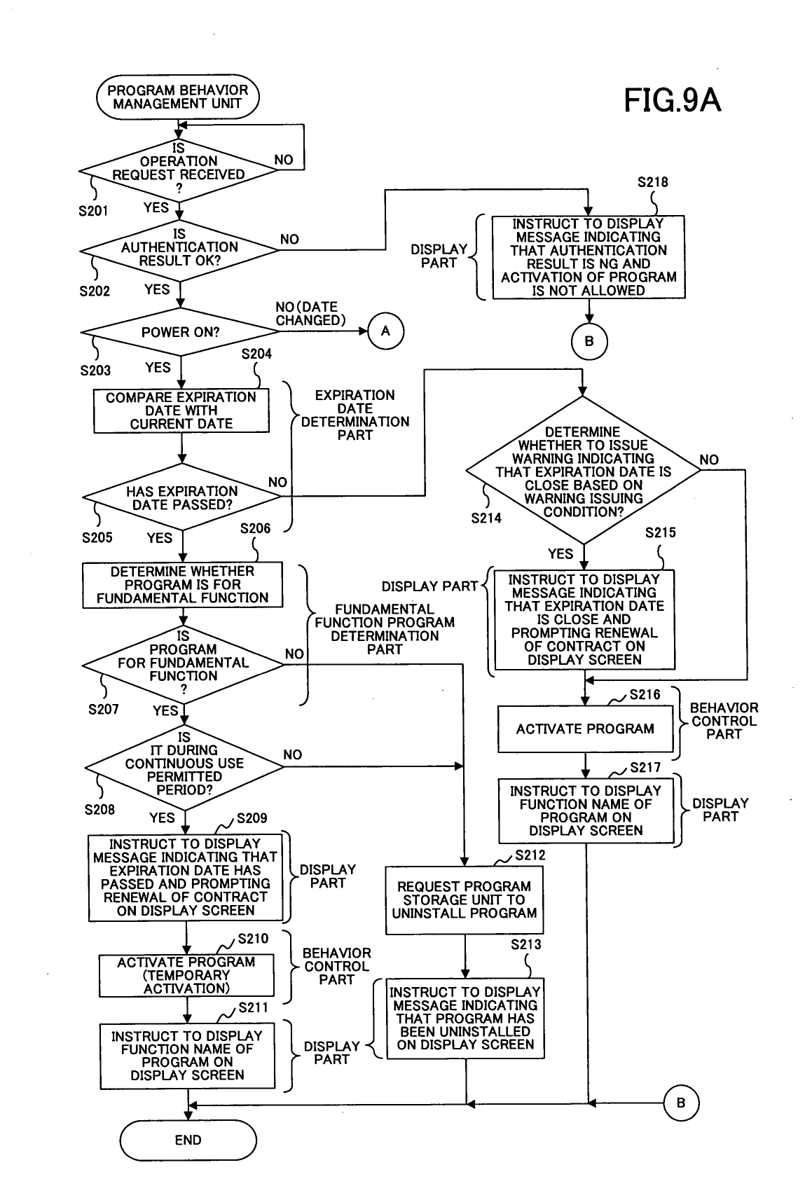

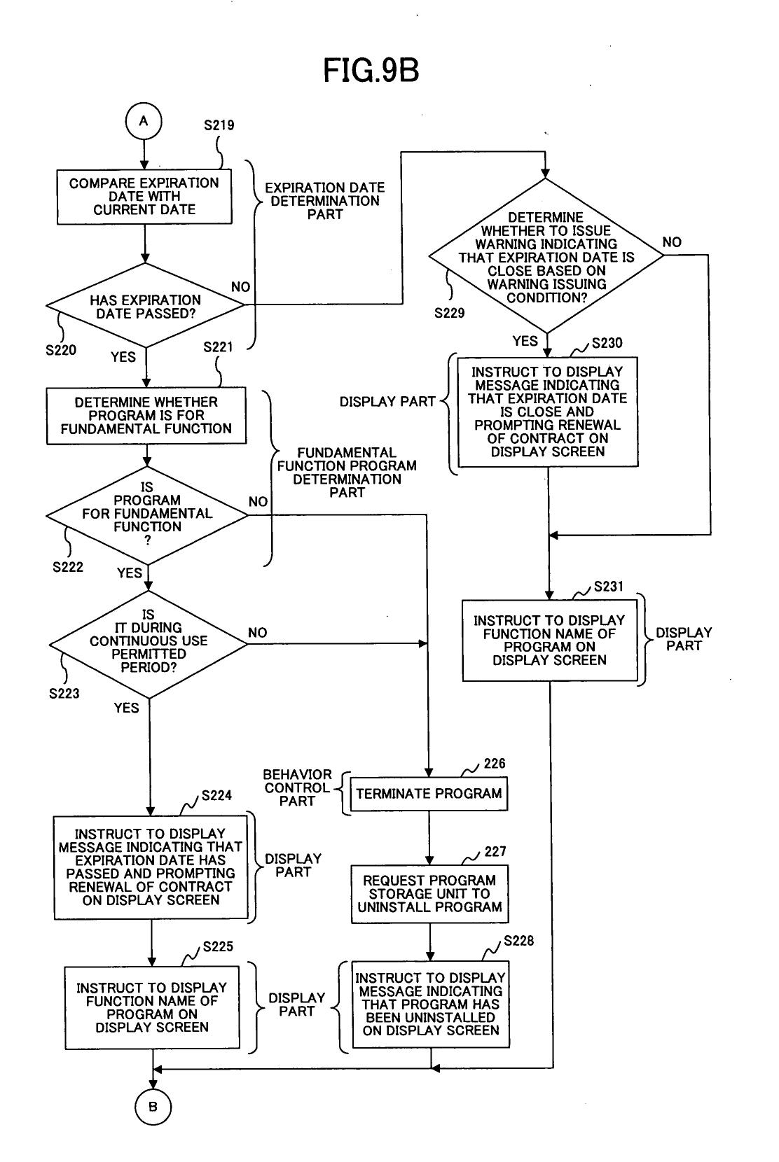

FIGS. 9A and 9B are flowcharts each illustrating processing performed by the program behavior management unit 62 in the image processing apparatus 10 according to the first embodiment of the present invention.

FIG. 9A is a flowchart illustrating processing performed by the program behavior management unit 62 in the image processing apparatus 10 at the time of power-on according to the first embodiment of the present invention.

The program behavior management unit 62 waits for a request for activating an appropriate request issued when the image processing apparatus 10 is turned on or when the date is changed (S201).

If the program activation request is received (YES in S201), the program behavior management part 62 requests the management server 20 to perform authentication of the certificate 523 (i.e. sends the certificate 523 to the management server 20) and waits for the authentication result (authentication determination OK: valid authentication information item 52/NG: tampered with authentication information item 52) from the management server 20 (S202).

If the authentication result sent from the management server 20 is “OK” (authentication determination OK: valid authentication information item 52) (YES in S202), the program behavior management unit 62 determines based on which condition (condition 1: when the image processing apparatus 10 is turned on, condition 2: when the date is changed) the activation request is issued (S203).

If the program activation request is issued based on the condition 1 (“when the image processing apparatus 10 is turned on”) (YES in S203), the program behavior management unit 62 causes the expiration date determination part 622 to compare the validity date 522a of the expiration date information item 522 of the authentication information item 52 managed by the program storage unit 61 and the current date (S204).

The expiration date determination part 622 determines whether the expiration date of the program has passed based on the comparison result (S205).

If the expiration date determination part 622 determines that the expiration date has passed (YES in S205), the program behavior management unit 62 instructs the fundamental function program determination part 623 to determine whether the program is for a fundamental function for the image processing apparatus 10 based on the program identification information item 521 managed by the program storage unit 61 (S206). In response, the fundamental function program determination part 623 determines whether the program is for a fundamental function for the image processing apparatus 10 (S207).

If the fundamental function program determination part 623 determines that the program is for the fundamental function (YES in S207), the program behavior management unit 62 determines whether it is during a period during which continuous use after the expiration date is permitted because of the importance of the function based on the continuous use expiration date 522e of the expiration date information item 522 of the authentication information item 52 managed by the program storage unit 61 (S208).

If it is during the continuous use permitted period (YES in S208), the program behavior management unit 62 causes the display part 624 to display a message indicating that the expiration date of the program has passed and prompting renewal of the service contract on the screen of the display unit 12 (S209).

The program behavior management unit 62 causes the behavior control part 621 to activate the corresponding program for the continuous use permitted period (S210) and displays the function name of the activated program on the screen of the display unit 12 (S211).

If the fundamental function program determination part 623 determines that the program is not for a fundamental function (NO in S207), the program is determined inappropriate for the image processing apparatus 10. Thus the program behavior management unit 62 requests the program storage unit 61 to uninstall the program in units of functions (S212) and causes the display part 624 to display a message indicating that the program has been uninstalled on the screen of the display unit 12 (S213).

If the expiration date determination part 622 determines that the expiration date has not passed (NO in S205), the program behavior management unit 62 determines whether to issue a warning indicating that the expiration date is close based on the warning issuing condition 522c of the expiration date information item 522 of the authentication information item 52 managed by the program storage unit 61 (S214).

If it is determined to issue a warning (YES in S214), the program behavior management unit 62 causes the display part 624 to display a message indicating that the expiration date is close and prompting renewal of the service contract before the expiration date on the screen of the display unit 12 (S215).

Then the program behavior management unit 62 causes the behavior control part 621 to activate the corresponding program (S216) and displays the function name of the activated program on the screen of the display unit 12 (S217).

If the authentication result sent from the management server 20 is “NG” (authentication determination NG: tampered with authentication information item 52) (NO in S202), the program behavior management unit 62 causes the display part 624 to display a message indicating that the certificate 523 is invalid and therefore the activation of the program is not allowed, and does not activate the program (S218).

FIG. 9B is a flowchart illustrating processing performed by the program behavior management unit 62 in the image processing apparatus 10 when the date is changed according to the first embodiment of the present invention.

If the program activation request is issued based on the condition 2 (“when the date is changed”) (NO in S203: A), the program behavior management unit 62 causes the expiration date determination part 622 to compare the validity date 522a of the expiration date information item 522 of the authentication information item 52 managed by the program storage unit 61 and the current date (S219).

The expiration date determination part 622 determines whether the expiration date of the program has passed based on the comparison result (S220).

If the expiration date determination part 622 determines that the expiration date has passed (YES in S220), the program behavior management unit 62 instructs the fundamental function program determination part 623 to determine whether the program is for a fundamental function for the image processing apparatus 10 based on the program identification information item 521 managed by the program storage unit 61 (S221). In response, the fundamental function program determination part 623 determines whether the program is for a fundamental function for the image processing apparatus 10 (S222).

If the fundamental function program determination part 623 determines that the program is for the fundamental function (YES in S222), the program behavior management unit 62 determines whether it is during a period during which continuous use after the expiration date is permitted because of the importance of the function based on the continuous use expiration date 522e of the expiration date information item 522 of the authentication information item 52 managed by the program storage unit 61 (S223).

If it is during the continuous use permitted period (YES in S223), the program behavior management unit 62 causes the display part 624 to display a message indicating that the expiration date of the program has passed and prompting renewal of the service contract on the screen of the display unit 12 (S224).

Then, the program behavior management unit 62 causes the behavior control part 621 to display the function name of the activated program on the screen of the display unit 12 for the continuous use permitted period (S225).

If the fundamental function program determination part 623 determines that the program is not for a fundamental function (NO in S220), the use of the program by the image processing apparatus 10 is determined inappropriate for the image processing apparatus 10. Thus the program behavior management unit 62 terminates the program (S226) and requests the program storage unit 61 to uninstall the program in units of functions (S227).

Then, the program behavior management unit 62 causes the display part 624 to display a message indicating that the program has been uninstalled on the screen of the display unit 12 (S228).

If the expiration date determination part 622 determines that the expiration date has not passed (NO in S220), the program behavior management unit 62 determines whether to issue a warning indicating that the expiration date is close based on the warning issuing condition 522c of the expiration date information item 522 of the authentication information item 52 managed by the program storage unit 61 (S229).

If it is determined to issue a warning (YES in S229), the program behavior management unit 62 causes the display part 624 to display a message indicating that the expiration date of the program is close and prompting renewal of the service contract before the expiration on the screen of the display unit 12 (S230).

Then, the program behavior management unit 62 causes the behavior control part 621 to display the function name of the running program on the screen of the display unit 12 (S231).

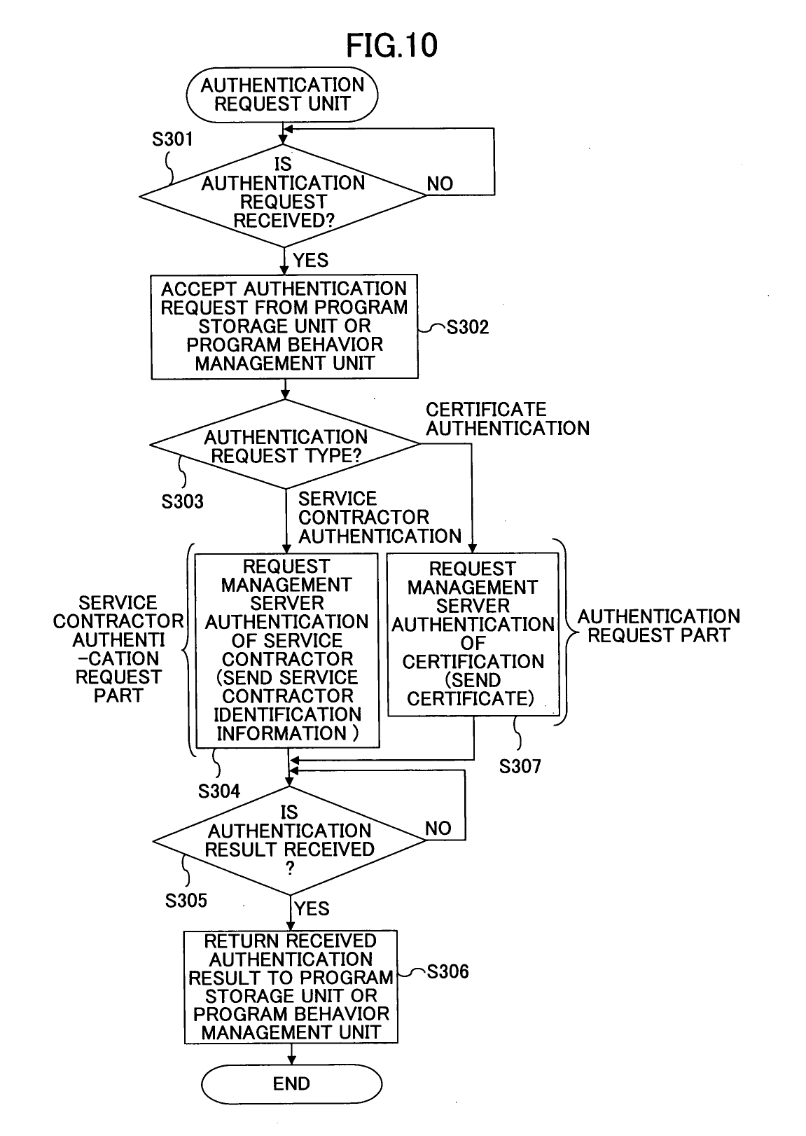

FIG. 10 is a flowchart illustrating processing performed by the authentication request unit 63 in the image processing apparatus 10 according to the first embodiment of the present invention.

The authentication request unit 63 waits for an authentication request from the program storage unit 61 or the program behavior management unit 62 (S301).

The authentication request unit 63 receives an authentication request (S302), and determines the type of the authentication request (service contractor authentication or certificate authentication) (S303).

If the authentication request unit 63 receives an authentication request for authenticating a service contractor (“service contractor” in S303), the service contractor authentication request part 632 sends the public key 54 as service contractor identification information to the management server 20, thereby requesting authentication (S304).

If the authentication request unit 63 receives a certificate authentication request (“certificate” in S303), the authentication request part 631 sends the certificate 523 to the management server 20, thereby requesting authentication (S307).

The authentication request unit 63 waits for an authentication result (authentication determination OK: authenticated service contractor/NG: unauthorized use in the case of service contractor authentication, authentication determination OK: valid authentication information item 52/NG: tampered with authentication information item 52 in the case of certificate authentication) from the management server 20 (S305).

If the authentication result is received from the management server 20 (YES in S305), the authentication request unit 63 returns the received authentication result to the program storage unit 61 or the program behavior management unit 62 (S306).

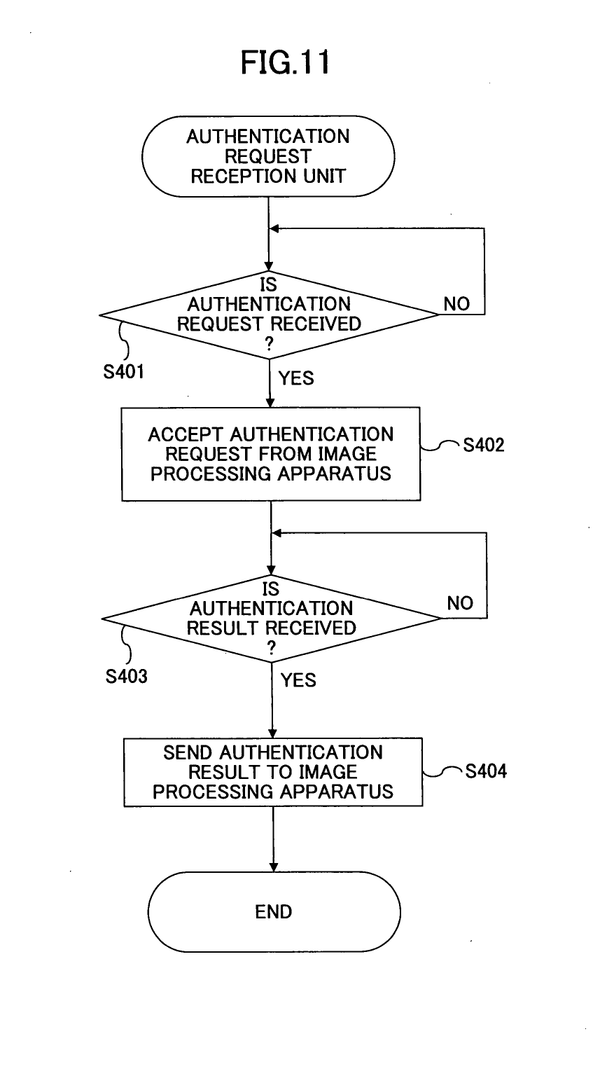

Next, processing performed by the main function units of the management server 20 is described in detail with reference to FIGS. 11 through 15.

FIG. 11 is a flowchart illustrating processing performed by the authentication request reception unit 71 in the management server 20 according to the first embodiment of the present invention.

The authentication request reception unit 71 waits for an authentication request (the public key 54 or the certificate 523) from the image processing apparatus 10 (S401).

Then, the authentication request reception unit 71 receives an authentication request (the public key 54 or the certificate 523), and transfers the received authentication request to the authentication unit 72 (S402).

Then the authentication request reception unit 71 receives an authentication result from the authentication unit 72 (S403). If the authentication result is received (YES in S403), the authentication request reception unit 71 sends the authentication result to the image processing apparatus 10 (S404).

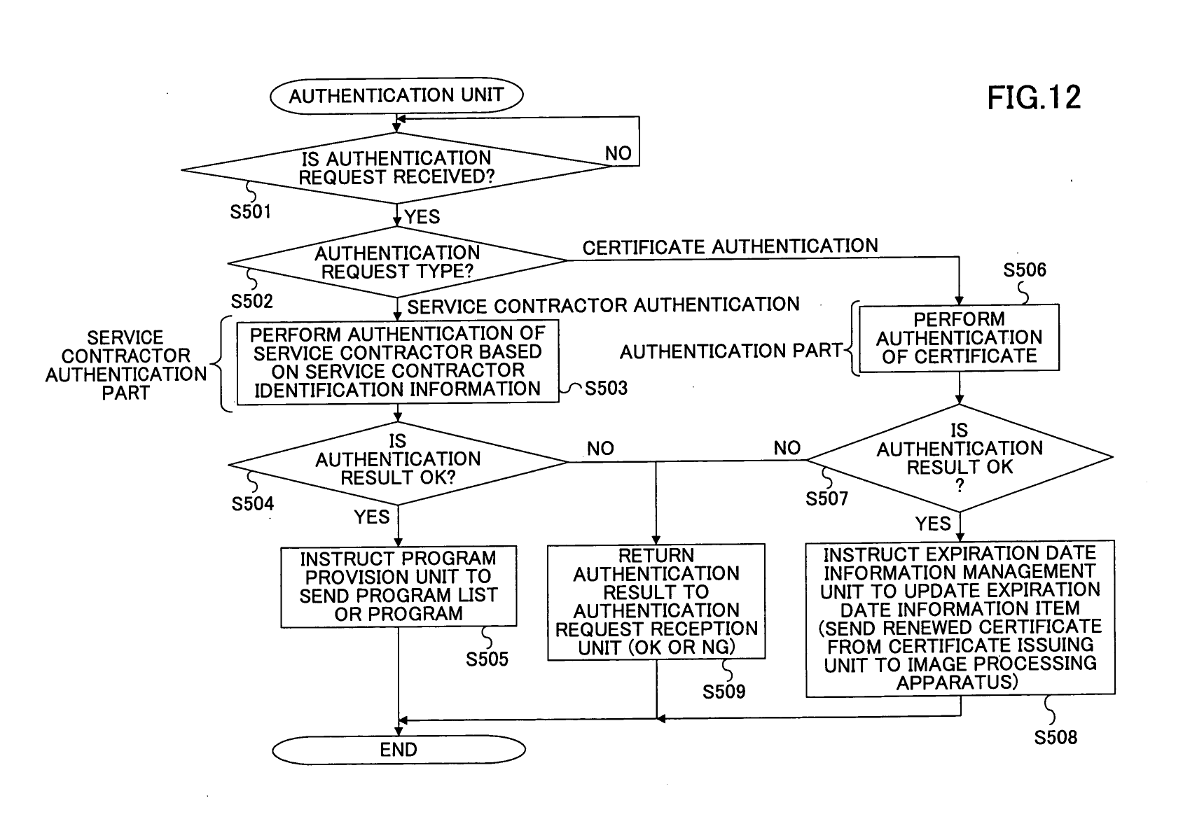

FIG. 12 is a flowchart illustrating processing performed by the authentication unit 72 in the management server 20 according to the first embodiment of the present invention.

The authentication unit 72 waits for an authentication request from the authentication request reception unit 71 (S501).

If an authentication request is received (YES in S501), the authentication unit 72 determines whether the received authentication request is for service contractor authentication or certificate authentication (S502).

If the authentication request is for service contractor authentication (“service contractor authentication” in Step S502), the authentication unit 72 causes the service contractor authentication part 722 to perform authentication of a service contractor based on the received public key 54 (S503).

The authentication unit 72 determines whether the authentication result of the service contractor authentication part 722 is “authenticated service contractor (authentication determination: OK) or “unauthorized use (authentication determination: NG)” (S504). If the authentication result is “authenticated service contractor (authentication determination: OK) (YES in S504), the authentication unit 72 instructs the program provision unit 74 to send the program list indicating information about the installable programs or the installable program (S505).

If the authentication result is “unauthorized use (authentication determination: NG)” (NO in S504), the authentication unit 72 transfers the authentication result (authentication determination: NG) to the authentication request reception unit 71 and instructs the authentication request reception unit 71 to send the authentication result to the image processing apparatus 10 (S509).

If the authentication request is for certificate authentication (“certificate authentication” in Step S502), the authentication part 721 performs authentication of the received certificate 523 (S506).

The authentication unit 72 determines whether the authentication result of the authentication part 721 is “valid authentication information item 52 (authentication determination: OK) or “tampered with authentication information item 52 (authentication determination: NG)” (S507). If the authentication result is “valid authentication information item 52 (authentication determination: OK) (YES in S507), the authentication unit 72 sends the authentication result (authentication determination: OK) to the expiration date information management unit 75 and instructs the expiration date information management unit 75 to update the expiration date information item 522 of the authentication information item 52 and send a new certificate 523 to the image processing apparatus 10 (S508).

If the authentication result is “tampered with authentication information item 52 (authentication determination: NG)” (NO in S507), the authentication unit 72 transfers the authentication result (authentication determination: NG)” to the authentication request reception unit 71 and instructs the authentication request reception unit 71 to send the authentication result to the image processing apparatus 10 (S509).

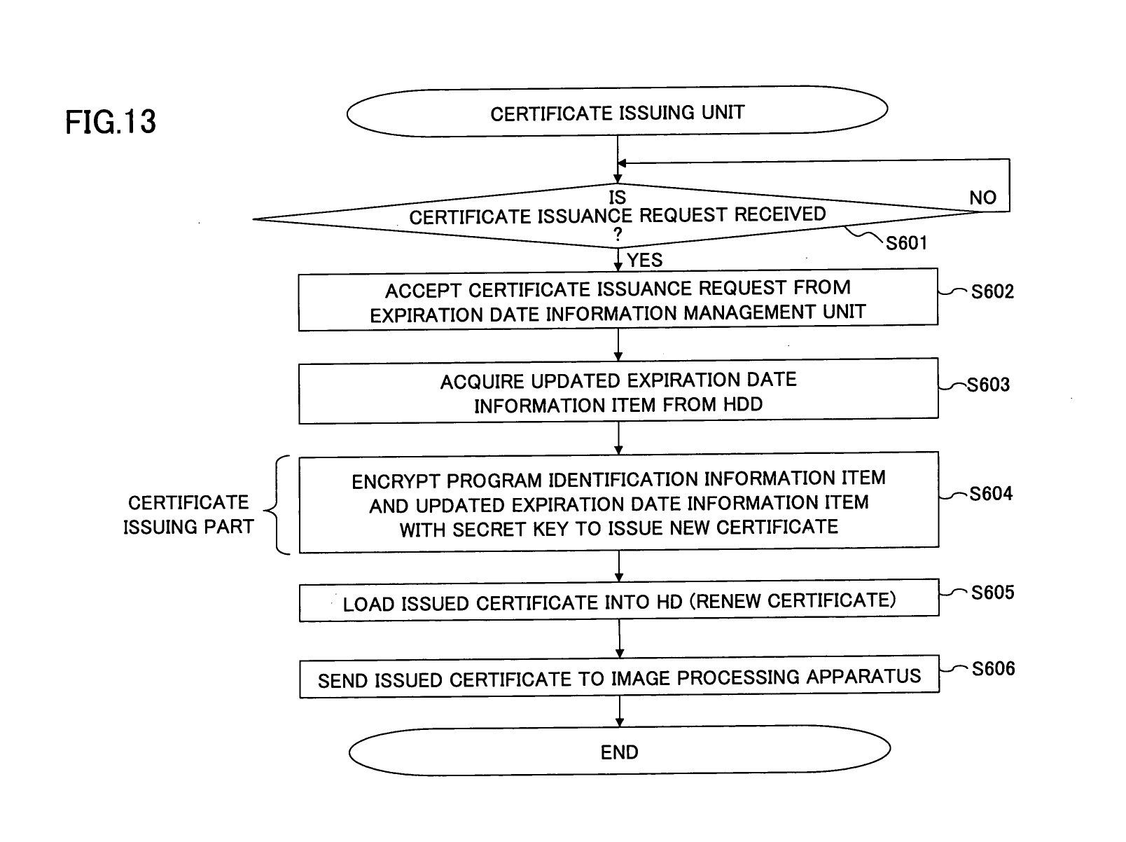

FIG. 13 is a flowchart illustrating processing performed by the certificate issuing unit 73 in the management server 20 according to the first embodiment of the present invention.

The certificate issuing unit 73 waits for a request for issuing a new certificate 523 from the expiration date information management unit 75 (S601).

If a certificate issuance request is received (YES in S601), the certificate issuing unit 73 accepts the certificate issuance request (S602) and acquires the updated authentication information item 52 from the secondary storage unit 13 (S603).

The certificate issuing unit 73 causes the certificate issuing part 731 to encrypt a program identification information item 521 and an expiration date information item 522 of the acquired authentication information item 52 using the secret key 53, thereby issuing a new certificate 523 (S604).

Then the certificate issuing unit 73 loads the newly issued certificate 523 into the secondary storage unit 13 (S605) and also sends the new certificate 523 to the image processing apparatus 10 (S606).

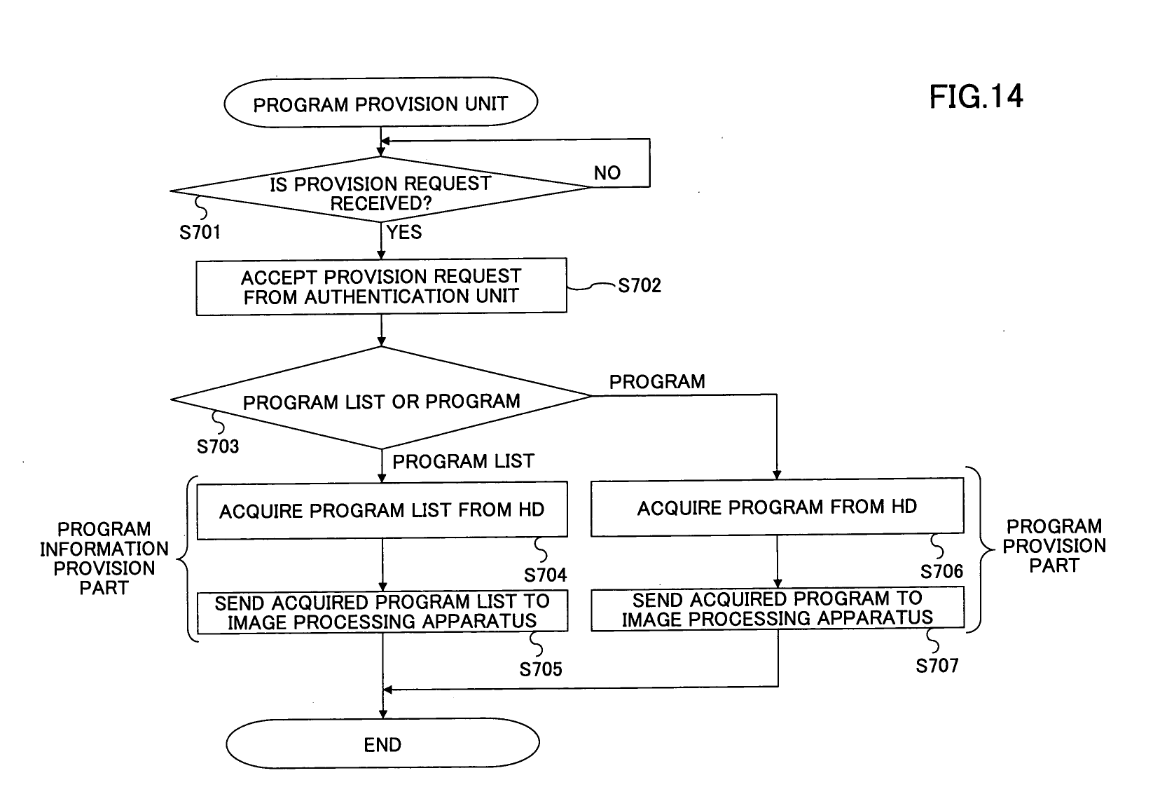

FIG. 14 is a flowchart illustrating processing performed by the program provision unit 74 in the management server 20 according to the first embodiment of the present invention.

The program provision unit 74 waits for a request for providing a program list or a program from the authentication unit 72 (S701).

If a program list provision request or a program provision request is received (YES in S701), the program provision unit 74 determines whether the received request is a program list provision request or a program provision request (S703).

If the received request is a program list provision request (“program list” in S703), the program provision unit 74 causes the program information provision part 741 to acquire a program list from the secondary storage unit 13 (S704) and send the acquired program list to the image processing apparatus 10 (S705).

If the received request is a program provision request (“program” in S703), the program provision unit 74 causes the program information provision part 741 to acquire a program from the secondary storage unit 13 (S706) and send the acquired program to the image processing apparatus 10 (S707).

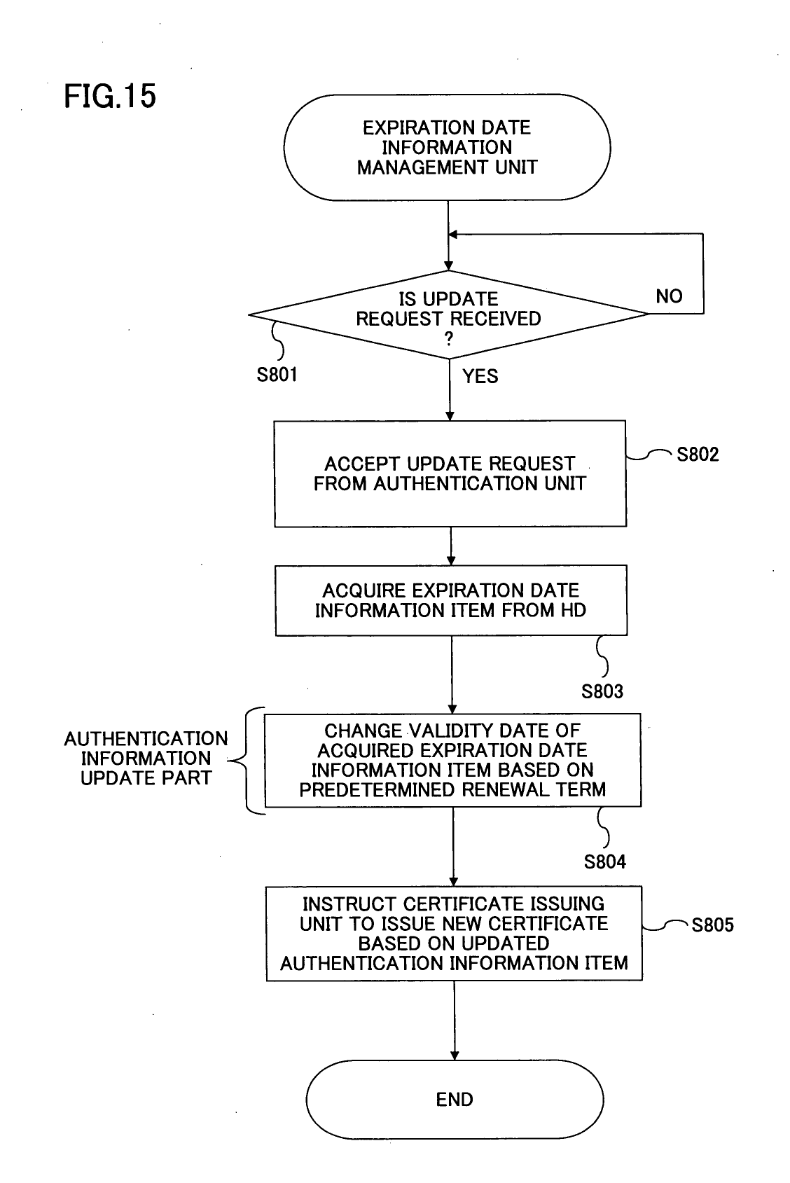

FIG. 15 is a flowchart illustrating processing performed by the expiration date information management unit 75 in the management server 20 according to the first embodiment of the present invention.

The expiration date information management unit 75 waits for a request for updating the expiration date information item 522 of the authentication information item 52 from the authentication unit 72 (S801).

If a request for updating the expiration date information item 522 is received (YES in S801), the expiration date information management unit 75 accepts the request (S802) and acquires the expiration date information item 522 of the authentication information item 52 from the secondary storage unit 13 (S803). Then the expiration date information management unit 75 causes the authentication information update part 751 to change the validity date 522a of the acquired expiration date information item 522 based on the renewal term of the expiration date predetermined for each program according to the service contract and loads the updated expiration date information item 522 into the secondary storage unit 13 (S804).

Then the expiration date information management unit 75 instructs the certificate issuing unit 73 to issue a new certificate 523 based on the authentication information item 52 containing the updated expiration date information item 522 and send the new certificate 523 to the image processing apparatus 10 (S805).

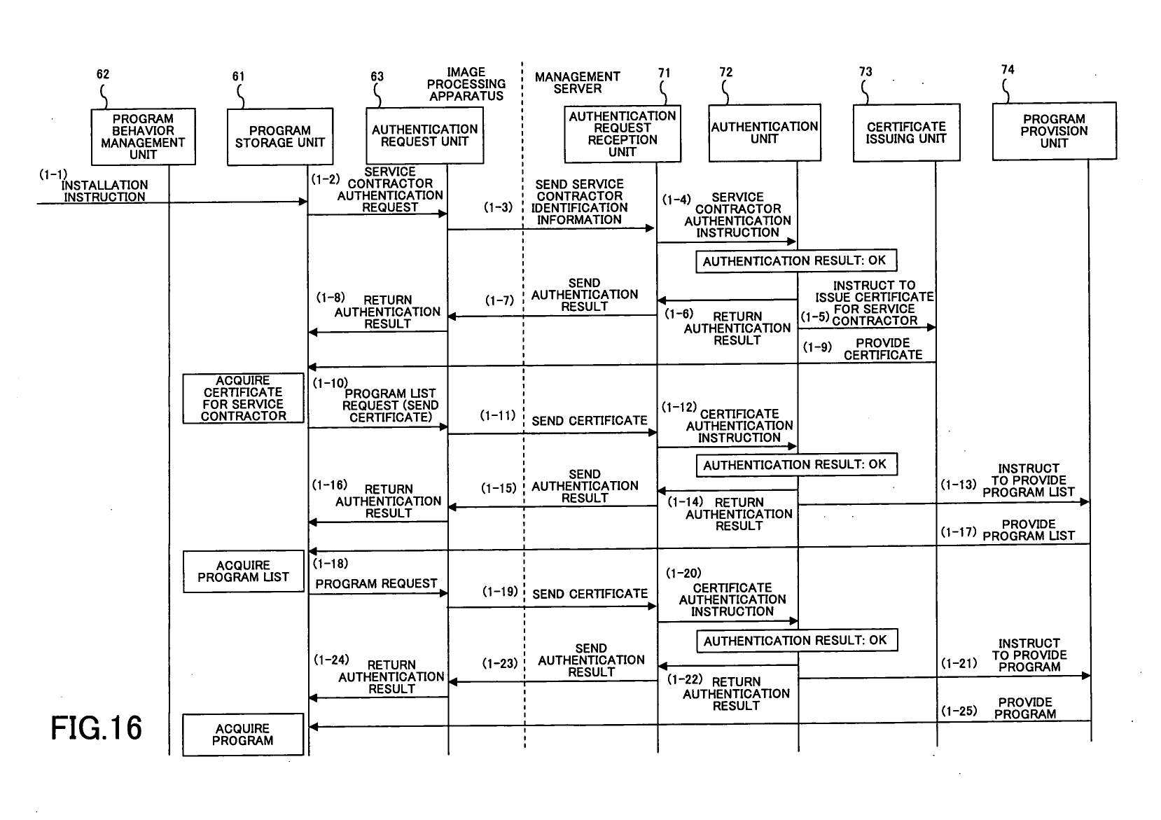

The following describes processes of installing and uninstalling a program, activating and terminating a program, and updating the authentication information item 52 in the image processing system with reference to FIGS. 16 through 19 in order to clarify the relationship between the image processing apparatus 10 and the management server 20 illustrated in FIG. 8 through FIG. 15.

FIG. 16 is a sequence diagram showing a process of installing a program according to the first embodiment of the present invention.

When the program storage unit 61 of the image processing apparatus 10 receives an installation instruction (1-1), the program storage unit 61 requests the authentication request unit 63 to perform service contractor authentication (1-2).

Then the authentication request unit 63 sends the public key 54 held by the image processing apparatus 10 to the management server 20, thereby requesting the management server 20 to perform the service contractor authentication (1-3).

The authentication request reception unit 71 of the management server 20 receives the public key 54 sent from the image processing apparatus 10, and transfers the received public key 54 to the authentication unit 72, thereby instructing the authentication unit 72 to perform the service contractor authentication (1-4).

The authentication unit 72 performs the authentication of the service contractor based on the received public key 54. If the authentication result is “authentication determination: OK”, the authentication unit 72 instructs the certificate issuing unit 73 to issue a certificate 523 for the service contractor (1-5) and returns the authentication result (authentication determination: OK) to the authentication request reception unit 71 (1-6). In response, the authentication request reception unit 71 sends the authentication result to the image processing apparatus 10 (1-7).

Then, the authentication request unit 63 of the image processing apparatus 10 returns the authentication result to the program storage unit 61 (1-8).

The certificate issuing unit 73 of the management server 20 sends the issued certificate 523 to the program storage unit 61 of the image processing apparatus 10 (1-9).

In this way, the management server 20 confirms the authenticity of the service contractor and issues the certificate 523 for the service contractor to the image processing apparatus 10.

Then, the program storage unit 61 of the image processing apparatus 10 requests the authentication request unit 63 to acquire a program list (1-10).

Then the authentication request unit 63 sends the acquired certificate 523 to the management server 20, thereby requesting the management server 20 to perform authentication of the certificate 523 (1-11).

The authentication request reception unit 71 of the management server 20 transfers the received certificate 523 to the authentication unit 72, thereby instructing the authentication unit 72 to perform the authentication of the certificate 523 (1-12).

The authentication unit 72 performs the authentication of the received certificate 523. If the authentication result is “authentication determination: OK”, the authentication unit 72 instructs the program provision unit 74 to provide a program list according to the service contract (1-13) and returns the authentication result (authentication determination: OK) to the authentication request reception unit 71 (1-14). In response, the authentication request reception unit 71 sends the authentication result to the image processing apparatus 10 (1-15).

Then, the authentication request unit 63 of the image processing apparatus 10 returns the authentication result to the program storage unit 61 (1-16).

The program provision unit 74 of the management server 20 sends the program list to the program storage unit 61 of the image processing apparatus 10 (1-17).

In this way, the management server 20 confirms the validity of the certificate 523, and the image processing apparatus 10 receives the program list indicating the information about installable programs from the management server 20.

Then, the program storage unit 61 of the image processing apparatus 10 requests the authentication request unit 63 to acquire a program to be installed (1-18).

The authentication request unit 63 sends the certificate 523 to the management server 20, thereby requesting the management server 20 to perform authentication of the certificate 523 (1-19).

The authentication request reception unit 71 of the management server 20 transfers the received certificate 523 to the authentication unit 72, thereby instructing the authentication unit 72 to perform the authentication of the certificate 523 (1-20).

The authentication unit 72 performs the authentication of the received certificate 523. If the authentication result is “authentication determination: OK”, the authentication unit 72 instructs the program provision unit 74 to provide the program according to the service contract (1-21) and returns the authentication result (authentication determination: OK) to the authentication request reception unit 71 (1-22). In response, the authentication request reception unit 71 sends the authentication result to the image processing apparatus 10 (1-23).

Then, the authentication request unit 63 of the image processing apparatus 10 returns the authentication result to the program storage unit 61 (1-24).

The program provision unit 74 of the management server 20 sends the program to the program storage unit 61 of the image processing apparatus 10 (1-25).

In this way, the image processing apparatus 10 acquires the program to be installed from the management server 20 based on the program list and installs the acquired program.

Thus, the image processing system of the first embodiment makes it possible to install a program according to the service contract.

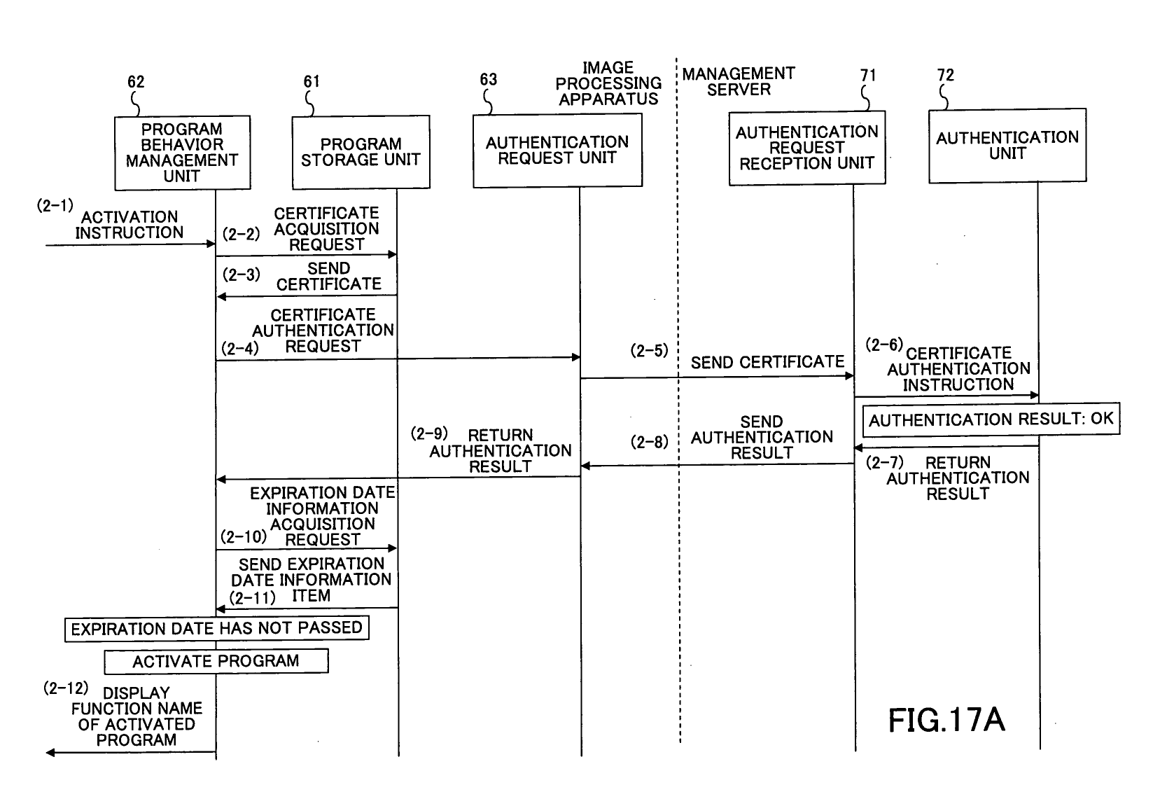

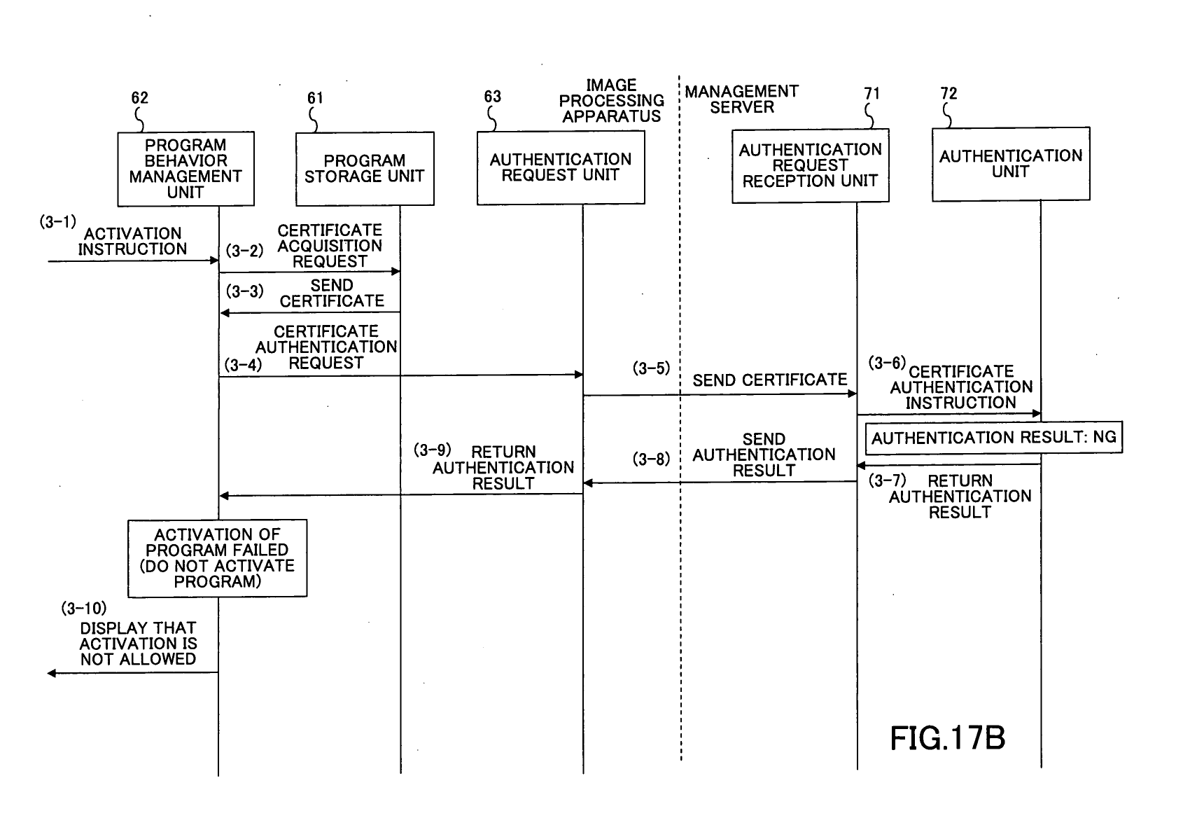

FIGS. 17A and 17B are sequence diagrams each showing a process of activating a program according to the first embodiment of the present invention.

FIG. 17A is a sequence diagram showing a processing flow in the case where the result of authentication performed when activating a program at the time of power-on is OK according to the first embodiment of the present invention.

When the image processing apparatus 10 is turned on, the program behavior management unit 62 of the image processing apparatus 10 receives an instruction for activating a program (2-1).

Then the program behavior management unit 62 requests the program storage unit 61 the certificate 523 (2-2); receives the certificate 523 sent in response to the request (2-3); and requests the authentication request unit 63 to perform authentication of the certificate 523 (2-4).

The authentication request unit 63 sends the certificate 523 to the management server 20, thereby requesting the management server 20 to perform the authentication of the certificate 523 (2-5).

The authentication request reception unit 71 of the management server 20 receives the certificate 523 sent from the image processing apparatus 10, and transfers the received certificate 523 to the authentication unit 72, thereby instructing the authentication unit 72 to perform the authentication of the certificate 523 (2-6).

The authentication unit 72 performs the authentication of the received certificate 523 and returns the authentication result (authentication determination: OK) to the authentication request reception unit 71 (2-7). In response, the authentication request reception unit 71 sends the authentication result to the image processing apparatus 10 (2-8).

Then, the authentication request unit 63 of the image processing apparatus 10 returns the authentication result to the program behavior management unit 62 (2-9).

Then the program behavior management unit 62 requests the expiration date information item 522 of the authentication information item 52 managed by the program storage unit 61 (2-10); receives the expiration date information item 522 sent in response to the request (2-11); and performs expiration date determination based on the validity date 522a of the received expiration date information item 522.

According to the result of the expiration date determination indicating that the expiration date of the program to be activated has not passed, the program behavior management unit 62 activates the program, and instructs the display unit 12 to display the name of the displayed program on the screen (2-12).

FIG. 17B is a sequence diagram showing a processing flow in the case where the result of authentication performed when activating a program at the time of power-on is NG according to the first embodiment of the present invention.

In the processing flow shown in FIG. 17B, (3-1) through (3-9) are the same as (2-1) through (2-9) shown in FIG. 17A except that the authentication result of the certificate 523 by the management server 20 is NG, and therefore these steps are not described herein. The following describes the difference (i.e. the program is not activated) from the processing flow of FIG. 17A.

According to the certificate authentication result (authentication determination: NG) from the management server 20, the program behavior management unit 62 of the image processing apparatus 10 does not activate the program, and instructs the display unit 12 to display a message indicating that activation of the program is not allowed because the authentication result is NG (i.e. because the certificate 523 of the service contractor is determined to be invalid) (3-10).

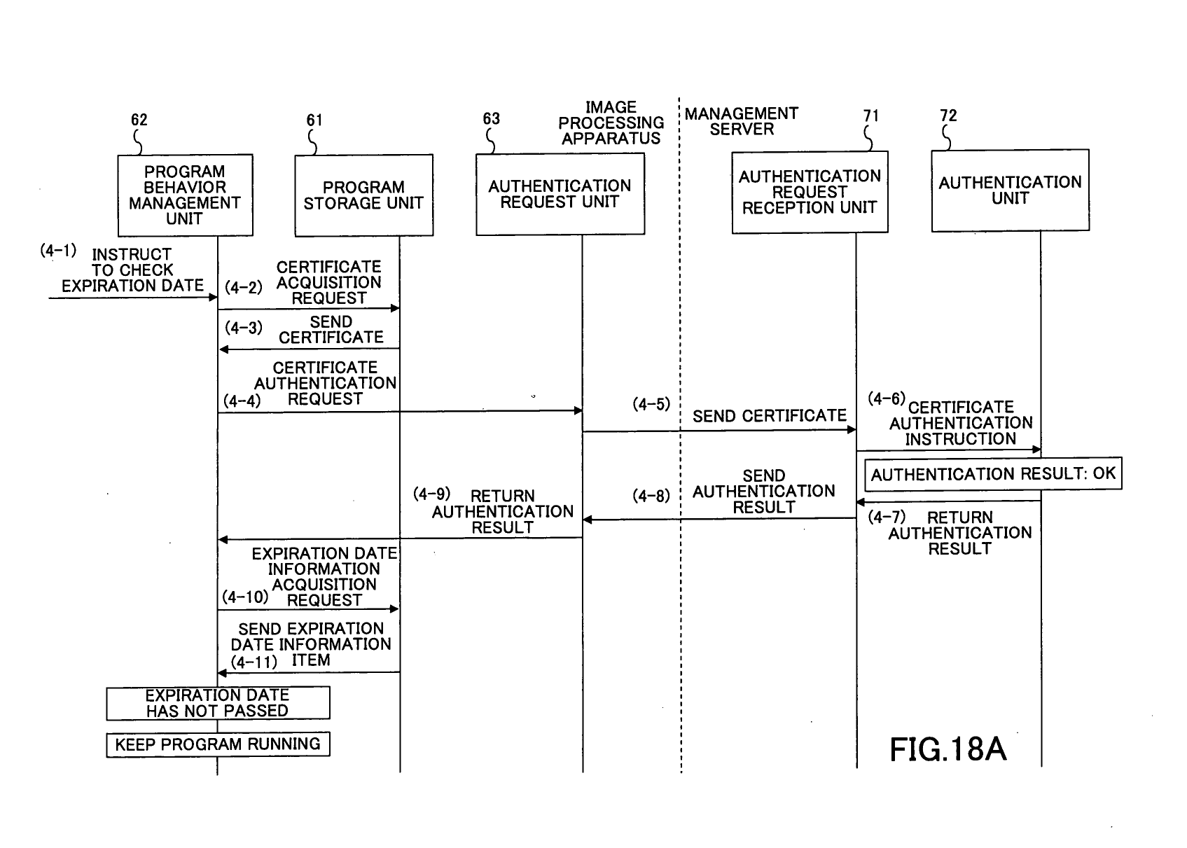

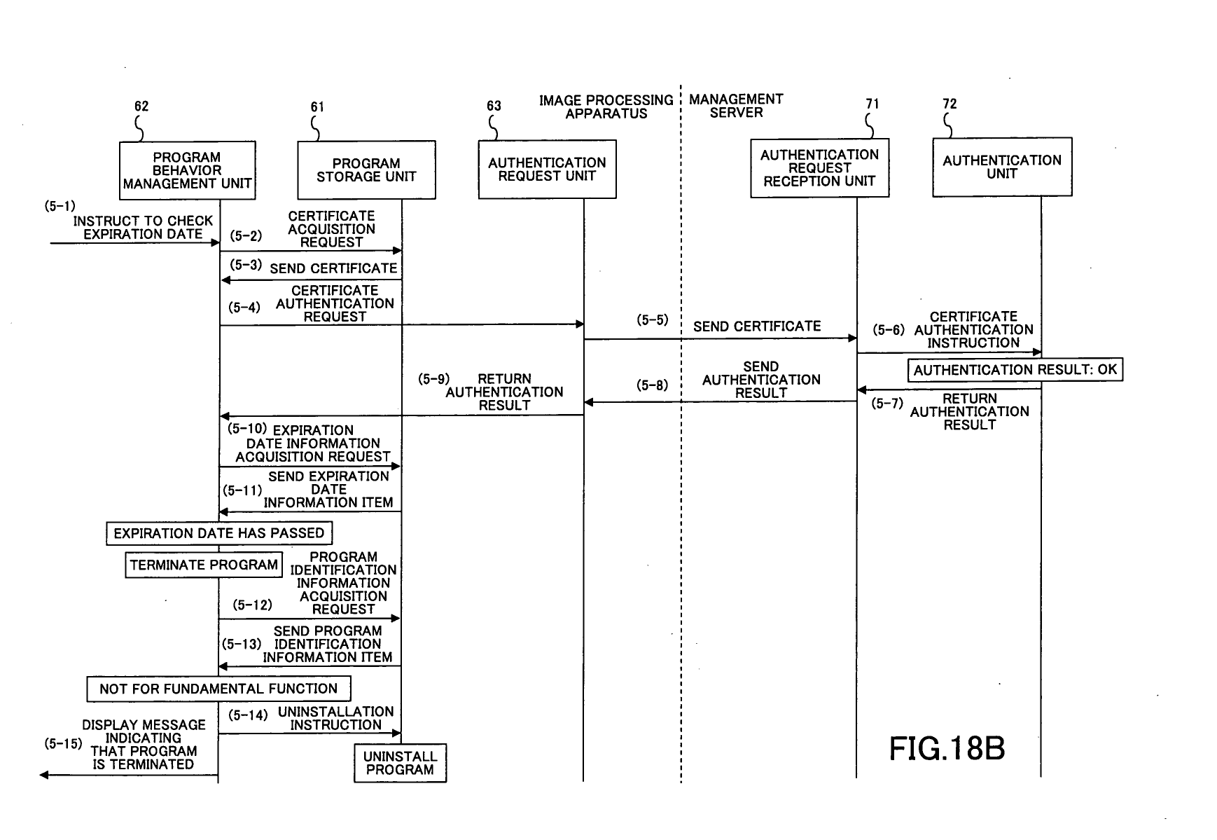

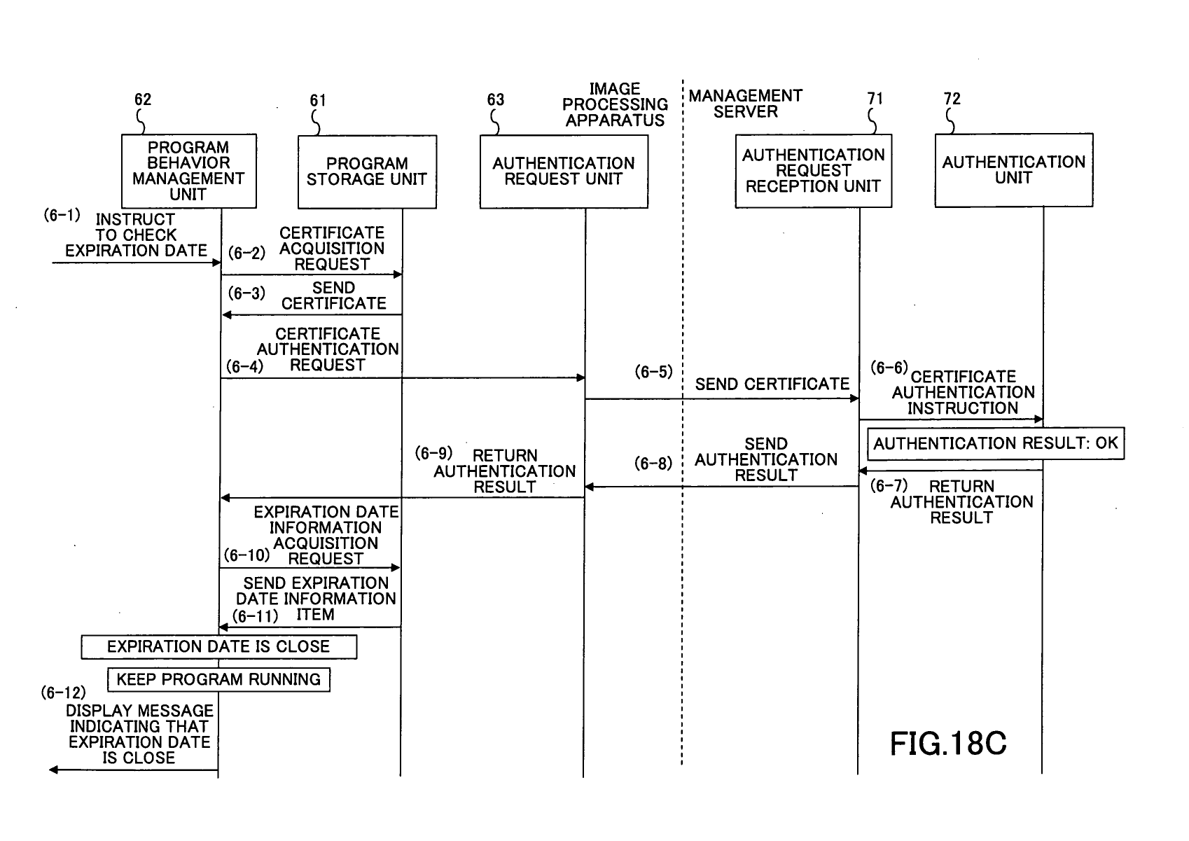

FIGS. 18A through 18C are sequence diagrams each showing a processing flow performed when the date is changed according to the first embodiment of the present invention.

FIG. 18A is a sequence diagram showing a processing flow in the case where the result of an expiration date determination performed when the date is changed is “the expiration date has not passed” according to the first embodiment of the present invention.

When the date is changed while a program is running, the program behavior management unit 62 of the image processing apparatus 10 receives an instruction for checking the expiration date of the program (4-1).

Then the program behavior management unit 62 requests the program storage unit 61 for the certificate 523 (4-2); receives the certificate 523 sent in response to the request (4-3); and requests the authentication request unit 63 to perform authentication of the certificate 523 (4-4).

The authentication request unit 63 sends the certificate 523 to the management server 20, thereby requesting the management server 20 to perform the authentication of the certificate 523 (4-5).

The authentication request reception unit 71 of the management server 20 transfers the received certificate 523 to the authentication unit 72, thereby instructing the authentication unit 72 to perform the authentication of the certificate 523 (4-6).

The authentication unit 72 performs the authentication of the received certificate 523 and returns the authentication result (authentication determination: OK) to the authentication request reception unit 71 (4-7). In response, the authentication request reception unit 71 sends the authentication result to the image processing apparatus 10 (4-8).

Then, the authentication request unit 63 of the image processing apparatus 10 returns the authentication result to the program behavior management unit 62 (4-9).

Then the program behavior management unit 62 requests the expiration date information item 522 of the authentication information item 522 managed by the program storage unit 61 (4-10); receives the expiration date information item 522 sent in response to the request (4-11); and performs expiration date determination based on the validity date 522a of the received expiration date information item 522.

According to the result of the expiration date determination indicating that the expiration date of the program to be activated is determined has not passed, the program behavior management unit 62 keeps the program running.

Thus, the image processing system of the first embodiment makes it possible to control the program behavior according to the service contract.

FIG. 18B is a sequence diagram showing a processing flow in the case where the result of expiration date determination performed when the date is changed is “the expiration date has passed” according to the first embodiment of the present invention.

In the processing flow shown in FIG. 18B, (5-1) through (5-11) are the same as (4-1) through (4-11) shown in FIG. 18A, and therefore are not described herein. The following describes the difference (i.e. the running program is terminated because the expiration date has passed) from the processing flow of FIG. 18A.

According to the expiration date determination result (the expiration date has passed) from the management server 20, the program behavior management unit 62 of the image processing apparatus 10 terminates the running program.

Then the program behavior management unit 62 requests acquisition of the program identification information item 521 of the authentication information item 52 managed by the program storage unit 61 (5-12); receives the program identification information item 521 sent in response to the request (5-13); and performs fundamental function program determination based on the program identification code 521a of the received program identification information item 521.

If the program is determined not to be for a fundamental function, the program behavior management unit 62 instructs the program storage unit 61 to delete the program from the secondary storage unit 13 (5-14); and causes the display unit 12 to display a message indicating that the program that has been running is terminated and uninstalled because the program has expired and is not for a fundamental function (5-15).

Thus, the image processing system of the first embodiment makes it possible to uninstall the program not allowed according to the service contract.

FIG. 18C is a sequence diagram showing a processing flow in the case where the result of expiration date determination performed when the date is changed is “the expiration date is close” according to the first embodiment of the present invention.

In the processing flow shown in FIG. 18C, (6-1) through (6-11) are the same as (4-1) through (4-11) shown in FIG. 18A and (5-1) through (5-11) shown in FIG. 18B, and therefore are not described herein. The following describes the difference (i.e. renewal of the service contract is requested because the expiration date is close) from the processing flows of FIGS. 18A and 18B.

According to the expiration date determination result (the expiration date is close), the program behavior management unit 62 of the image processing apparatus 10 instructs the display unit 12 to display a message indicating that the expiration date is close and prompting renewal of the service contract on the screen (6-12).

Thus, the image processing system of the first embodiment makes possible the prompt renewal of the service contract before the expiration date.

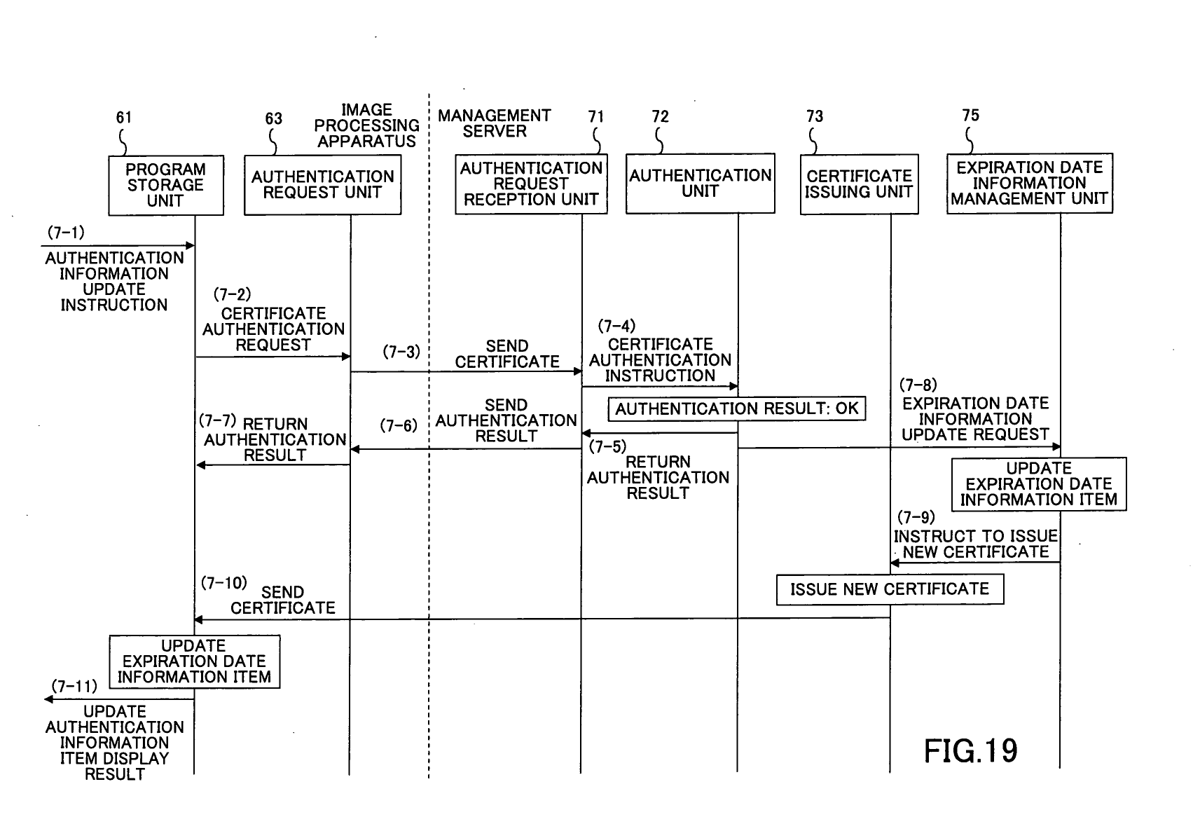

FIG. 19 is a sequence diagram showing a process of updating the authentication information item 52 according to the first embodiment of the present invention.

When the program storage unit 61 of the image processing apparatus 10 receives an instruction for updating the authentication information item 52 (7-1), the program storage unit 61 requests the authentication request unit 63 to perform authentication of the certificate 523 (7-2).

The authentication request unit 63 sends the certificate 523 to the management server 20, thereby requesting the management server 20 to perform the authentication of the certificate 523 (7-3).

The authentication request reception unit 71 of the management server 20 transfers the received certificate 523 to the authentication unit 72, thereby instructing the authentication unit 72 to perform the authentication of the certificate 523 (7-4).

The authentication unit 72 performs the authentication of the received certificate 523 and returns the authentication result (authentication determination: OK) to the authentication request reception unit 71 (7-5). In response, the authentication request reception unit 71 sends the authentication result to the image processing apparatus 10 (7-6).

Then, the authentication request unit 63 of the image processing apparatus 10 returns the authentication result to the program storage unit 61 (7-7).

If the authentication result is “authentication determination: OK”, the authentication unit 72 of the management server 20 instructs the expiration date information management unit 75 to update the expiration date information item 522 of the authentication information item 52 (7-8).

The expiration date information management unit 75 changes the validity date 522a of the acquired expiration date information item 522 based on the renewal term for the expiration date predetermined according to the service contract. Then the expiration date information management unit 75 instructs the certificate issuing unit 73 to issue a new certificate 523 containing the expiration date information item 522 of the updated authentication information item 52 and send the new certificate 523 to the image processing apparatus 10 (7-9).

The certificate issuing unit 73 issues a new certificate 523 based on the updated authentication information item 52 and sends the new certificate 523 to the image processing apparatus 10 (7-10).

The program storage unit 61 of the image processing apparatus 10 receives the certificate 523 sent from the management server 20, updates the expiration date information item 522 that has been stored therein based on the expiration date information item 522 obtained by decryption; and instructs the display unit 12 to display a message indicating that the expiration date information item 522 of the authentication information item 52 has been updated (7-11).

Thus, the image processing system of the first embodiment makes it possible to update the authentication information item 52.

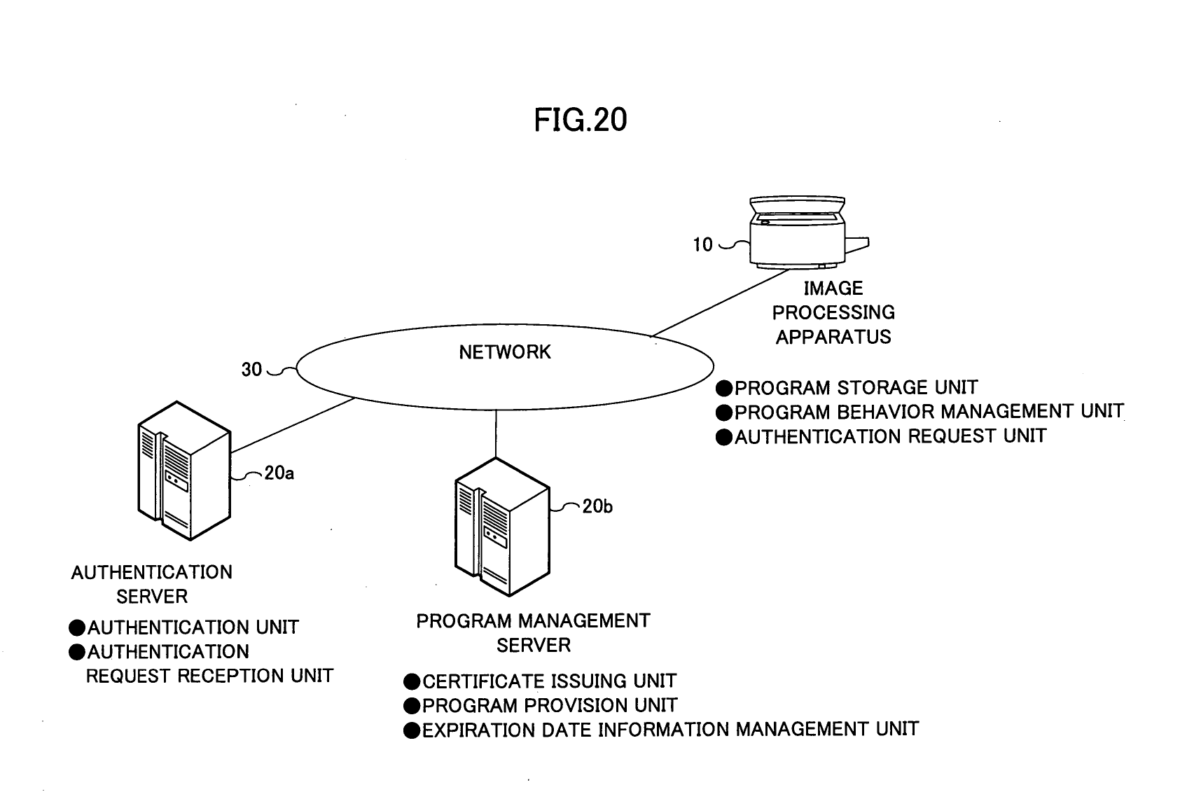

Modified embodiments of the first embodiment are described below with reference to FIGS. 20 through 23.

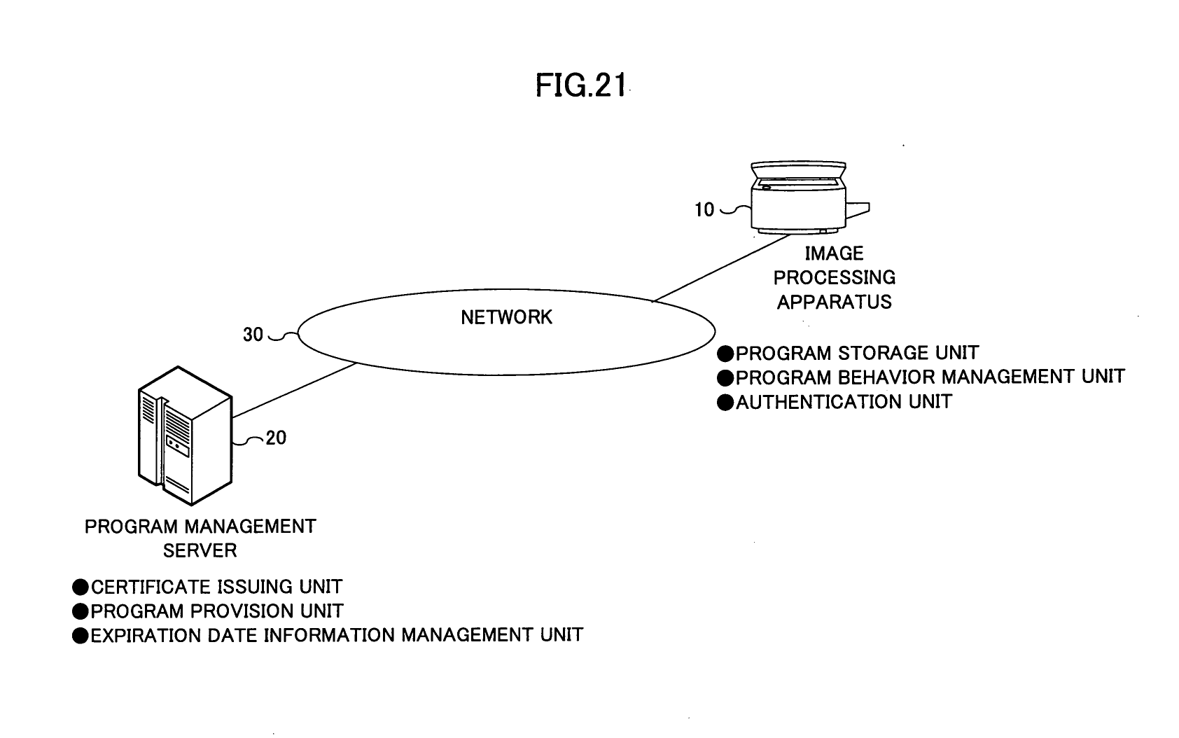

FIGS. 20 and 21 are diagrams each showing an example of a configuration of an image processing system according to a modified embodiment of the first embodiment of the present invention.

In the first embodiment, a single management server 20 incorporates the authentication request reception unit 71, the authentication unit 72, the certificate issuing unit 73, the program provision unit 74, and the expiration date information management unit 75. Alternatively, as shown in FIG. 20, these units may be divided into plural functional groups and separately installed in plural distributed management servers 20n. For example, an authentication server 20a and a program management server 20b (distributed management servers 20a and 20b) may be used, the authentication server 20a including the authentication request reception unit 71 and the authentication unit 72, and the program management server 20b including the certificate issuing unit 73, the program provision unit 74, and the expiration date information management unit 75.

The image processing system with the above-described configuration can reduce the workload in each management server 20n.

In a second modified embodiment shown in FIG. 21, an image processing apparatus 10 (an extended image processing apparatus 10) includes the authentication unit 72, while a program management server 20 includes the certificate issuing unit 73, the program provision unit 74, and the expiration date information management unit 75.

The image processing system of the above-described configuration eliminates the need for requesting the management server 20 to perform authentication via the network 30. It is therefore possible to prevent the system from being influenced by line condition (transmission condition), line performance (bandwidth) or the like, resulting in quicker response to an authentication request and higher processing speed.

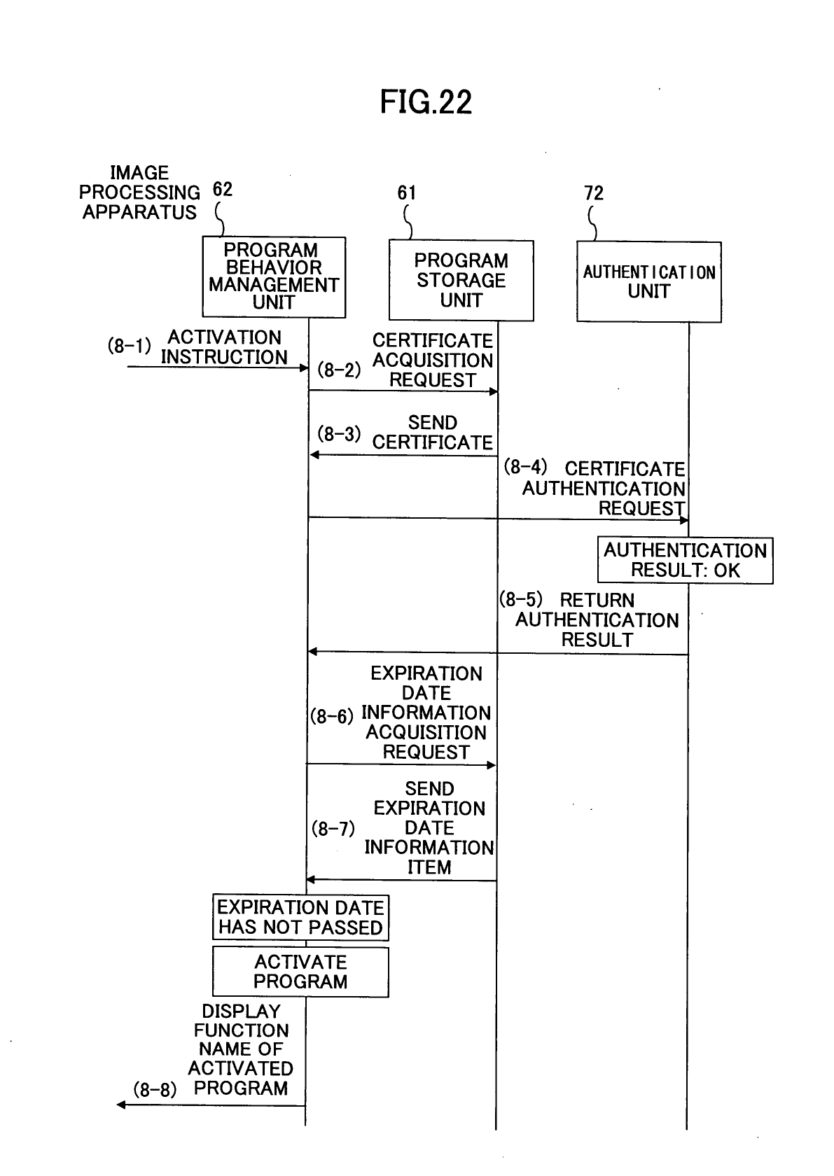

FIG. 22 is a sequence diagram showing a processing flow performed when activating a program in the extended image processing apparatus 10 according to the modified embodiment of the first embodiment of the present invention.

Referring to FIG. 22, because the extended image processing apparatus 10 includes the authentication unit 72, the image processing apparatus 10 does not need to request the management server 20 to perform authentication via the network 30.

Accordingly, operations such as authentication determination of a program to be activated or a running program can be performed within the extended image processing apparatus 10, resulting in significant advantages.

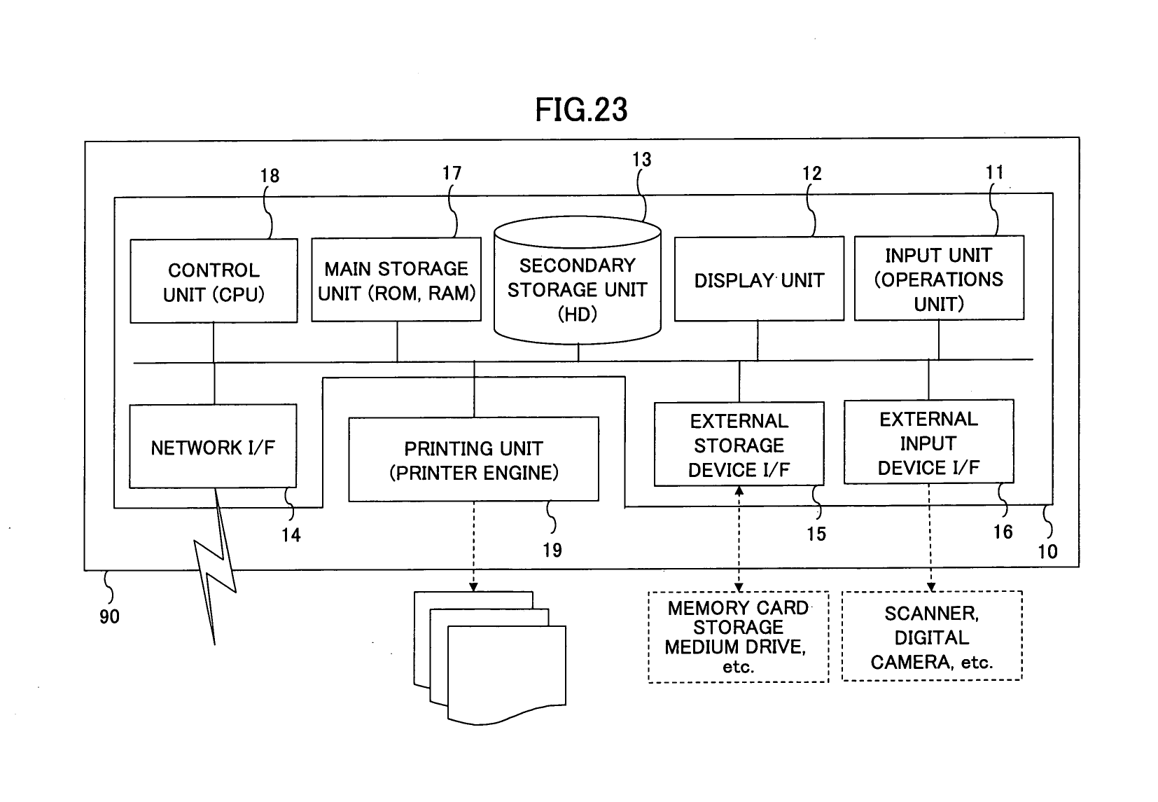

FIG. 23 is a block diagram showing an example of a hardware configuration of an image processing apparatus 90 according to a third modified embodiment of the present invention.

Referring to FIG. 23, the image processing apparatus 90 includes a printing unit 19 in addition to the hardware components of the image processing apparatus 10 of FIG. 1.

The printing unit 19 is called a printer engine, includes an image forming part that prints onto paper raster images generated by image processing (e.g. filtering, resolution conversion, color matching, γ correction, and grayscale conversion), a paper feeding part for transporting paper to the image forming part, and a paper ejection part that ejects the printed paper.

The printing unit 19 prints, onto paper, image data received from the image output function of the basic functions 41 shown in FIG. 2.

In this way, an image processing apparatus, such as the image processing apparatus 90, that includes the hardware components of the image processing apparatus 10 can realize the first embodiment of the present invention.

As described above, according to the first embodiment of the present invention, the program storage unit 61 of the image processing apparatus 10 includes the authentication information update request part 611, the certificate acquisition part 612, the program information request part 613, the program information acquisition part 614, the program acquisition part 615, the installation part 616, and the uninstallation part 617. The program storage unit 61 installs a program and related data acquired from the management server 20 and manages the installed program and the authentication information item 52. For example, the program storage unit 61 loads/deletes a program, and updates the authentication information item 52.

The program behavior management unit 62 includes the behavior control part 621, the expiration date determination part 622, and the fundamental function program determination part 623. The program behavior management unit 62 is configured to activate or terminate the program based on the authentication result and the authentication information item 52 sent from the management server 20, and thus control the behavior of the installed program.

The program behavior management unit 62 further includes the display part 624, and is configured to display information about the installed program (e.g. the expiration date information item 522 of the program) acquired from the management server 20 on the screen of the display unit 12.

The authentication request unit 63 includes the authentication request part 631 and the service contractor authentication request part 632, and is configured to request the management server 20 to determine whether a service contractor and the certificate 523 issued to the service contractor are valid.

In this way, with use of the component parts of the main function units, the image processing apparatus 10 can control and manage installation of a program based on an authentication result and can control and manage behavior of the installed program based on the authentication result, the expiration date, and the out-of-date behavior condition.

The authentication request reception unit 71 of the management server 20 receives information for identifying a service contractor and the certificate 523 that are sent from the image processing apparatus 10 when authentication is requested, transfers the received information to the authentication unit 72, and returns the authentication result of the authentication unit 72 to the image processing apparatus 10.

The authentication unit 72 includes the authentication part 721 and the service contractor authentication part 722, and is configured to perform authentication of the service contractor and the certificate 523 in response to authentication requests from the image processing apparatus 10.

The certificate issuing unit 73 includes the certificate issuing part 731, and is configured to issue the certificate 523 containing the program identification information item 521 and the expiration date information item 522 of the authentication information item 52 in an encrypted manner.

The program provision unit 74 includes the program information provision part 741 and the program provision part 742, and is configured to provide the image processing apparatus 10 with the information about the program of which installation into the image processing apparatus 10 is allowed. The program provision unit 74 also provides the image processing apparatus 10 with the program requested by image processing apparatus 10 based on the provided information.

The expiration date information management unit 75 includes the authentication information update part 751, and is configured to update the authentication information item 52 held by the management server 20 in response to a request for updating the authentication information item 52 from the image processing apparatus 10.

With use of these component parts of the main function units, the management server 20 can perform authentication and data management necessary for controlling installation of a program and behavior of the installed program in the image processing apparatus 10, and can provide information required by the image processing apparatus 10 in response to a request therefrom.

As described above, according to the first embodiment of the present invention, the image processing apparatus 10 sends the authentication information item 52 containing encrypted information to the management server 20. The management server 20 determines whether the sent authentication information item 52 is valid. If the authentication information item 52 is determined to be valid, the management server 20 provides a program to the image processing apparatus 10.

The image processing apparatus 10 loads the acquired program into a predetermined storage area of the secondary storage unit 13, and operates the program based on a certificate of the program. Thus, the image processing apparatus 10 can control the behavior of the program based on the authentication result.

According to the first embodiment, it is possible to provide an image processing system that authenticates a program in an image processing apparatus in units of functions based on the authentication information item 52 containing encrypted information and thus efficiently manages appropriate programs.

Further, because the authentication information item 52 exchanged between the image processing apparatus 10 and the management server 20 is encrypted, it is possible to prevent the authentication information item 52 from being maliciously tampered with and thus prevent unauthorized use of the functions of the image processing apparatus 10.

### Second Embodiment

According to a second embodiment of the present invention, a function of certifying a program (hereinafter referred to as “a program certification function”) is offered by a management server in place of a program management server of an image processing system. The second embodiment of the present invention thus provides an image processing system that can efficiently manage appropriate programs and can flexibly respond to changes in program development environments such as when program development is commissioned to another company as well as changes in the specification of the management server related to program development efficiency such as when trying to improve program development efficiency.

In the first embodiment, a single management server (a program management server) offers the program management function and the program certification function. On the other hand, the program management function and the program certification function are offered by corresponding different management servers, i.e., a first management server (program management server) and a second management server (activation server).

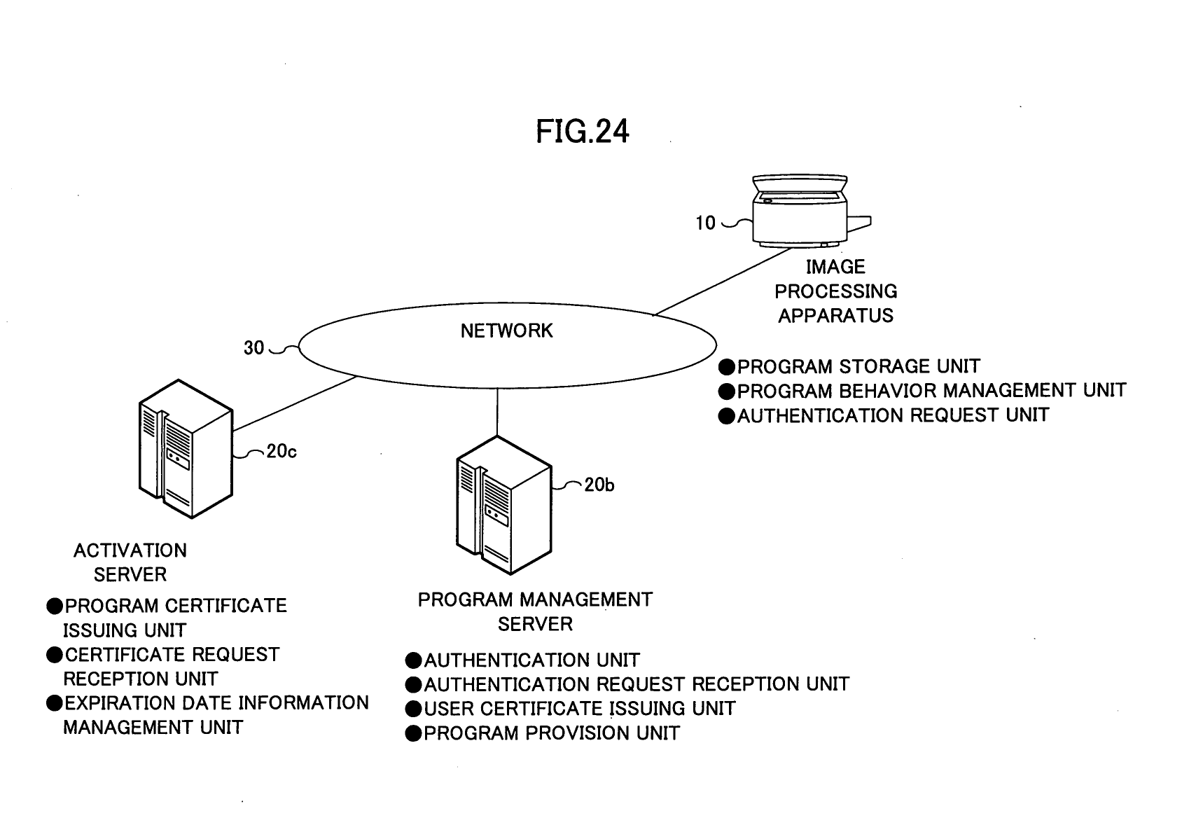

In the following discussion of the second embodiment, the differences from the first embodiment are described with reference to FIGS. 24 through 26. Components of the second embodiment that are the same as those of the first embodiment are denoted by the same reference numerals, and are not further described.

The configuration of the image processing system of the second embodiment is described below with reference to FIG. 24.

FIG. 24 is a diagram showing an example of a configuration of an image processing system (wherein an activation server 20c is used) according to the second embodiment of the present invention.

Referring to FIG. 24, the image processing system of the second embodiment includes an image processing apparatus 10 into which a function extension program is installed, a program management server 20b having a program management function for managing a function extension program to be installed into the image processing apparatus 10, and an activation server 20c having a program certification function for certifying the function extension program. The image processing apparatus 10, the program management server 20b, and the activation server 20c are connected via a network 30. The image processing apparatus 10 can download the function extension program managed by the program management server 20b via the network 30 and install the downloaded function extension program therein, thereby extending its function. The image processing apparatus 10 can acquire a certificate for the program issued by the activation server 20c and can execute the installed program based on the acquired program certificate.

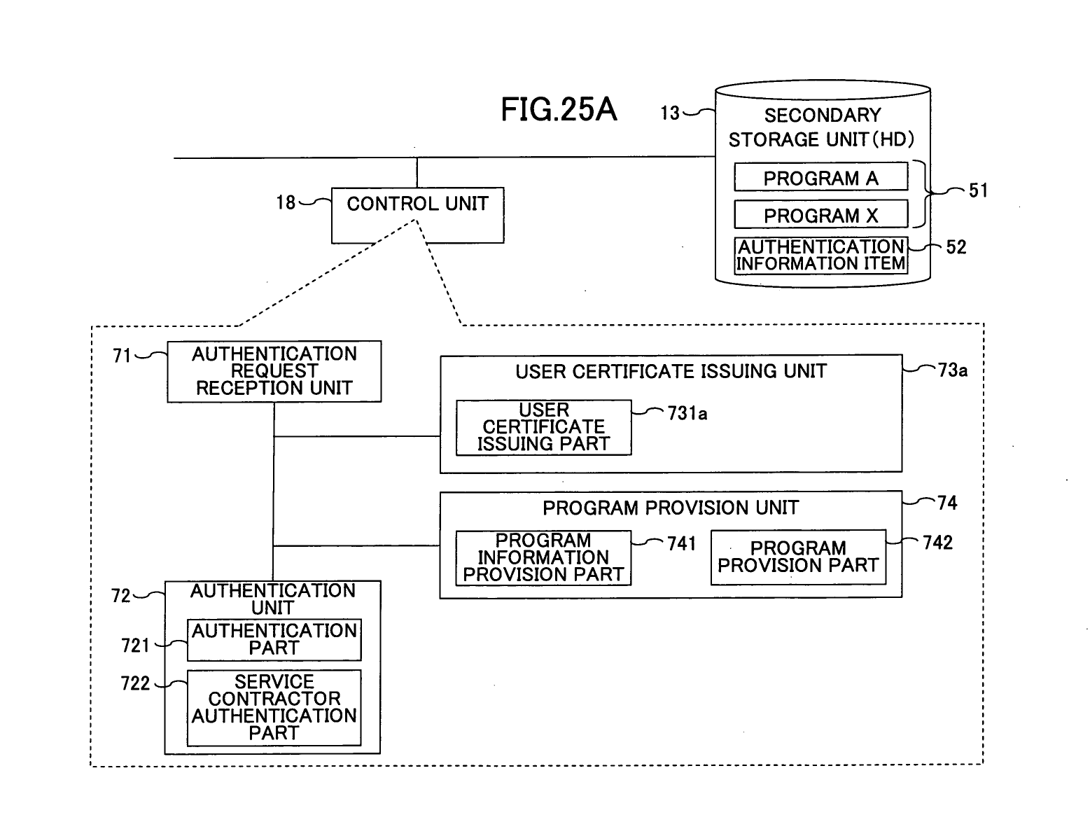

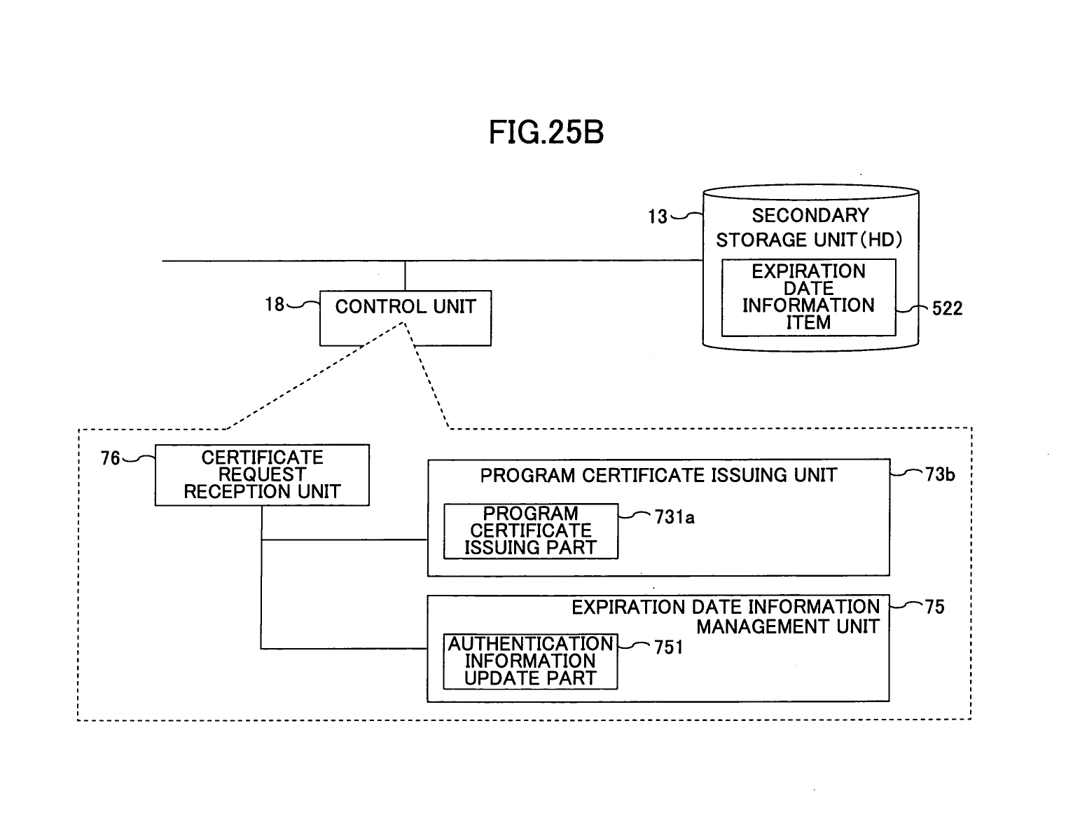

With reference to FIGS. 25A and 25B, the following describes components of the image processing system illustrated in FIG. 24 that realize the program management function of the program management server 20b and the program certification function of the activation server 20c.

FIG. 25A is a block diagram showing a configuration example of main function units of the program management server 20b according to the second embodiment of the present invention. FIG. 25B is a block diagram showing a configuration example of main function units of the activation server 20c according to the second embodiment of the present invention.

First, the main function units of the program management server 20b are described with reference to FIG. 25A.

In FIG. 25A, the main function units include an authentication request reception unit 71, an authentication unit 72, a user certificate issuing unit 73a, and a program provision unit 74. The difference from the main function units of the management server 20 of the first embodiment (FIG. 6B) is that the user certificate issuing unit 73a that issues only certificates for users is provided in place of the certificate issuing unit 73, and that the expiration date information management unit 75 is not provided. The user certificate issuing unit 73a is described below in detail.

The user certificate issuing unit 73a includes a user certificate issuing part 731a, and is configured to issue a certificate containing encrypted information (e.g. the public key 54) for identifying a service contractor and encrypted information indicating extended functions that can be used by the service contractor (including information indicating programs that can be installed).

In the image processing apparatus 10, in order to install an appropriate program (extension function) from the program management server 20b, the authentication request unit 63 sends to the program management server 20b the information (e.g. the public key 54) for identifying a service contractor who requested the installation, thereby requesting the program management server 20b to perform authentication of the service contractor so as to determine whether the service contractor is valid before installation of the program.

The program management server 20b is operated by an administrator and manages information indicating extended functions that can be used by registered service contractors (including information indicating installable programs).

The user certificate issuing unit 73a causes the user certificate issuing part 731a to encrypt information (e.g. the public key 54) for identifying a service contractor, which is received from the image processing apparatus 10, and information indicating extended functions that can be used by the service contractor (including information indicating installable programs) so as to issue a certificate.

The user certificate issuing part 731a of the user certificate issuing unit 73a encrypts the information (e.g. the public key 54) for identifying a service contractor and the information indicating extended functions that can be used by the service contractor (including information indicating installable programs) using the secret key 53.

When the latest certificate of the service contractor is needed, such as when the service contractor wishes to install a new program or when extended functions (including installable programs) that can be used by the service contractor are changed, the image processing apparatus 10 requests the user certificate issuing part 731a to perform authentication of the service contractor and to issue a certificate. In response, the user certificate issuing part 731a issues a certificate only for the authenticated service contractor and sends the issued certificate to the image processing apparatus 10.

In this way, when the latest certificate for the service contractor is needed, the user certificate issuing unit 73a can provide the image processing apparatus 10 with the certificate for the service contractor managed according to the service contract with use of the user certificate issuing part 731a.

Thus, with use of the authentication request reception unit 71, the authentication unit 72, and the user certificate issuing unit 73a, the program management server 20b performs authentication and data management necessary for controlling installation of a program and behavior of the installed program in the image processing apparatus 10.

Next, the main function units of the activation server 20c are described with reference to FIG. 25B.

In FIG. 25B, the main function units include a program certificate issuing unit 73b, an expiration date information management unit 75, and a certificate request reception unit 76.

The program certificate issuing unit 73b includes a program certificate issuing part 731b, and is configured to issue the certificate 523 containing the program identification information item 521 and the expiration date information item 522 in an encrypted manner.

When installing a new program, the image processing apparatus 10 acquires the program (extended function) to be installed from the program management server 20b. Then the program storage unit 61 sends the program identification information item 521 to the activation server 20c via the authentication request unit 63, and requests issuance of a certificate indicating that the acquired program is valid.

In the activation server 20c, the expiration date information management unit 75 associates each program having a certificate with its expiration date information item 522 so as to manage the expiration date of each program.

The program certificate issuing unit 73b causes the program certificate issuing part 731b to encrypt the program identification information item 521 received from the image processing apparatus 10 and the corresponding expiration date information item 522 so as to issue a certificate. The certificate issued by the program certificate issuing unit 73b is based on the type of use by the service contractor. Examples of the type of use by the service contractor include use of a purchased program (hereinafter referred to as “purchase”), use of a rented program (hereinafter referred to as “rental”), and use of a program on trial (hereinafter referred to as “trial use”).

If the type of use by the service contractor is “purchase”, the program certificate issuing unit 73b issues a certificate that allows permanent use of the program when the payment for the program is confirmed. That is, the program certificate issuing unit 73b issues a certificate based on the program identification information item 521 of the purchased program and the expiration date information item 522 indicating unlimited time of use.

If the type of use by the service contractor is “rental” or “trial use”, the program certificate issuing unit 73b issues a certificate that allows use of the program during a rental period or a trial period. That is, the program certificate issuing unit 73b issues a certificate based on the program identification information item 521 of the rented program or the program used on trial and the expiration date information item 522 indicating the expiration date of the rental or the trial use predetermined according to the service contract.

The program certificate issuing part 731b of the program certificate issuing unit 73 encrypts the program identification information item 521 and the expiration date information item 522 using the secret key 53.

When the latest certificate of a program is needed, such as when a new program is installed or when the expiration date of a program is changed (when the type of use by a service contractor is changed), the image processing apparatus 10 requests the program certificate issuing part 731b to issue a certificate of the program. In response, the program certificate issuing part 731b issues the certificate of the program based on the program identification information item 521 sent at the time of request and the expiration date information item 522 corresponding to the type of use, and then sends the issued certificate to the image processing apparatus 10.

In this way, when the latest certificate of the program is needed, the program certificate issuing unit 73b can provide the image processing apparatus 10 with the certificate of the program managed according to the service contract with use of the program certificate issuing part 731b.

The expiration date information management unit 75 includes an authentication information update part 751, and is configured to update the authentication information item 52 held by the program management server 20b in response to a request for updating the authentication information item 52 from the image processing apparatus 10.

The certificate request reception unit 76 is configured to receive the program identification information item 521 sent from the image processing apparatus 10 when the issuance of the program certificate is requested, transfer the received information to the program certificate issuing unit 73b, and provide the certificate issued by the program certificate issuing unit 73b to the image processing apparatus 10.

Thus, with use of the program certificate issuing unit 73b, the expiration date information management unit 75, and the certificate request reception unit 76, the activation server 20c manages validity of a program to be installed into or activated by the image processing apparatus 10, and manages the expiration date of the program according to the type of use by a service contractor.

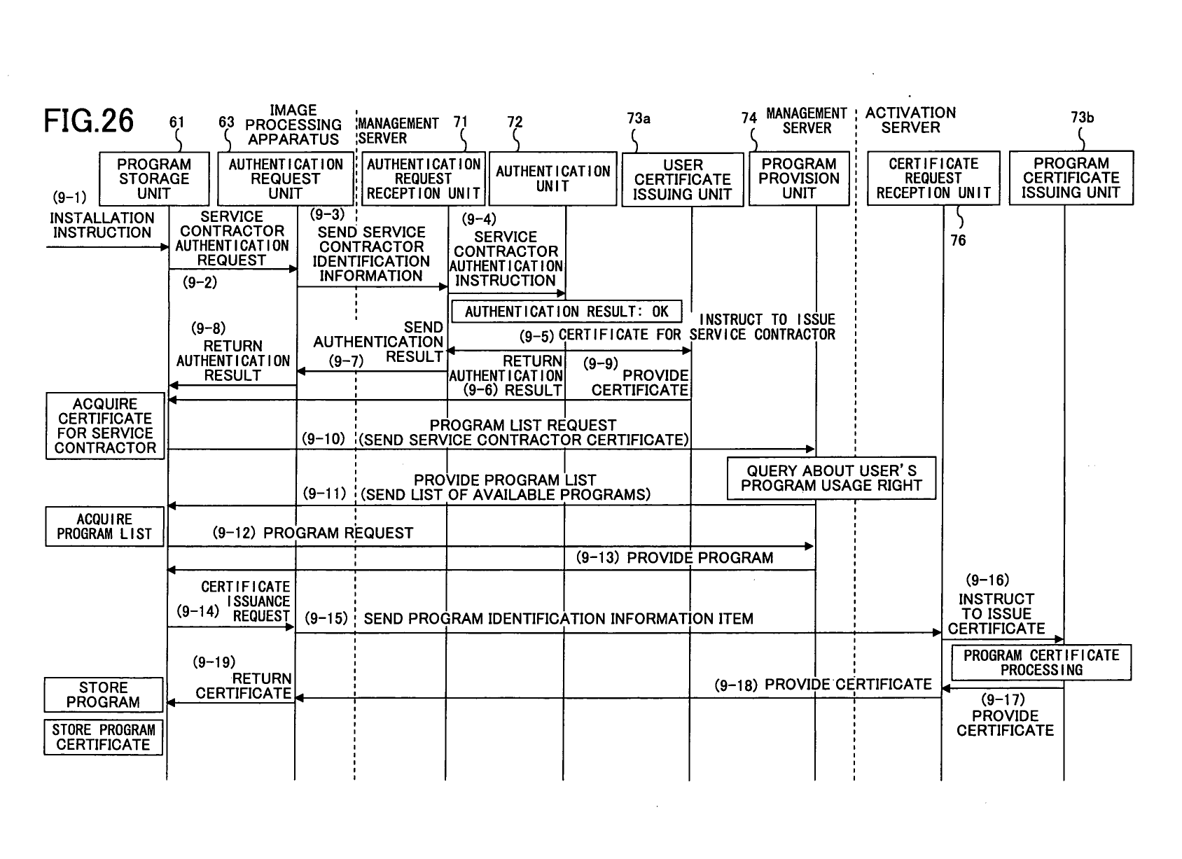

With reference to a flow of installing a program in the image processing system shown in FIG. 26, the following describes a relationship between the program management server 20b and the activation server 20c of FIGS. 25A and 25B, and the image processing apparatus 10.

FIG. 26 is a sequence diagram showing a process of installing a program according to the second embodiment of the present invention.

When the program storage unit 61 of the image processing apparatus 10 receives an installation instruction (9-1), the program storage unit 61 requests the authentication request unit 63 to perform service contractor authentication (9-2).

Then the authentication request unit 63 sends the public key 54 held by the image processing apparatus 10 to the program management server 20b, thereby requesting the program management server 20b to perform the service contractor authentication (9-3).

The authentication request reception unit 71 of the program management server 20b transfers the received public key 54 to the authentication unit 72, thereby instructing the authentication unit 72 to perform the service contractor authentication (9-4).

The authentication unit 72 performs the authentication of the service contractor based on the received public key 54. If the authentication result is “authentication determination: OK”, the authentication unit 72 instructs the user certificate issuing unit 73a to issue a certificate for the service contractor (9-5) and returns the authentication result (authentication determination: OK) to the authentication request reception unit 71 (9-6). In response, the authentication request reception unit 71 sends the authentication result to the image processing apparatus 10 (9-7).

Then, the authentication request unit 63 of the image processing apparatus 10 returns the received authentication result to the program storage unit 61 (9-8).

The user certificate issuing unit 73a of the program management server 20b sends the issued service contractor certificate to the image processing apparatus 10 (9-9).

In this way, the program management server 20b confirms the authenticity of the service contractor and issues the certificate for the service contractor to the image processing apparatus 10.

Then the program storage unit 61 of the image processing apparatus 10 sends the received service contractor certificate to the program management server 20b, thereby requesting provision of a program list corresponding to the service contract (9-10).

The program provision unit 74 of the program management server 20b queries programs available to the service contractor (queries service contractor's program usage right) based on the received certificate of the service contractor, and provides the image processing apparatus 10 with a program list (a list of available programs) in accordance with the service contract (9-11).

In this way, the image processing apparatus 10 acquires the program list indicating the information about available programs from the program management server 20b.

Then the program storage unit 61 of the image processing apparatus 10 requests the program management server 20b to provide a program to be installed into (an extended function to be added to) the image processing apparatus 10 selected from the received program list (9-12).

The program provision unit 74 of the program management server 20b sends the requested program to the image processing apparatus 10 (9-13).

In this way, the image processing apparatus 10 acquires the program to be installed from the management server 20 based on the program list.

Then the program storage unit 61 of the image processing apparatus 10 requests the authentication request unit 63 to issue the latest certificate for the received program (9-14).

The authentication request unit 63 sends the program identification information item 521 of the received program to the activation server 20c, thereby requesting issuance of the program certificate (9-15).

The certificate request reception unit 76 of the activation server 20c receives the program identification information item 521 as a request for issuance of the program certificate, and transfers the received information to the program certificate issuing unit 73b, thereby instructing issuance of the program certificate (9-16).

The program certificate issuing unit 73b issues a certificate based on the program identification information item 521 and the expiration date information item 522 predetermined according to the service contract, and provides the issued certificate to the certificate request reception unit 76 (9-17).

The certificate request reception unit 76 sends the issued program certificate to the image processing apparatus 10 (9-18).

Then, the authentication request unit 63 of the image processing apparatus 10 returns the received program certificate to the program storage unit 61 (9-19).

The program storage unit 61 loads the program and the program certificate received respectively from the program management server 20b and the activation server 20c into predetermined storage areas of the secondary storage unit 13.

In this way, the image processing system can perform installation of a program according to the service contract.

As described above, according to the second embodiment of the present invention, the image processing apparatus 10 sends information for identifying the service contractor to the program management server 20b. The program management server 20b determines the authenticity of the service contractor. If the service contractor is authenticated, the program management server 20b provides a certificate for the service contractor and a program to the image processing apparatus 10. Then the activation server 20c issues a certificate for the program to the image processing apparatus 10.

The image processing apparatus 10 loads the program and the certificate for the program into the predetermined storage areas of the secondary storage unit 13, and operates the function extension program based on the program certificate.

In the second embodiment of the present invention, it is thus possible to efficiently manage appropriate programs and flexibly respond to changes in program development environments such as when program development is commissioned to another company as well as changes in the specification of the management server 20 related to program development efficiency such as when trying to improve program development efficiency.

### Third Embodiment

In the above embodiments, the image processing apparatus offers the function of requesting service contractor authentication (hereinafter referred to as “a usage permission request function”) and the function of acquiring the program to be installed (hereinafter referred to as “a program acquisition function”). On the other hand, in a third embodiment of the present invention, an information processing apparatus for creating programs to be installed (hereinafter referred to as “a to-be-installed-program creating PC”) offers these functions. Further, information required by the image processing apparatus for program installation is held by a storage medium (e.g. a memory card, etc.). Thus the second embodiment of the present invention provides an image processing system that can install an appropriate program into (i.e. add an appropriate function to) an image processing apparatus not connected to a network (including an image processing apparatus not having a communication function) in accordance with the service contract.

The differences between the first and second embodiments and the third embodiment are as follows. In the first and second embodiments, the image processing apparatus into which a program for extending a function is installed is connected to the management server via the network. On the other hand, in the third embodiment, in place of the image processing apparatus, the to-be-installed-program creating PC is connected to the management server via the network. Further, in the third embodiment, the to-be-installed-program creating PC performs the usage permission request function and the program acquisition function.

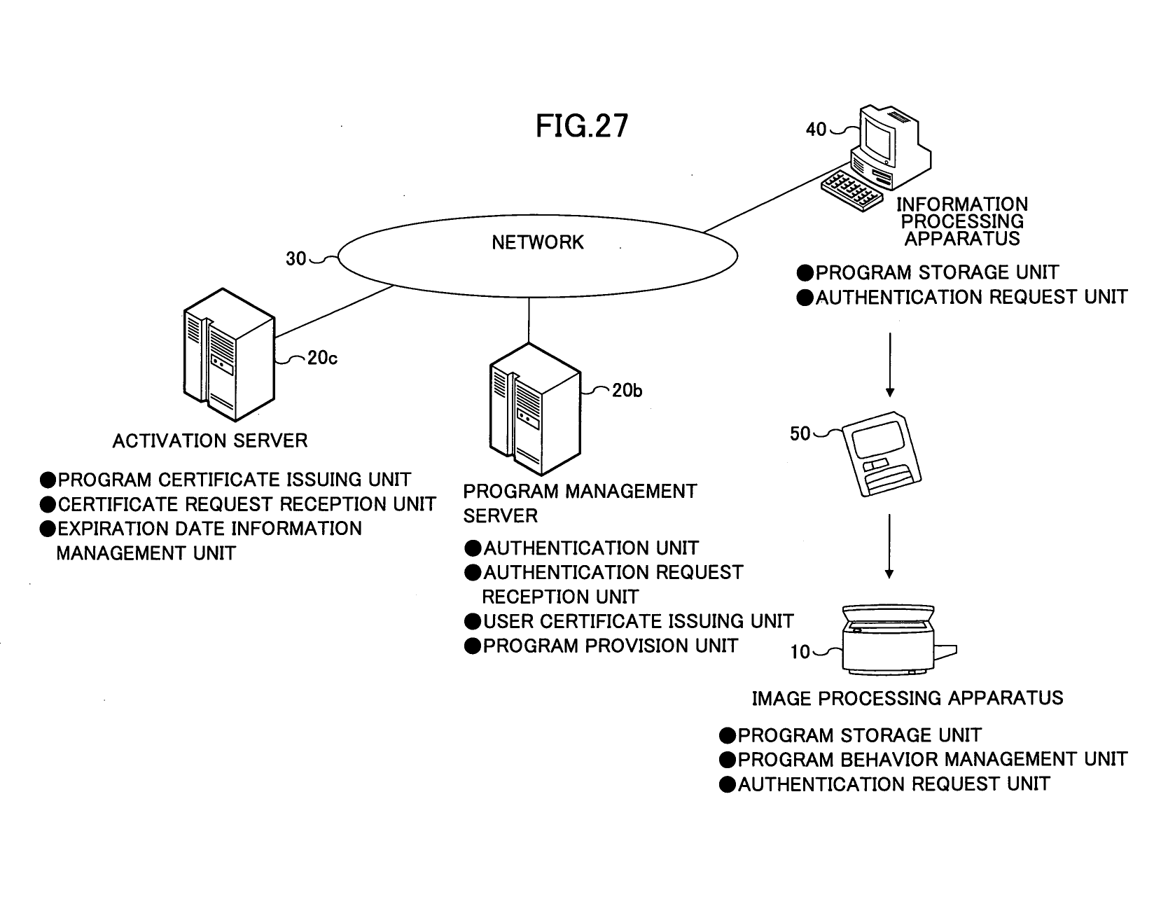

In the following discussion of the third embodiment, the differences from the first and second embodiments are described with reference to FIGS. 27 through 29. Components of the third embodiment that are the same as those of the first and second embodiments are denoted by the same reference numerals, and are not further described.

The configuration of the image processing system of the third embodiment is described below with reference to FIG. 27.

FIG. 27 is a diagram showing an example of a configuration of an image processing system (wherein a to-be-installed-program creating PC 40 is used) according to the third embodiment of the present invention.

Referring to FIG. 27, the image processing system of the third embodiment includes a program management server 20b having a program management function for managing a function extension program to be installed into an image processing apparatus 10, an activation server 20c having a program certification function for certifying the function extension program, and the to-be-installed-program creating PC 40 having the usage permission request function and the program acquisition function. The program management server 20b, the activation server 20c, and the to-be-installed-program creating PC 40 are connected via a network 30. The image processing apparatus 10 into which the function extension program is installed is used stand-alone. In other words, the image processing apparatus 10 is not connected to the program management server 20b, the activation server 20c, or the network 30.

The to-be-installed-program creating PC 40 can acquire, via the network 30, the program to be installed into the image processing apparatus 10 from the program management server 20b, and a certificate for the program issued by the activation server 20c. The to-be-installed-program creating PC 40 loads the acquired program and the certificate into an external storage medium 50 (e.g. a memory card, etc.). The image processing apparatus 10 installs the program and the certificate from the external storage medium 50 (e.g. a memory card, etc.), and thus can realize function extension as in the case of being connected to the network 30.

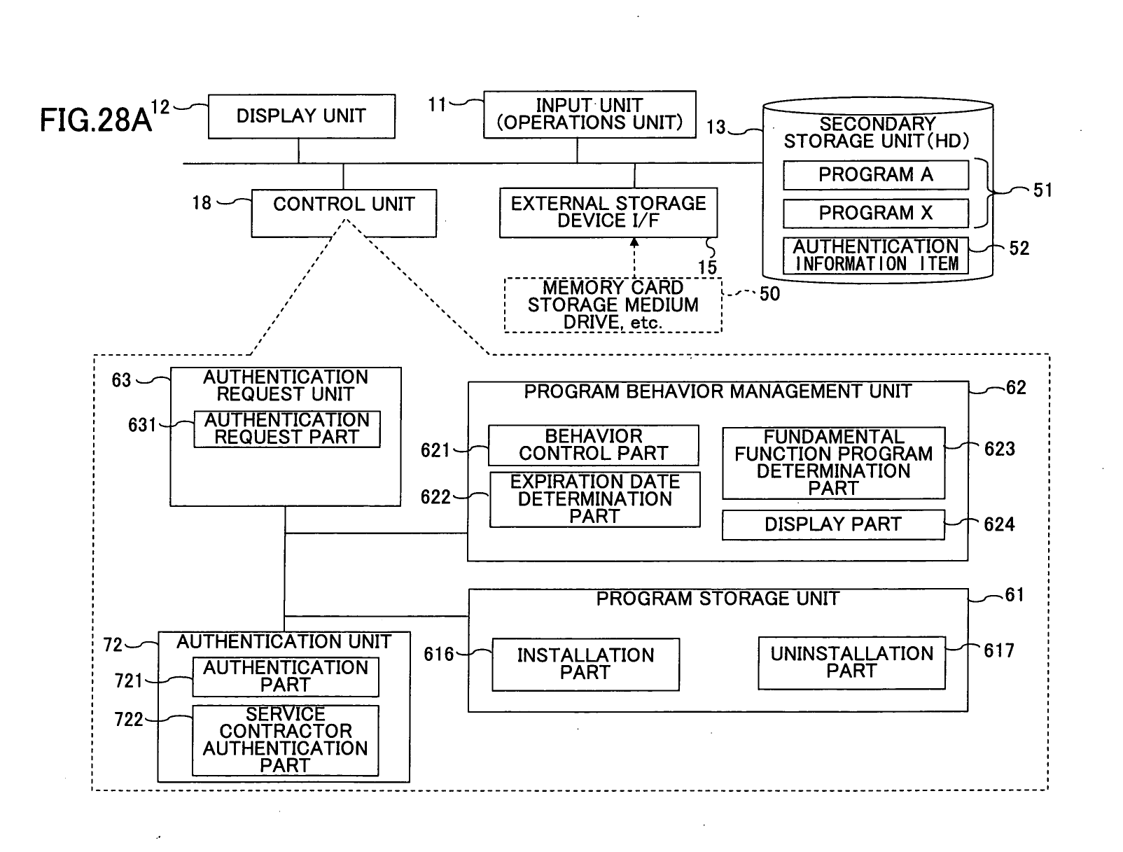

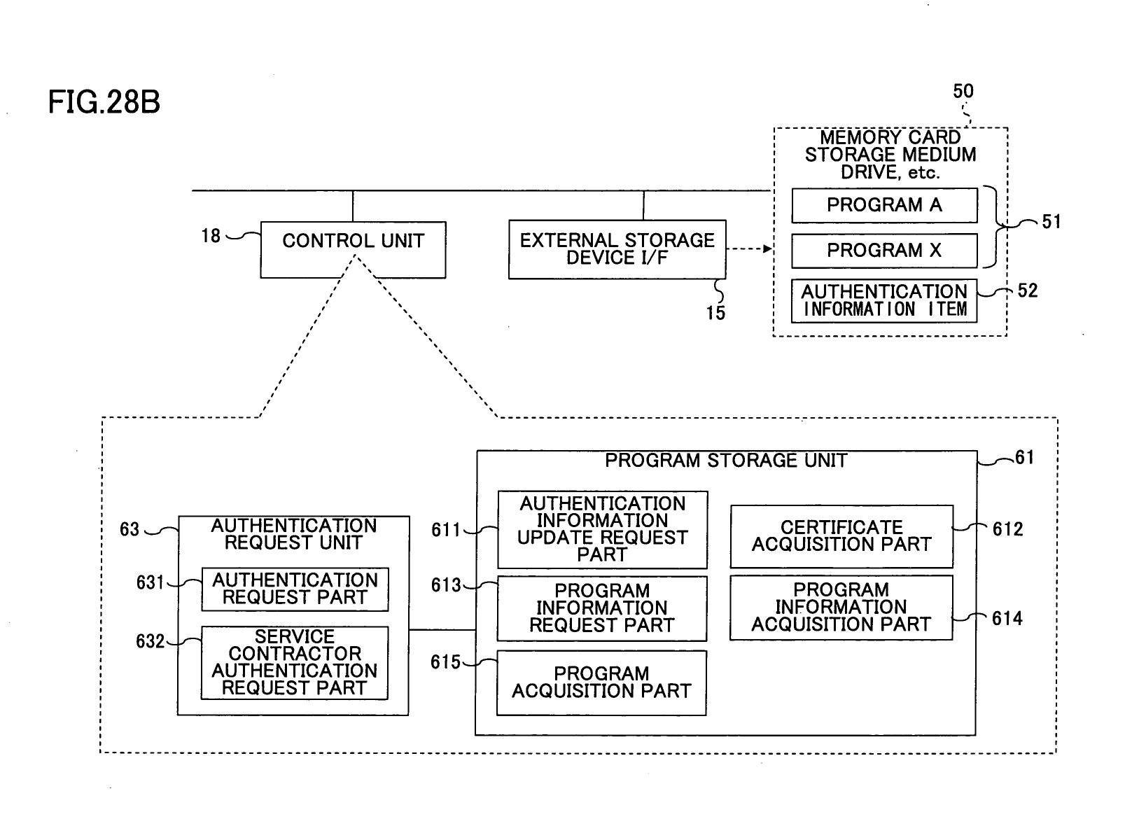

The following describes components of the image processing system illustrated in FIG. 27 that realize the program installation function and the program behavior control function of the image processing apparatus 10 and the usage permission request function and the program acquisition function of the to-be-installed-program creating PC 40 with reference to FIGS. 28A and 28B.

FIG. 28A is a block diagram showing a configuration example of main function units of the image processing apparatus 10 according to the third embodiment of the present invention. FIG. 28B is a block diagram showing a configuration example of main function units of the to-be-installed-program creating PC (information processing apparatus) 40 according to the third embodiment of the present invention.

Referring to FIG. 28A, the main function units of the image processing apparatus 10 includes a program storage unit 61, a program behavior management unit 62, an authentication request unit 63, and an authentication unit 72.

The main function units of the image processing apparatus 10 of the third embodiment is different from the main function units (FIG. 6A) of the image processing apparatuses 10 of the first and second embodiments in that the function of the program storage unit 61 is limited to program installation/uninstallation; and that the authentication unit 72 is added.

Thus, with use of the program storage unit 61, the program behavior management unit 62, the authentication request unit 63, and the authentication unit 72, the image processing apparatus 10 of this embodiment performs installation and uninstallation of the program and controls behavior of the installed program.

Referring to FIG. 28B, the main function units of the to-be-installed-program creating PC 40 includes the program storage unit 61 and the authentication request unit 63.

Although both the image processing apparatus 10 and the to-be-installed-program creating PC 40 include the program storage units 61, these program storage units 61 have different functions as shown in FIGS. 28A and 28B.

The program storage unit 61 of the image processing apparatus 10 includes an installation part 616 and an uninstallation part 617, and is configured to perform installation and uninstallation of the program acquired by the to-be-installed-program creating PC 40 from the program management server 20b. On the other hand, the program storage unit 61 of the to-be-installed-program creating PC 40 includes an authentication information update request part 611, a certificate acquisition part 612, a program information request part 613, a program information acquisition part 614, and a program acquisition part 615, and is configured to acquire the program to be installed and a certificate for the program from the program management server 20b and the activation server 20c, respectively.

Although both the image processing apparatus 10 and the to-be-installed-program creating PC 40 include the authentication request unit 63, these authentication request units 63 have different functions as shown in FIGS. 28A and 28B.

The authentication request unit 63 of the image processing apparatus 10 includes only the authentication request part 631 and requests the authentication unit 72 to determine whether a certificate issued to the to-be-installed program is valid. On the other hand, the authentication request unit 63 of the to-be-installed-program creating PC 40 includes the authentication request part 631 and the service contractor authentication request part 632, and requests the program management server 20b to determine whether a service contractor and a certificate issued to the service contractor are valid.

Thus, with use of the program storage unit 61 and the authentication request unit 63, the to-be-installed-program creating PC 40 acquires the program to be installed and a certificate indicating that the installed program is valid.

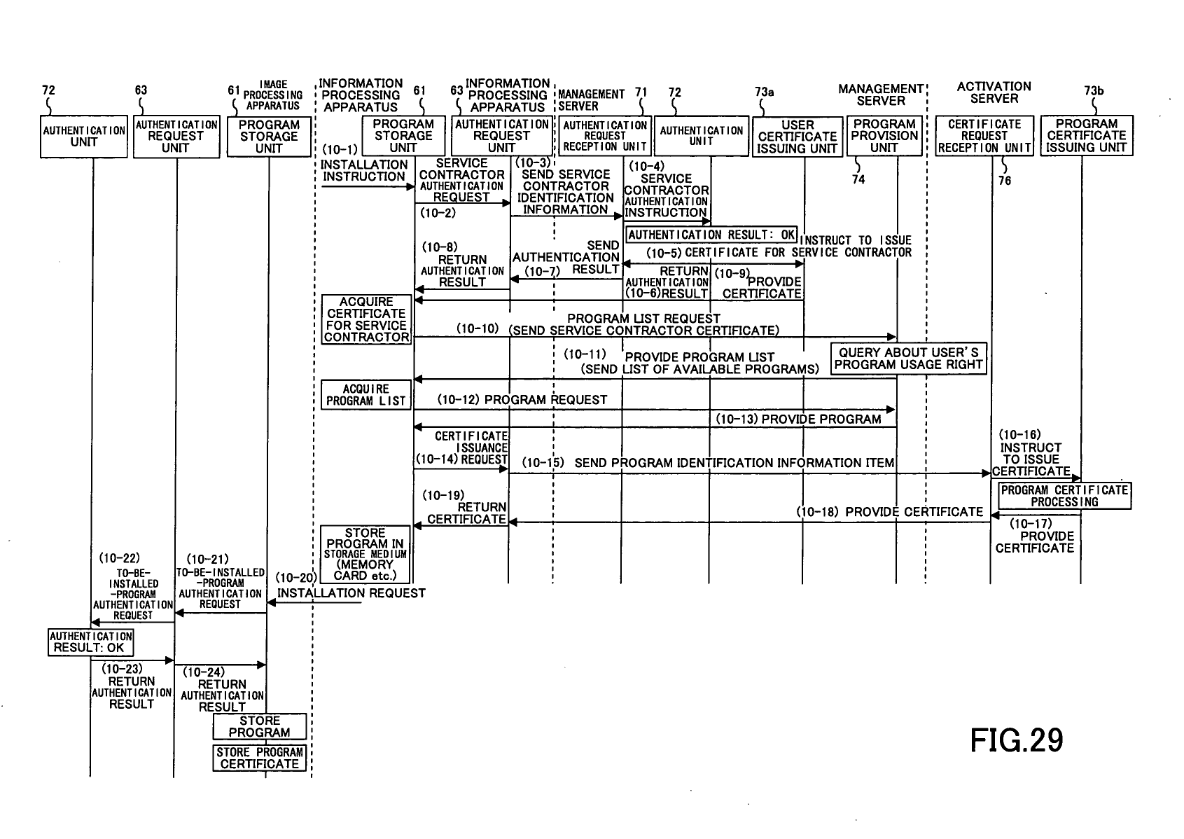

With reference to a flow of installing a program in the image processing system shown in FIG. 29, the following describes a relationship between the image processing apparatus 10, the to-be-installed-program creating PC 40, the program management server 20b, and the activation server 20c illustrated with reference to FIGS. 28A and 28B.

FIG. 29 is a sequence diagram showing a process of installing a program according to the third embodiment of the present invention.

When the program storage unit 61 of the to-be-installed-program creating PC 40 receives an installation instruction (10-1), the program storage unit 61 requests the authentication request unit 63 to perform service contractor authentication (10-2).

Then the authentication request unit 63 sends the public key 54 held by the to-be-installed-program creating PC 40 to the program management server 20b, thereby requesting the program management server 20b to perform the service contractor authentication (10-3).

The authentication request reception unit 71 of the program management server 20b transfers the received public key 54 to the authentication unit 72, thereby instructing the authentication unit 72 to perform the service contractor authentication (10-4).

The authentication unit 72 performs the authentication of the service contractor based on the received public key 54. If the authentication result is “authentication determination: OK”, the authentication unit 72 instructs the user certificate issuing unit 73a to issue a certificate for the service contractor (10-5) and returns the authentication result (authentication determination: OK) to the authentication request reception unit 71 (10-6). In response, the authentication request reception unit 71 sends the authentication result to the to-be-installed-program creating PC 40 (10-7).

Then, the authentication request unit 63 of the to-be-installed-program creating PC 40 returns the received authentication result to the program storage unit 61 (10-8).

The user certificate issuing unit 73a of the program management server 20b sends the issued service contractor certificate to the to-be-installed-program creating PC 40 (10-9).

In this way, the program management server 20b confirms the authenticity of the service contractor and issues the certificate for the service contractor to the to-be-installed-program creating PC 40.

Then the program storage unit 61 of the to-be-installed-program creating PC 40 sends the received service contractor certificate to the program management server 20b, thereby requesting provision of a program list corresponding to the service contract (10-10).

The program provision unit 74 of the program management server 20b queries programs available to the service contractor (queries service contractor's program usage right) based on the received certificate of the service contractor, and provides the to-be-installed-program creating PC 40 with a program list (a list of available programs) in accordance with the service contract (10-11).

In this way, the to-be-installed-program creating PC 40 acquires the program list indicating the information about available programs from the program management server 20b.

Then the program storage unit 61 of the to-be-installed-program creating PC 40 requests the program management server 20b to provide a program to be installed into (an extended function to be added to) the image processing apparatus 10 selected from the received program list (10-12).

The program provision unit 74 of the program management server 20b sends the requested program to the to-be-installed-program creating PC 40 (10-13).

In this way, the to-be installed program creating PC 40 acquires the program to be installed from the management server 20 based on the program list.

Then the program storage unit 61 of the to-be-installed-program creating PC 40 requests the authentication request unit 63 to issue the latest certificate for the received program (10-14).

The authentication request unit 63 sends the program identification information item 521 of the received program to the activation server 20c, thereby requesting issuance of the program certificate (10-15).

The certificate request reception unit 76 of the activation server 20c receives the program identification information item 521 as a request for issuance of the program certificate, and transfers the received information to the program certificate issuing unit 73b, thereby instructing issuance of the program certificate (10-16).

The program certificate issuing unit 73b issues a certificate based on the program identification information item 521 and the expiration date information item 522 predetermined according to the service contract, and provides the issued certificate to the certificate request reception unit 76 (10-17).

The certificate request reception unit 76 sends the issued program certificate to the image processing apparatus 10 (10-18).

Then, the authentication request unit 63 of the image processing apparatus 10 returns the received program certificate to the program storage unit 61 (10-19).

The program storage unit 61 loads the program and the program certificate received respectively from the program management server 20b and the activation server 20c into predetermined storage areas of the external storage medium 50 (e.g. a memory card, etc.) via, e.g., the external storage device I/F 15 such as the one shown in FIG. 2B.

Then, the external storage medium 50 (e.g. a memory card) holding the to-be-installed program and the program certificate is connected to the image processing apparatus 10 via the external storage device I/F 15 such as the one shown in FIG. 2A so as to be read by the image processing apparatus 10.

The program storage unit 61 of the image processing apparatus 10 receives an installation instruction (10-20), and transfers the program certificate from the external storage medium 50 (e.g. a memory card, etc.) to the authentication request unit 63, thereby requesting authentication of the to-be-installed program (10-21).

The authentication request unit 63 transfers the received program certificate to the authentication unit 72 (10-22).

The authentication unit 72 performs the authentication of the to-be-installed program based on the received public key 54. If the authentication result is “authentication determination: OK”, the authentication unit 72 returns the authentication result (authentication determination: OK) to the authentication request reception unit 71 (10-23). In response, the authentication request reception unit 71 sends the authentication result to the program storage unit 61 (10-24).

Then the program storage unit 61 loads the program and the program certificate from the external storage medium 50 (e.g., a memory card, etc.) into predetermined storage areas of the secondary storage unit 13.

In this way, the image processing system can perform installation of a program into the stand-alone image processing apparatus 10 according to the service contract.

As described above, according to the third embodiment of the present invention, the to-be-installed program creating PC 40 sends the service contractor identification information to the program management server 20b. The program management server 20b determines the authenticity of the service contractor. If the service contractor is authenticated, the program management server 20b provides a certificate for the service contractor and a program to the to-be-installed-program creating PC 40. Then the activation server 20c issues a certificate for the program to the to-be-installed-program creating PC 40.

The to-be-installed-program creating PC 40 loads the program and the certificate for the program into the external storage medium 50 (e.g. a memory card, etc.).

In the second embodiment of the present invention, it is thus possible to install an appropriate program in the stand-alone image processing apparatus 10, and to efficiently manage the function extension program.

The public-key cryptosystem used in the above first through third embodiments is merely an example of a cryptosystem and does not limit the present invention.

For example, in place of the public-key cryptosystem, a secret-key cryptosystem represented by DES (Data Encryption Standard) may be used. In the public-key cryptosystem, data encrypted with the secret key 53 can be decrypted only with the corresponding public key 54. The data encrypted with the public key 54 can be decrypted only with the corresponding secret key 53. Therefore, compared with the secret-key cryptosystem that uses the same key for encryption and decryption, the public-key cryptosystem does not require a key transportation channel with a high safety level and can provide easier and safer management of the keys. For this reason, the public-key cryptosystem is used in the above embodiments of the present invention.

In the case of using a secret-key cryptosystem, a safe channel needs to be used for sharing the secret key 53 by the image processing apparatus 10 and the management server 20.

The public key 54 of the above embodiment sent to the management server 20 for the service contractor authentication is an example of information for identifying the service contractor, and hence does not limit the present invention.

For example, other types of information that can identify the service contractor, such as a service contractor ID and a password, may be used.

The data formats of the program identification information item 521 and the expiration date information item 522 of the above embodiments are merely examples, and do not limit the present invention.

Other types of data structures may be used that can represent information contained in the program identification information item 521 and the expiration date information item 522.

The above-described requirements about, e.g., the shapes, combinations of elements do not limit the present invention. These requirements can be changed without departing from the scope of the invention and can be properly determined according to application purposes.

The present application is based on Japanese Priority Application No. 2006-224520 filed on Aug. 21, 2006, and Japanese Priority Application No. 2007-170863 filed on Jun. 28, 2007, with the Japanese Patent Office, the entire contents of which are hereby incorporated by reference.

What is claimed is:

1. A management server that is connected to an image processing apparatus, the management server comprising:
an authentication unit that performs authentication of authentication information sent from the image processing apparatus;
a certificate issuing unit that issues a certificate containing program identification information for identifying a program and expiration date information indicating an expiration date of the program in an encrypted manner; and
a program provision unit that provides the image processing apparatus with the program to be installed and the certificate.

2. The management server as claimed in claim 1, further comprising:
a program information provision unit that provides the image processing apparatus with a program list indicating information about a program that can be installed in the image processing apparatus.

3. The management server as claimed in claim 1, further comprising:
a service contractor authentication unit that determines whether a service contractor can use a function of the image processing apparatus based on service contractor identification information for identifying the service contractor sent from the image processing apparatus.

4. The management server as claimed in claim 3, wherein, if the image processing apparatus requests authentication of the service contractor, the certificate issuing unit issues the certificate corresponding to a usage right of the service contractor based on the user authentication result by the service contractor authentication unit, and sends the issued certificate to the image processing apparatus.

5. The management server as claimed in claim 1, further comprising:
an authentication information update unit that updates the expiration date information by renewing the expiration date based on a renewal term of the expiration date predetermined for each program.

6. An image processing apparatus that is connected to a management server, the image processing apparatus comprising:
an authentication request unit that sends authentication information to the management server at a predetermined timing so as to request the management server including an authentication unit to perform authentication of the authentication information, the authentication information including program identification information for identifying a program downloaded from the management server, expiration date information indicating an expiration date and time of the program, and a certificate containing the program identification information and the expiration date information in an encrypted manner; and
a behavior control unit that, if the authentication information sent by the authentication request unit is authenticated by the authentication unit of the management server, controls behavior of the program downloaded from the management server based on the expiration date of the program indicated in the authentication information.

7. The image processing apparatus as claimed in claim 6, further comprising:
a certificate acquisition unit that acquires the certificate from the management server;
a program information request unit that sends the received certificate to the management server so to as request the management server to send a program list;
a program information acquisition unit that receives the program list from the management server;
a program acquisition unit that acquires the program to be installed into the image processing apparatus based on the program list; and
an installation unit that installs the program acquired by the program acquisition unit.

8. The image processing apparatus as claimed in claim 6, further comprising:
a service contractor authentication request unit that sends service contractor identification information for identifying a service contractor of the image processing apparatus to the management server so as to request the management server to perform authentication of the service contractor.

9. The image processing apparatus as claimed in claim 6, further comprising:
an authentication information update request unit that requests the management server to update the authentication information.

10. The image processing apparatus as claimed in claim 6, further comprising:
an expiration date determination unit that compares the expiration date and time indicated in the expiration date information with a current date and time so as to determine whether the expiration date of the installed program has passed based on the expiration date information.

11. The image processing apparatus as claimed in claim 10, wherein, if the expiration date determination unit determines that the expiration date of the installed program has passed, the behavior control unit terminates or does not activate the program.

12. The image processing apparatus as claimed in claim 10, further comprising:
an uninstallation unit that, if the expiration date determination unit determines that the expiration date of the installed program has passed, uninstalls the program.

13. The image processing apparatus as claimed in claim 12, further comprising:
a fundamental function program determination unit that determines whether the image processing apparatus will be disabled by uninstalling the program.

14. The image processing apparatus as claimed in claim 13, further comprising:
continuous use expiration date information that indicates an extended period of the expiration date;
wherein, if the fundamental function program determination unit determines that the image processing apparatus will be disabled by uninstalling the program, the uninstallation unit uninstalls the program after the extended period indicated in the continuous use expiration date information is over.

15. The image processing apparatus as claimed in claim 13, wherein, if the expiration date determination unit determines that the expiration date of the installed program has passed, and if the fundamental function program determination unit determines that the image processing apparatus will be disabled by uninstalling the program, the behavior control unit runs or activates the program during the extended period indicated in the continuous use expiration date information.

16. The image processing apparatus as claimed in claim 13, further comprising:
a display unit that displays information about the program installed from the management server on a display screen,
wherein, if the expiration date determination unit determines that the expiration date of the installed program has passed, and if the fundamental function program determination unit determines that the image processing apparatus will be disabled by uninstalling the program, the display unit displays a message that prompts renewal of the expiration date on the display screen during the extended period indicated in the continuous use expiration period.

17. The image processing apparatus as claimed in claim 16,
wherein the expiration date information includes a warning issuing condition that indicates the number of remaining days before the expiration date;
if the expiration date determination unit determines that the expiration date of the installed program is close, the display unit displays a message indicating that the expiration date of the program is close on the display screen.

18. The image processing apparatus as claimed in claim 16, wherein if the behavior control unit runs or activates the installed program, the display unit displays the name of a function corresponding to the program on the display screen.

19. A program management method for use in a management server that is connected to an image processing apparatus, the program management method comprising:
an authenticating step of performing authentication of authentication information sent from the image processing apparatus;
a certificate issuing step of issuing a certificate containing program identification information for identifying a program and expiration date information indicating an expiration date of the program in an encrypted manner; and
a program providing step of providing the image processing apparatus with the program to be installed and the certificate.
